(19) United States
(12) Patent Application Publication
(10) Pub. No.: US 2007/0296202 A1
(43) Pub. Date: Dec. 27, 2007

(54) Document handling apparatus

(75) Inventor: Fritz Zwahlen, Ammerzwil (CH)

Correspondence Address: OLIFF & BERRIDGE, PLC, P.O. BOX 320850, ALEXANDRIA, VA, 22320-4850, US

(73) Assignee: DE LA RUE INTERNATIONAL LIMITED, BASINGSTOKE (GB)

(21) Appl. No.: 11/797,606

(22) Filed: May 4, 2007

Related U.S. Application Data
(60) Provisional application No. 60/798,341, filed on May 8, 2006.

(51) Int. Cl. B42D 15/10

(52) U.S. Cl. 283/58

(57) ABSTRACT

A document handling apparatus is disclosed. The apparatus comprises an input module for receiving documents and feeding them one by one into the apparatus, a note handling module for transporting the documents to a safe, a note reader module for detecting characteristics of the documents, and a safe for storing the documents. The safe comprises a number of roll storage modules connect by transport means. The module in which each document is stored is determined based upon the detected characteristics of the document. Documents can be retrieved from the storage modules upon operator input and dispensed through an output module.

### BACKGROUND OF THE INVENTION

The present invention relates to a document handling apparatus. The apparatus is particularly well adapted for handling documents of value, such as banknotes, or other security documents such as cheques, certificates, vouchers, tickets or tokens.

Document handling apparatus are required in many different environments, including banks and other cash processing institutions. What is needed is a secure, multifunctional apparatus which assists an operator in carrying out transactions, thereby eliminating operator error, and which stores and accounts for documents of value when they are not in use.

### SUMMARY OF INVENTION

The present invention provides a document handling apparatus substantially as herein described with reference to the accompanying drawings. P A document handling apparatus is disclosed. The apparatus comprises an input module for receiving documents and feeding them one by one into the apparatus, a note handling module for transporting the documents to a safe, a note reader module for detecting characteristics of the documents, and a safe for storing the documents. The safe comprises a number of roll storage modules connect by transport means. The module in which each document is stored is determined based upon the detected characteristics of the document. Documents can be retrieved from the storage modules upon operator input and dispensed through an output module.

The present apparatus has two main functions: the secure storage of deposited documents, and the accurate retrieval and dispensing of documents from the store. In a bank or other cash-handling scenario, this can be used for secure and fast desposit and withdrawal of banknotes. The apparatus is particularly appropriate for operation by one or more tellers in an open banking environment since the documents of value are stored in the apparatus' safe and can only be accessed by executing a withdraw operation on the apparatus.

The apparatus incorporates detectors for recognising, authenticating and counting documents which enables all documents input into the system to be tracked and logged. Any suspected counterfeit documents can also be readily identified and either output for immediate checking by the operator or stored securely for later processing.

### BRIEF DESCRIPTIONS OF DRAWINGS

An example of the invention, termed the “TCR Twin Safe”, will now be described with reference to the accompanying drawings, in which:

FIG. 1 TCR Twin Safe Workstation

FIG. 2 External view of the TCR Twin Safe

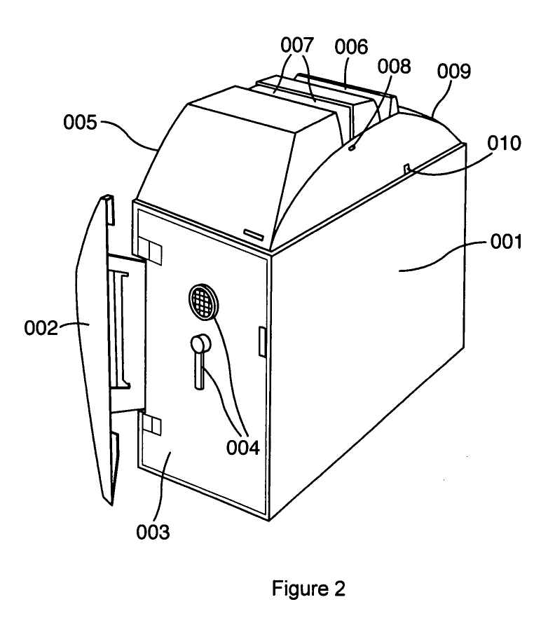

FIG. 3 Internal view of the TCR Twin Safe

FIG. 4 Transport Paths

FIG. 5 Note Handling Module in the open position showing transport belts

FIG. 6 Feedgate solenoid and check sensor

FIG. 7 Stepper motor

FIG. 8 Overview of sensors on the TCR twin safe

FIG. 9 Note reader module

FIG. 10 Opening the Note Handling Module

FIG. 11 Safety catch (014) for Note Handling Module

FIG. 12 Note Handling Module in the open position.

FIG. 13 Note Handling Module in the open position (left view)

FIG. 14 Note Handling Module in the open position with the right-hand damper in the rear slot.

FIG. 15 Checking that the Note Handling Module is fully closed.

FIG. 16 Pulling out the trolley

FIG. 17 Trolley pulled out

FIG. 18 Opening a storage unit

FIG. 19 Storage unit open

FIG. 20 Points in the system where note jams can occur

FIG. 21 Removing banknotes from the input compartment

FIG. 22 Removing banknotes from under the input tray

FIG. 23 Removing banknotes from the Note Reader Module

FIG. 24 Removing banknotes from the NHM feedgate

FIG. 25 Removing banknotes from the entry to the output path

FIG. 26 Removing banknotes from the entry to the output path

FIG. 27 Twin Safe in stand-alone mode with two Safemaster units

FIG. 28 Twin Safe connected to a host computer, four Safemaster units and a journal printer

FIG. 29 Twin Safe connected to a network

FIG. 30 Alarm locations

FIG. 31 Overview of Input Module 100

FIG. 32 Input compartment top view

FIG. 33 Reverse top view of the input compartment

FIG. 34 Top view of the Input Module

FIG. 35 Components of the pusher plate assembly 127

FIG. 36 Side view of the Input Module

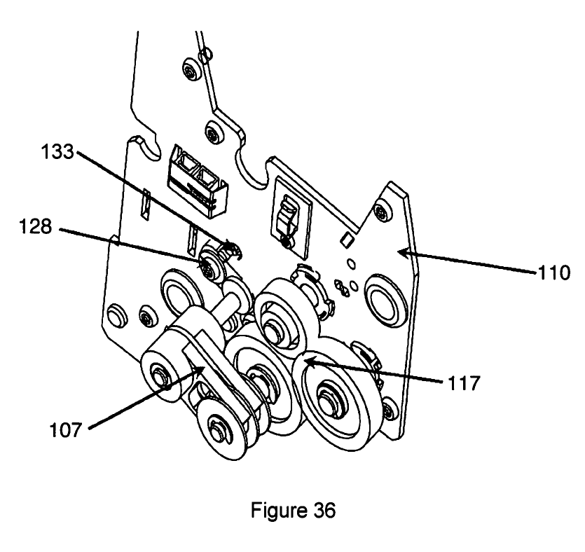

FIG. 37 View of shafts and rollers in the Input Module

FIG. 38 The interaction between the various rollers

FIG. 39 Note Handling Module 201

FIG. 40 Expanded view of Note Handling Module

FIG. 41 NHM transport paths

FIG. 42 Toothed wheel at top of Storage Transport Module

FIG. 43 Note Reader Module transport belt with central sensor head removed

FIG. 44 Lower transport belts and guide plates on input path

FIG. 45 Rear transport belt and sensors, under the Output Module.

FIG. 46 Note reader head (right-hand view)

FIG. 47 Transport path through Note Reader Module (right-hand view)

FIG. 48 Lower transport belt assembly at entry to input path

FIG. 49 Output Module 400—front right view

FIG. 50 Output path components

FIG. 51 Input tray and output drawers on top cover

FIG. 52 Storage feedgate with teeth in upper (default) position

FIG. 53 Storage feedgate with teeth in lower (activated) position

FIG. 54 Storage feedgate assembly 240

FIG. 55 Storage feedgate assembly tilted upward to access storage gateway

FIG. 56 Storage gateway, viewed from within the storage cabinet

FIG. 57 Sensors on Note Handling Module

FIG. 58 Thickness sensor LED on Note Handling Controller

FIG. 59 Mechanical drive to input and output paths (right view)

FIG. 60 Rear left view of the Output Module

FIG. 61 Rear belt and driveshafts

FIG. 62 Transport base unit

FIG. 63 Drive components for transport base unit

FIG. 64 Note reader calibration papers 304

FIG. 65 Note reader adjustment screws

FIG. 66 Storage Transport Module 500

FIG. 67 Storage Transport Module mounted on trolley behind Roll Storage Modules

FIG. 68 Storage transport system drive belts and sensors

FIG. 69 Storage Transport Module 500 (left front view)

FIG. 70 Drive wheels at lower right of Storage Transport Module

FIG. 71 Mechanical drive for Note Transport Modules, from Storage Transport Module

FIG. 72 Storage unit with Note Transport Modules mounted between Roll Storage Modules

FIG. 73 Exploded view of the storage unit

FIG. 74 Upper Note Transport Module, raised on its hinge above the lower module.

FIG. 75 Upper Note Transport Module

FIG. 76 Upper and lower Note Transport Modules

FIG. 77 Storage unit hinge

FIG. 78 Roll Storage Controller

FIG. 79 Roll Storage Module 700

FIG. 80 Storage unit open showing the two sections of the Note Transport Module attached to roll storage modules

FIG. 81 View One of the Outer Casing

FIG. 82 View Two of the Outer Casing

FIG. 83 The Input Rollers

FIG. 84 Cross Section of the Roll Storage Module

FIG. 85 The Timing Wheel and Sensor

FIG. 86 The Swivel Arm Assembly 724

FIG. 87 The Differential Gear Set 719

FIG. 88 Power management system

FIG. 89 CAN bus

FIG. 90 Storage cabinet internal components

FIG. 91 Power and data sockets on left side of storage cabinet

FIG. 92 Power and data sockets on left side of storage trolley

FIG. 93 Mains power socket and service switch on right side of storage cabinet

FIG. 94 Mains power socket on right side of storage trolley

FIG. 95 Cables connecting Twin Safe to environment

FIG. 96 Main control box without NIU (top) and with NIU (bottom)

FIG. 97 Main control box, service panel

FIG. 98 Main control box, wiring panel

FIG. 99 Main Control Unit circuit board

FIG. 100 Note Handling Controller (indicated by dotted line), with cover, fitted to Output Module

FIG. 101 Note Handling Controller 939 circuit board

FIG. 102 NHM connections to Service Display and Note Reader Module

FIG. 103 Service Display Module (indicated by dotted line)

FIG. 104 Service Display Module 963 circuit board

FIG. 105 Note Reader Module circuit board 967

FIG. 106 Storage Transport and Roll Storage Controllers

FIG. 107 Storage Transport Controller circuit board

FIG. 108 Roll Storage Controller circuit board

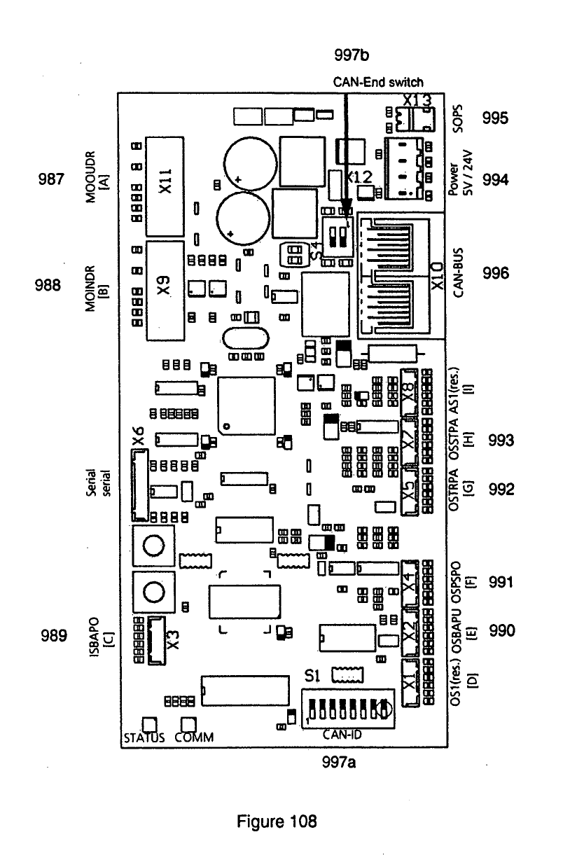

### DETAILED DESCRIPTION

0. Introduction

The TCR Twin Safe is a teller assist unit for storing and recycling banknotes. It is designed for use in banks, post offices, foreign exchange bureaux and similar cash handling institutions using open plan counters. It can be operated by two tellers, one on either side.

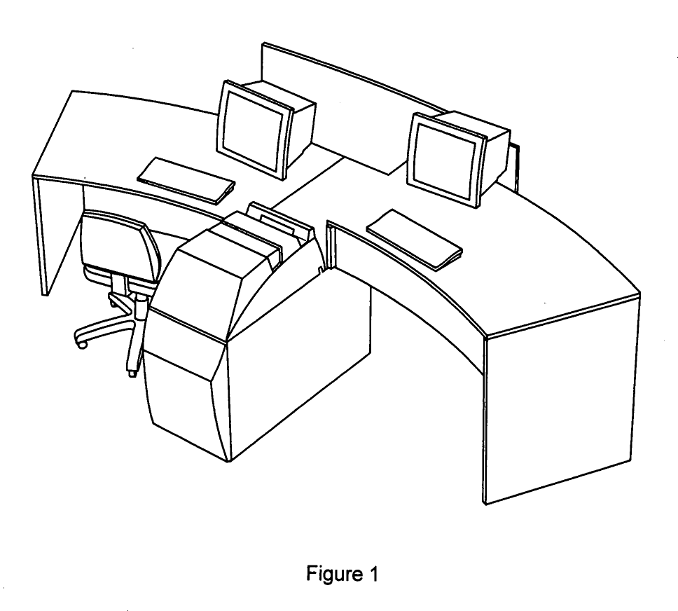

The TCR Twin Safe workstation is shown in FIG. 1. There are two terminals attached to the workstation so that either of the two tellers can perform cash transactions independently, as soon as the previous transaction has been completed.

A transaction may consist of the deposit or withdrawal of cash from the safe. When cash is placed in the input tray, it passes through a system of optical and mechanical sensors to determine its currency, denomination and condition. The system can be configured to accept up to eight different types of banknote, which are stored in separate compartments within the safe. If a banknote is unrecognised, or if it is in poor physical condition, it will be rejected and sent to the output tray.

All banknotes entering the system are examined by a multi-headed optical reader which is programmed with a detailed profile of each currency and denomination that is to be accepted for storage. Any banknote that does not conform to one of these profiles is rejected, including unrecognised currencies and denominations, and forgeries.

The TCR Twin Safe has an internal transport system made up of conveyor belts and feedgates, sending notes to storage compartments within a locked cabinet. The storage compartments can be filled and emptied as required, and cash transactions can be made without any need to open the safe. This enables the teller to perform transactions without having to handle large amounts of money at the cash desk. Locks and security features are available to European and American standards, so that cash can be left in the safe overnight.

The safe consists of a Note Handling Module at the top, where notes are deposited and retrieved by the teller, and a storage system below, inside the locked cabinet. The storage system is mounted on a trolley which can be wheeled out along a set of rails mounted on the floor of the cabinet, although normally this will only be necessary when trapped banknotes have to be retrieved, or the system requires maintenance. The Note Handling Module can also be opened, in case notes become trapped on the input path, before they are sent to storage.

The TCR Twin Safe can be used as a stand-alone unit, or it can linked to the bank's host computer or network. It can also be connected to the following peripherals:
A printer, to print the journal file, giving details of actions performed by the Twin Safe and any event messages that have been generated.
A set of Safemaster units. These are cabinets with drawers for storage of cheques, coins and foreign currencies. They can be opened by the teller, by entering a pin code from the terminal.

The Twin Safe is operated between two tellers, left and right, with the input tray at the front and the safe door at the rear. This defines the orientation of the system for the purpose of describing the components as left, right, front and rear.

0.1 Overview

0.1.1 Construction of the TCR Twin Safe

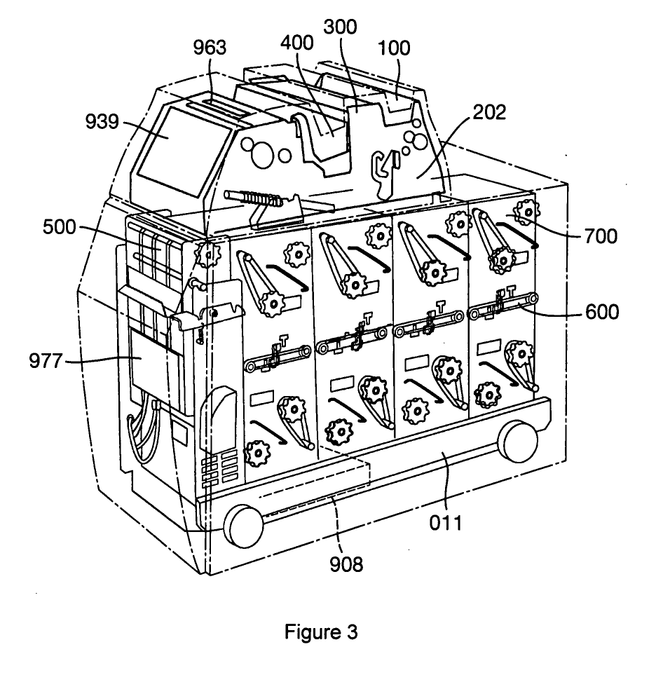

The TCR Twin Safe is enclosed in a cabinet, shown in FIG. 3. The components of the cabinet are:
The secure safe unit 001 which contains the stored banknotes.
Safe door cover 002, hinged and fitted with magnets to keep it closed without locking. A drop box and document box may optionally be fitted inside the cover, in which case the cover will be fitted with locks.
Safe door 003 fitted with a locking system 004.
Top cover 005 with aperture 006 for access to the input tray, and sliding doors 007 for access to the output tray. On some models, an LED 008 may be fitted on either side of the output tray, instead of the sliding doors, to indicate which teller is to retrieve the notes. The top cover can be raised to access the Note Handling Module, for servicing the module or removing banknotes that have become trapped.
Top cover section 009 which can be removed so that the Twin Safe can be slid under the cash desk.

The internal components of the safe, inside the cabinet and under the top cover, are shown in FIG. 3. These are made up of a number of assemblies which are known as “modules” if they perform a specific function and can be physically separated from the system. The modules and other assemblies are as follows:
The Note Handling Module (NHM) which is made up of the following sub-assemblies:
   The Input Module 100 where banknotes are placed in the input tray and fed into the system.
   The Note Reader Module 300 where banknotes are optically examined to determine their currency and denomination.
   The Output Module 400 where banknotes are retrieved, either because the teller has withdrawn them, or the system has rejected them on the input path.
   The transport base unit 202 on which the above three modules are mounted. This consists of a series of transport belts which are complementary to the belt components fitted underneath the modules.
   The Service Display Module 963. This is an optional module which can be fitted above the Output Module, to display event information for service engineers.
The trolley 011, on which the following assemblies are mounted:
   The Storage Transport Module 500 which provides the vertical section of the transport path from the Note Handling Module above to the storage system below.
   The Roll Storage Modules 700 where banknotes are stored between successive windings of Mylar™ tape around a rotating drum. There can be up to eight Roll Storage Units, mounted in pairs, one on top of the other.
   The Note Transport Modules 600. These are sandwiched between the upper and lower Roll Storage Modules, providing the horizontal section of the transport path so that banknotes can be fed to the appropriate Roll Storage Modules.

The following components are also available for control and monitoring purposes:
The Main Control Box 908, mounted on the floor of the safe, underneath the trolley. This contains the Main Control Unit, and it may also contain an optional Network Interface Unit, in case the Twin Safe needs to be connected to an external computer network.
The Note Handling Controller 939, mounted behind the Output Module.
The Storage Transport Controller 977, mounted behind the Storage Transport Module.
The Roll Storage Controllers (see Section 6). Each Roll Storage Module has a controller mounted on the left-hand side.
   0.2 Transport System

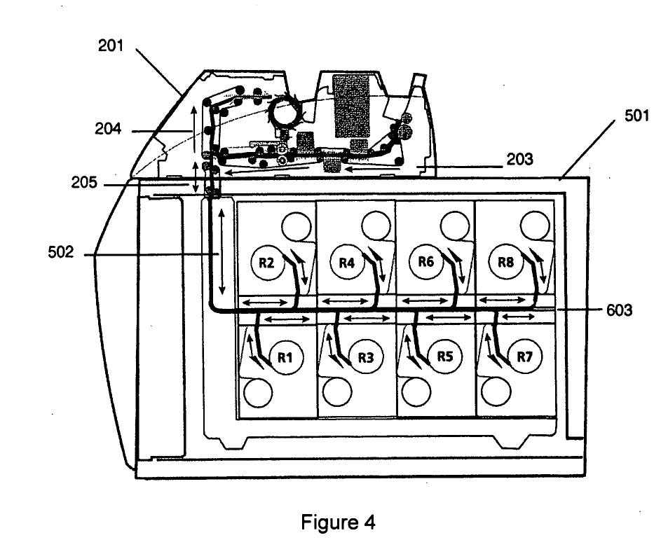

The transport system primarily consists of a series of belts, forming the transport paths shown in FIG. 4. When banknotes are placed in the input tray, they are separated by the Input Module and fed one at a time into the input path 203 which takes them through the note reader and towards a feedgate where they are fed upwards to the output path 204 or downwards through the storage gateway 205 into the storage system below. Notes on the output path are fed to a stacking wheel so that they appear in the output tray.

When notes are fed downwards through the storage gateway 205, they continue vertically downwards through the storage transport path 502, then they turn horizontally and go into the note transport path 603 which is sandwiched between the Roll Storage Modules. As they pass along the note transport path, they reach a series of feedgates where they go upward or downward into the appropriate Roll Storage Modules, depending on which feedgate is open. Within the Roll Storage Modules, they are held between successive windings of Mylar™ tape.

The input and output paths operate in one direction only, from input to output. The storage paths, consisting to the storage gateway, storage transport path and note transport path, operate on both directions, in and out of the system. Banknotes on the input path can be fed down into storage, and then when the notes are to be retrieved, the storage system works in reverse and the banknotes are sent to the output path.

The modules that make up these transport paths are briefly described later, but for more detail see the following documents:
Input Module 100
Note Handling Module (NHM) Transport System 200.—This describes the complete input path, including the transport components of the Note Reader Module 300.
Output Module 400
Storage Transport Module 500
Note Transport Module 600
Roll Storage Module 700

The transport belts are made up of assemblies of complementary pairs of flat belts, facing each other so that the banknotes are held securely between them. This arrangement is used throughout most of the transport system, although there are some variations:
When a banknote passes a sensor head on the Note Reader Module, there is a belt on only one side. However, the note engages with a complementary belt as soon as it leaves the head.
There are points in the Note Transport Modules where there is a belt on one side of the note, but there is a complementary roller on the other side.

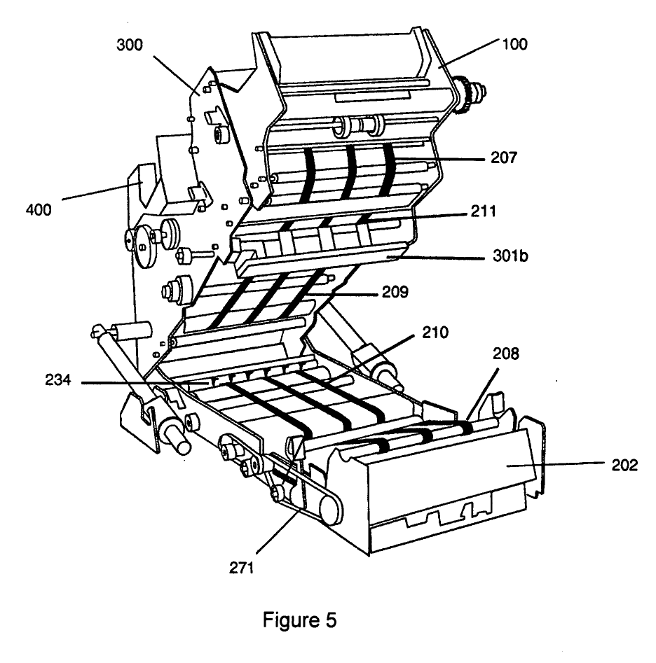

There are three parallel sets of belts and/or rollers throughout the transport system, so that an assembly with complementary pairs has six belts altogether. FIG. 5 shows the arrangement of upper and lower belts on the input path, with the Note Handling Module in the open position (for maintenance or retrieving trapped banknotes). For example, the upper belt assembly 209 is complementary to the lower belt assembly 210. An assembly of three belts is referred to in this documentation as a “transport belt”, and the figure annotations refer to all three belts within the assembly, even though they might point to a single belt.

Banknotes are given additional support by the use of guide rails running parallel to the belts, or guide plates mounted transversely across the width of a belt assembly. Guide rails and guide plates are used as appropriate, depending on the location of other system components such as sensors and feedgates, and are discussed in the documentation of the modules.

The belts are driven by plastic pulleys mounted on metal driveshafts. The pulleys are the “crowned” type, with a convex profile so that their diameter is larger at the centre than at the edges. Flat belts under tension tend to creep upwards to the highest point on their pulleys, so the best tracking is achieved with pulleys that have their highest point at the centre. The use of crowned pulleys has the advantage of providing a smooth surface for the transport of banknotes, and there are no raised edges that would cut grooves in the notes.

The correct profile of the belts is maintained by placing idler shafts at various points along their path. These shafts have crowned pulleys, same as the driveshafts, although the pulleys are free-wheeling and there are spacers to maintain them in the correct position.

The transport system belts should not be confused with the belts for mechanical drive purposes, described later. The pulleys for the mechanical drivebelts have raised edges to keep the belts in place, but the belts do not climb up the edges because they are vertical.

0.3 Transport Feedgates

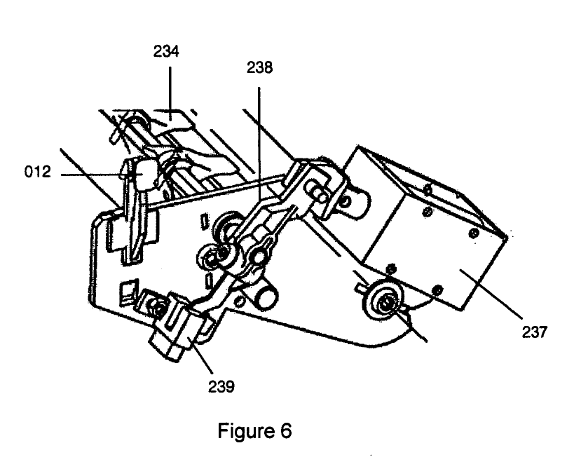

There are a number of feedgates throughout the transport system, directing banknotes in the appropriate direction, depending on their currency, denomination and condition. See for example the feedgate 234 (FIG. 5). They all have a similar design and are operated by a solenoid which connects to the feedgate using a lever. Check sensors are fitted to the solenoids to make sure that they operate correctly when activated. See for example, the feedgate solenoid 237 (FIG. 6). The solenoid operates the lever 238 which opens the feedgate 234, and the other end of the lever passes between the forks of the optical check sensor 239.

The solenoids have pistons which are normally fully extended, but when activated the piston retracts into the solenoid housing. The specific orientation of the solenoid with respect to the feedgate, and the design of the operating levers, varies from one location to another depending on the transport belt system and the required positions of the feedgate when the solenoid is in the active or inactive (default) position.
The default position of the feedgate at the end of the input path is to send banknotes down into storage. This design is used because, during normal operation, the teller places banknotes into the input tray in the expectation that they will be accepted for storage. The solenoid becomes activated in the exceptional circumstance that a note is rejected, For details of this feedgate, see Section 2.3.4.
There are two feedgates on each of the storage units, one sending notes to the upper Roll Storage Module, and the other sending them to the lower module. There can be up to four storage units, with eight feedgates altogether. The default position of these feedgates is to be closed to the Roll Storage Modules so that the notes continue along the path to the next feedgate. This design is used because they only need to open when a banknote of the appropriate category arrives at the feedgate. Further details of these feedgates are given in Section 5.
   0.4 Mechanical Drive Components
   0.4.1 Motors

The transport system, including the belts, driveshafts idler rollers and note guides are described earlier, but the components that supply mechanical power to the transport system are described in general terms here.

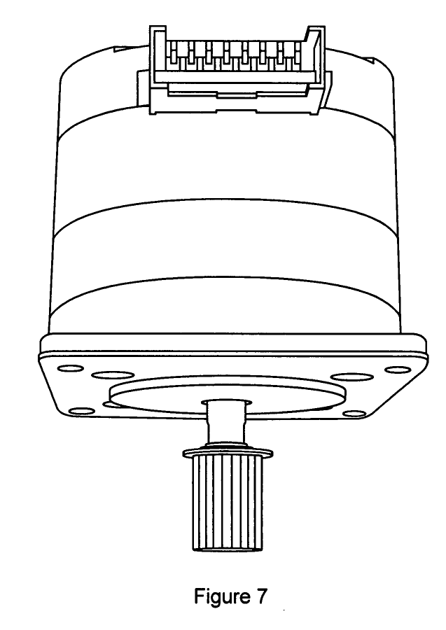

The transport system is driven by a number of electric motors (FIG. 7) at various points throughout the system. These are variable-speed stepper motors that are individually managed from the control units attached to the modules where they are fitted. The motors are fitted at the following points:
One motor is fitted to the Output Module, to drive the belts on both the input and output paths. The output path is driven directly from the motor, but the input path is driven from a clutch which engages when banknotes are placed in the input tray. This motor is managed by the Note Handling Controller, mounted on the Output Module. For details see the NHM Transport System (Section 2).
One motor is fitted to the Storage Transport Module, to drive the belts within the module itself, and also the belts on the note transport path between the storage units, and the short pair of belts at the storage gateway under the Note Handling Module. This motor is managed by the Storage Transport Controller, mounted on the Storage Transport Module. For details see Section 4.
Two motors are fitted to each of the Roll Storage Modules, one to roll the notes in by driving the note storage drum, and the other to roll the notes out by driving the tape storage reels. Only one motor is active at any given time, while the other is idling and exerting a resistance to the motion, maintaining the correct tension in the Mylar™ tape. The two motors in each Roll Storage Module are managed by a Roll Storage Controller, fitted to the module. For details see Section 6.

The motors are capable of measuring torque, so that if a belt or Mylar tape becomes jammed, or for some reason there is an increase in tension, the motors will limit their torque to prevent damage.

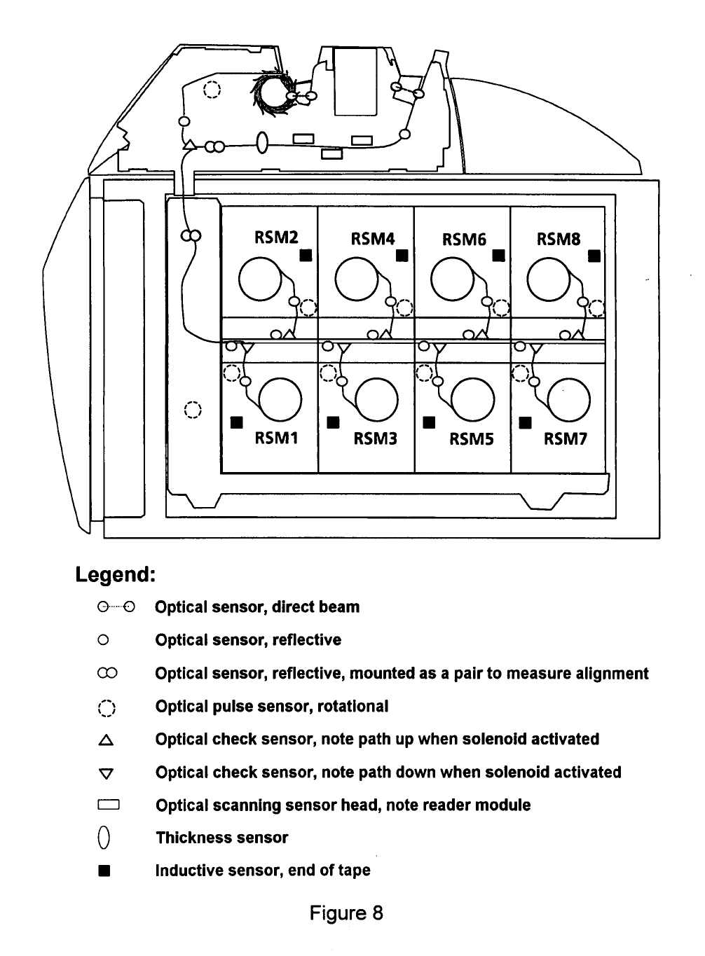

All the transport belts and Mylar tapes throughout the whole system have to run at the same rate, to prevent the notes from being snatched or crumpled as they pass from one section of the transport system to another. If a note leaves a belt and passes to a faster-moving belt, it will be snatched and possibly stretched and torn. If a note is passed to a slower-moving belt it will be crumpled or folded. To ensure that all the belts and tapes run at the same rate, there are rotating counter sensors at various points in the transport system (see FIG. 8). These are described later, but their positions in the transport system are as follows:
A sensor is fitted to the inner driveshaft at the top of the Output Module belt. This sends a signal to the Note Handling Controller to manage the speed of the motor fitted to the Output Module.
A sensor is fitted to the rear belt driveshaft on the Storage Transport Module. This sends a signal to the Storage Transport Controller to manage the speed of the motor fitted to the Storage Transport Module.
A sensor is fitted to an idler shaft on each of the Roll Storage Modules, to measure the speed of the Mylar tape as it passes from the note storage drum to the tape storage reels and back again. The motors have to run at varying speeds because of the varying diameter of the tape windings on the storage drum and reels. The sensor provides a signal to the Roll Storage Controller (fitted to the module) to maintain the speed of the currently active motor.

DC motors (not the same as the variable-speed stepper motors) are also fitted at the following positions:
On the Input Module, to operate the pressure plate.
On the top cover to operate the left and right drawers, allowing access to the output tray.
   0.5 Toothed Wheels and Drivebelts

There are systems of toothed wheels and drivebelts throughout the Twin Safe, supplying drive to the transport belts and other components. The specific features are described in the documentation of the modules, but in general they are as follows:
Toothed wheels are used as reduction gears and are arranged in assemblies to supply drive to the appropriate components, using idler wheels where necessary.
Drivebelts and pulleys are used to transfer drive to points in the system where it becomes inappropriate to use a system of toothed wheels. See, for example, the Input Module drivebelt 271, FIG. 5. The drivebelts and pulleys are serrated to prevent slippage and ensure that the correct gear ratios are precisely achieved. The pulleys have raised edges on one side, to achieve tracking and prevent the belts from slipping off. There are always at least two pulleys on a drivebelt, a drive pulley and a driven pulley, and they are fitted opposite ways round so that one pulley has the raised edge on one side, and the other pulley has the raised edge on the other side, so the belt cannot slip off on either side. Tensioning adjusters, consisting of idler wheels mounted on slotted holes, are used where appropriate to maintain the correct belt tension.
   0.6 Sensors

FIG. 8 shows the position of the sensors within the Twin Safe. There are three basic types of sensor, as follows:
Optical sensor. These have two heads, one to transmit a light beam and the other to receive it. There are a number of different types:
   Direct beam sensor, where the two heads face each other to detect objects placed between them.
   Reflective sensor where both heads face in the same direction and the reflected light from a passing object is detected. A pair of reflective sensors mounted transversely across a transport belt can be used to measure alignment in case a banknote has become skewed.
   Pulse (rotating counter) sensor where there are two heads facing each other across a rotating wheel, measuring pulses of light.
   Check sensor where two heads face each other to detect a lever attached to a feedgate solenoid.
   Scanning sensor. These are used in the Note Reader Module and are capable of reading a banknote and comparing it with a predefined profile to determine its currency and denomination.
Mechanical thickness sensor. This has a floating arm that moves as an object passes underneath it.
Inductive sensor. This detects a metal object passing through a magnetic field.

The sensors work in co-ordination with each other, to monitor the passage of banknotes through the transport system. The belts operate at a carefully controlled rate which is monitored by the rotating counter sensors, and the system calculates the precise time when a banknote should arrive at each of the optical sensors. The sensors on the Note Reader Module detect the currency and denomination of the notes so that they can be assigned to the appropriate Roll Storage Modules. The system calculates which type of banknote should be at any given position on the transport system at any given time, and opens the feedgates as required to send them in the right direction. If a banknote does not arrive at a sensor position when expected, the system will return an error.

The sensors are described in more detail in the following sections.

0.6.1 Optical Sensor (Direct Beam)

This type of sensor is fitted to the input and output trays and is identified by the appropriate legend in FIG. 8. In each case there are two separate components, the transmitter at the front of the tray, and the receiver at the rear. When banknotes appear in one of these trays, the beam is broken and a signal is sent to the Note Handling Controller to take the appropriate action:
When notes are placed in the input tray, the Input Module and the transport belts on the input path will begin to operate.
When notes appear in the output tray, the appropriate drawer will open on the top cover.
   0.6.2 Optical Sensor (Reflective)

There are many of these throughout the Twin Safe, sometimes occurring singly to detect the arrival banknotes on the transport path, and sometimes in pairs, mounted transversely across the transport path to detect the alignment of banknotes, in case they have become skewed.

The two heads on a reflective sensor point in the same direction, so that when a banknote arrives, the light from the transmitter is reflected back to the receiver and a signal is sent to the appropriate controller.

When a sensor occurs before a feedgate it is known as a “reflex sensor” because it will trigger the feedgate to move to the active position to send the note to the appropriate destination.

Single reflective sensors occur at the following points in FIG. 8:
At the entry to the input path. This sensor is mounted on the transport base unit, to detect the entry of a banknote into the system. The signal from this sensor provides the starting point which enables the system to calculate the expected position of the banknote as it passes though the system.
On the output path, just after the feedgate.
On the note transport path, between the Roll Storage Modules. A sensor is mounted in each of the upper and lower Note Transport Modules, up to eight sensors altogether. These are mounted just before the feedgates, and they act as reflex sensors to open the feedgates for incoming notes. They also detect the arrival of notes on the outward path, to indicate that they have passed safely through the feedgates.
Inside the Roll Storage Modules, to detect the passage of notes in and out of storage. When a note is on the outward path, they act as reflex sensors to open the feedgates. A sensor is mounted in each module, up to eight altogether.

Pairs of reflective sensors occur at the following points in FIG. 8:
On the input path, mounted under the Output Module, just before the feedgate. These are reflex sensors, and the feedgate will operate when a note arrives that is to be sent to the output path.
In the Storage Transport Module.
   0.6.3 Rotating Counter Sensor

These are otherwise known as “pulse sensors” or “timing wheels”. They consist of a rotating wheel with long teeth known as “fingers”, mounted on a driveshaft, and a direct beam optical sensor, with two heads mounted on a fork, facing each other across the fingers of the rotating wheel. Each finger breaks the beam as it passes the sensor, creating a series of pulses. These are fed to the appropriate controller, then to the transport belt motors, to accurately control the speed. For a detailed description including illustrations, see the Roll Storage Module (Section 6).

The position of these sensors has been described earlier, in the discussion of motors, but see also FIG. 8. There is one sensor on the Output Module, one on the Storage Transport Module, and one on each of the Roll Storage Modules.

0.6.4 Solenoid Check Sensor

This is a type of direct beam optical sensor, fitted to the feedgate solenoids, to ensure that they operate fully when activated. The heads are integrated into a single unit, facing each other on the ends of a fork at a distance of 3 mm. The sensor returns a signal to the appropriate control unit when a mechanical arm connected to the solenoid passes between the heads. This type of sensor is fitted to all the feedgate solenoids in the system. For example, see the feedgate solenoid check sensor 239 (FIG. 6).

0.7 Note Reader Module

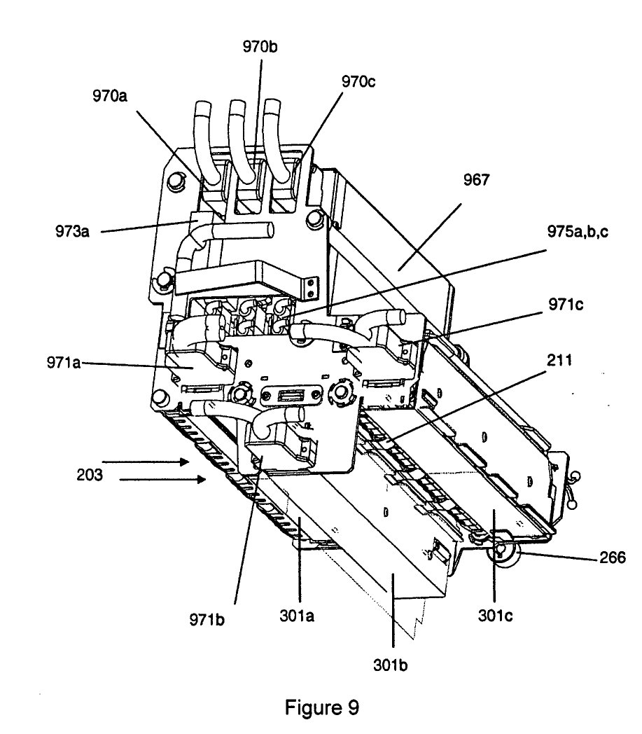

The Note Reader Module (FIGS. 6 and 9) has up to three reader heads. There is a master 301a and there can optionally be one or two slaves, 301b and 301c depending on the scanning requirements. For the position of the heads in relation to the transport system, see FIG. 8.

Each reader head has two scanning sensors, so that the banknotes are illuminated first from the infra-red perspective and then from the green or ultra-violet perspective. The reflected picture is then scanned line for line and electronically interpreted and compared with a number of standard profiles to determine the category and denomination. The angle is also measured to make sure that the notes are not skewed.

Each reader head has its own electronic control unit, mounted at the top of the Note Reader Module.

For further details, see Section 3.

0.7.1 Note Thickness Sensor

This is located on the input path, at the entry to the rear transport belt as the notes leave the Note Reader Module and proceed towards the feedgate. It detects the thickness of banknotes in case two notes have arrived together or a note has become folded. For the position, see FIG. 8.

The sensor consists of two components:
A pair of free-wheeling upper rollers on a floating arm, mounted under the Output Module.
A pair of lower rollers on a driveshaft, mounted on the transport base unit.

As the note passes between the two pairs of rollers, the thickness is measured by the position of the floating arm, connected to a magnetic component that moves within an electric coil. For details of the upper and lower rollers, see the NHM Transport System (Section 2).

0.8 Inductive Sensors

These sensors are fitted to the Roll Storage Modules to detect the ends of the Mylar™ tapes. There is one sensor in each module, up to eight altogether. See FIG. 8.

There are a number of metal strips at intervals near each end of the tape, generating signals as they pass the sensor head, to indicate that the tape is approaching the end. For details see Section 6.

0.9 Modules

The modules of the TCR Twin Safe are briefly described in the following sub-sections, but are described in more detail in the associated document sections.

0.9.1 Input Module

The Input Module 100 (FIG. 3) is the entry point to the system, where banknotes are placed in the input tray and fed into the transport path, one at a time, at a controlled rate. A pressure plate holds the notes against the backplate of the input tray, while a feeder wheel draws them down through a narrow slot. The pressure plate engages and releases, and the slot opens and closes, under the control of a motor and a pair of micro-switches. At the same time, an intermittent clutch linked to the transport system engages and releases, to operate the feeder wheel. The banknotes then pass through a set of rollers that engage them on both sides unequally to separate them, in case two notes are fed down from the input tray at the same time. The rollers are linked to the intermittent clutch, and on one side they feed the notes downward toward the transport route, but on the other side they are almost stationary, having just a small rotation in the opposite direction to avoid becoming worn at a single contact point. There is sufficient friction between the two sets of rollers to separate two notes, but not enough to damage a single note. For further details, see Section 1.

0.9.2 Note Reader Module

This has been discussed already, under Sensors, but for further details see Section 3.

0.9.3 Output Module

The Output Module 400 (FIG. 3) provides the transport path to the output tray, in case notes on the input path have been rejected, or notes are being retrieved from storage. The primary mechanical components are the transport belts, guide rails, rollers and a stacking wheel which deposits the notes to the output tray where they can be retrieved by the teller. The documentation of the Output Module has been incorporated into the NHM Transport System (Section 2).

0.9.4 Storage Transport Module

The Storage Transport Module 500 (FIG. 3) is the vertical section of the transport system, under the storage gateway at the bottom of the Note Handling Module, sending notes in both directions, in and out of storage. It contains a pair of transport belts connecting with the storage gateway at the upper end and the Note Transport Modules at the lower end. For further details see Section 4.

0.9.5 Note Transport Modules

The Note Transport Modules 600 (FIG. 3) provides the horizontal section of the transport system, from the Storage Transport Module to the delivery of notes into the storage units. They consist of two components, the upper and lower Note Transport Modules, sandwiched between the upper and lower Roll Storage Modules. Each component has a feedgate which opens when a note of the appropriate category arrives on the transport route, sending it into the associated Roll Storage Module. For further details see Section 5.

0.9.6 Roll Storage Modules

The Roll Storage Modules 700 (FIG. 3) store the banknotes on rotating drums, held between successive windings of Mylar tape. The modules are mounted in pairs on the storage trolley, one above the other, so that there can be eight modules altogether, each containing different categories of banknote. For further details see Section 6.

0.9.7 Service Display Module

The Service Display Module 963 (FIG. 3) is an optional unit, mounted on top of the Output Module, to display event information for service engineers. It has a two-line display screen and four keys that are used for navigating the menu system and displaying data. Since it is primarily used for servicing, it is documented as part of the Control System (Section 7).

0.10 System Access and Clearing Note Jams

The system is designed for easy access to the internal components, for servicing, maintenance and clearing trapped banknotes.
The Note Handling Module can be accessed by raising the top cover on its hinge, and then the transport belts can be accessed by raising the upper section of the module. The teller can do this at any time to retrieve banknotes that have been trapped, and it does not create any unusual risk because only a small number of notes will be on the input path at any time.
Access to the Roll Storage Modules is available by opening the safe and wheeling out the trolley. It is then possible to manually remove banknotes from the modules and transport paths. The Roll Storage Modules may contain significant amounts of cash, and if this is considered to be a security risk in an open plan office, the trolley can be wheeled off to a secure area.

The access procedures are described in more detail in the following sub-sections.

0.10.1 Opening the Note Handling Module

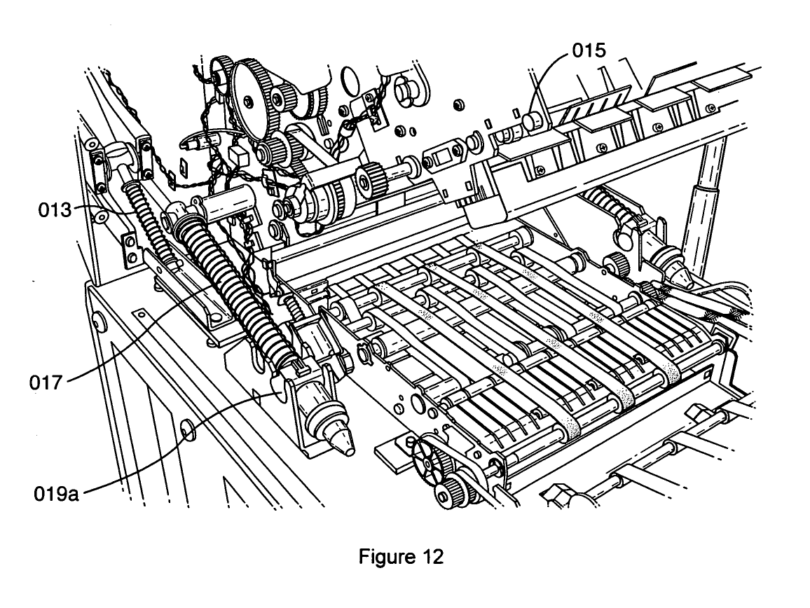

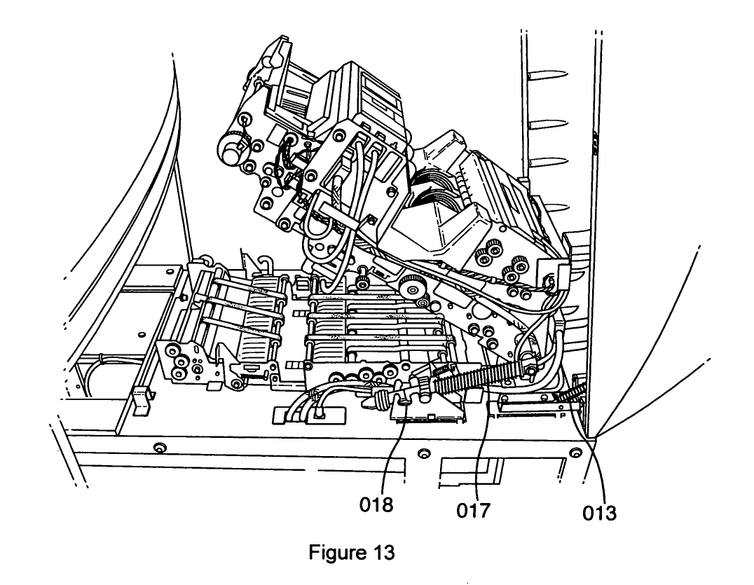

The top cover can be opened by pressing the release button 010 (FIG. 3) and when fully open it will be held up by the spring dampers 013 (FIGS. 12 and 13), mounted on the hinges. The cover can then be closed again so that it engages with the release catch.

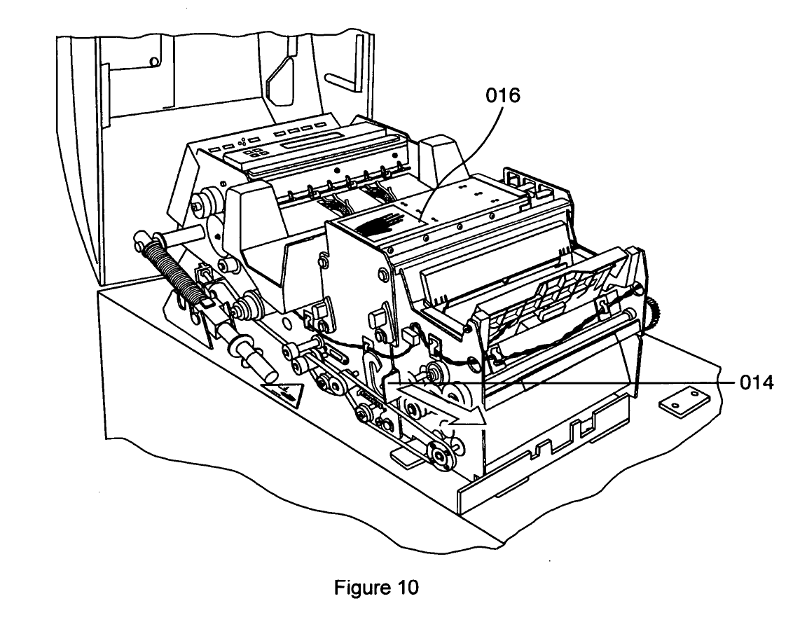

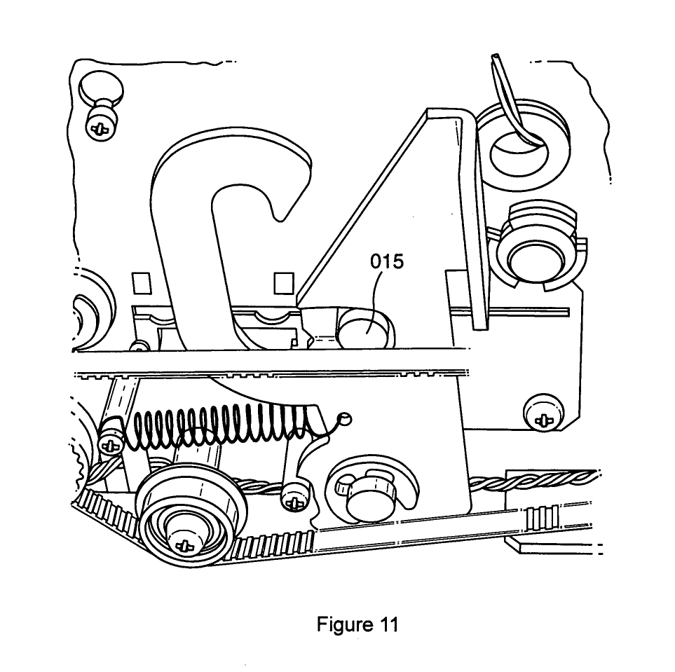

With the top cover open, the Note Handling Module can be opened to access the transport belts. The closed module is held securely in place by a green catch on either side of the base unit, each with a horizontal slot that engages with a pin on the upper section of the module. The two catches are linked by a shaft so that they both operate together. The right-hand catch 014 (FIGS. 10 and 11) has a vertical safety hook so that when the catches are released, by moving them in the direction of the arrow (FIG. 10) the module rises just a small amount and the pin 015 engages with the hook. A hand symbol 016 is printed on the top of the note reader, indicating that the operator should place a hand at this point to control the movement of the module, in case it misses the hook and comes suddenly upwards.

The module can then be opened further by moving the catch in the opposite direction and disengaging the hook, then allowing it to rise slowly. It will be held open on its spring dampers 017 as shown in FIGS. 12 and 13.

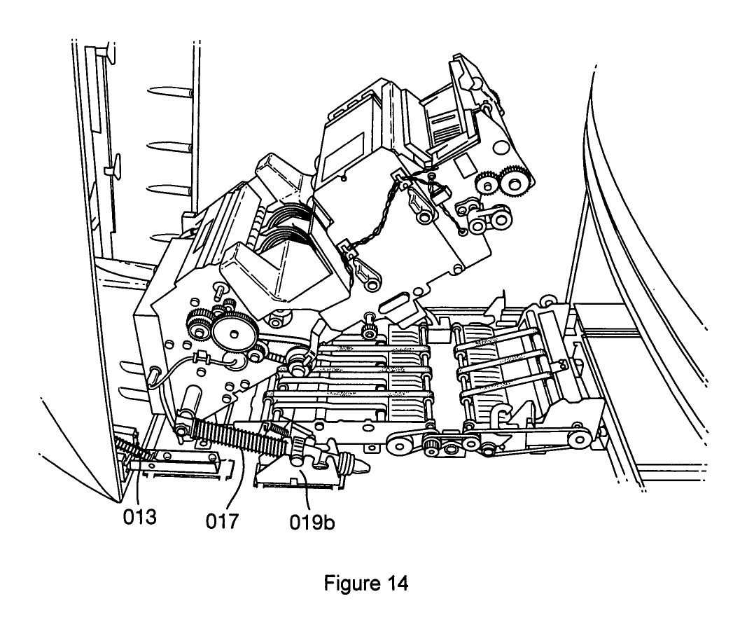

The lower ends of the spring dampers are mounted in open slots on the base unit, shown in FIGS. 12, 13 and 14. There is one slot 018 on the left-hand side and two slots 019a and 019b on the right. When the module is first opened, the right-hand damper is in the front slot 019a (FIG. 12), but it can be moved to the rear slot 019b (FIG. 14) to open the module further. Two operators are required to do this, because the module has to be lifted while both the left and right dampers are taken out of their slots. The right damper can then be placed in its rear slot and it will take the weight of the module while the left damper is laid to rest on its bracket behind the slot. Only the right damper is needed to hold the module in this position, although the left damper will fall into its slot if the module is lowered slightly.

The right damper must always be in one of the slots, front or rear, to securely support the module.

The module can be closed by performing the operation in reverse. If the right damper is in the rear slot, it has to be moved to the front slot. Then the module can be carefully pushed down by applying pressure to the hand symbol 016 (FIG. 10) until it engages securely with the green catches 014 on either side.

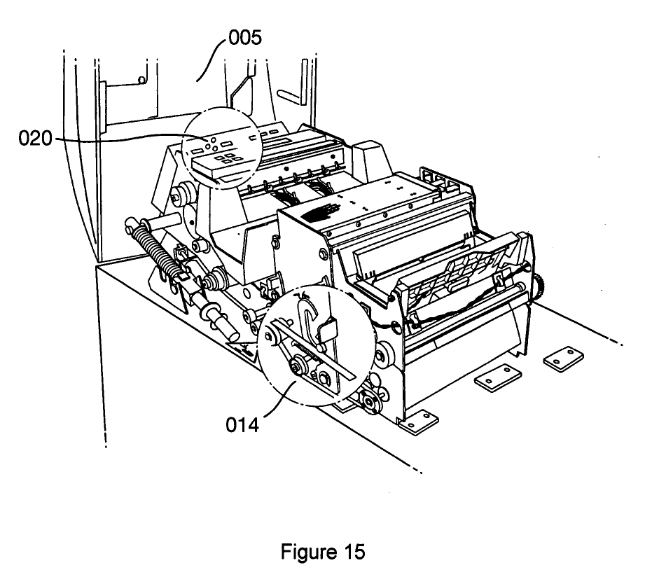

The red LED 020 (FIG. 15) at the top of the Note Handling Controller is linked to the note thickness sensor on the input path, and normally it should be continuously illuminated when the Twin Safe is switched on. If it flashes, it indicates that the thickness sensor needs adjustment or the Note Handling Module is not fully closed.

With the Note Handling Module in the open position, note jams can be cleared from anywhere along the input path, including the entry points to the storage feedgate and the output path. Details of clearing note jams are described later.

0.10.2 Removing the Trolley and Opening the Storage Units

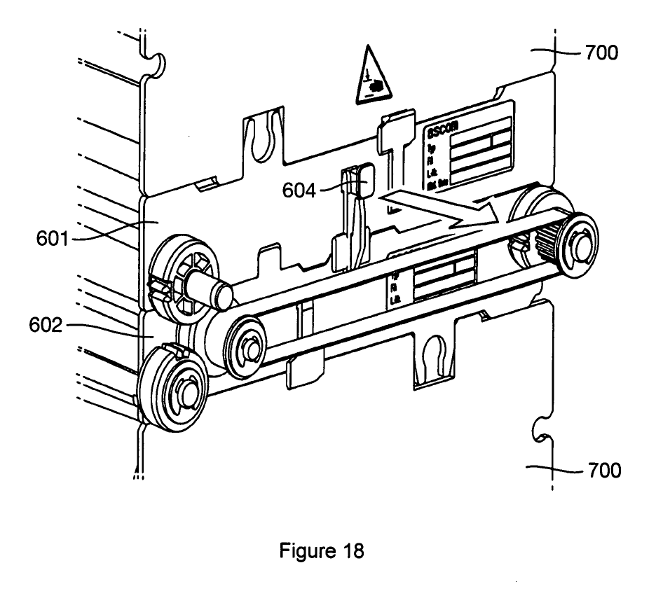

To access the storage units, it is necessary to open the safe and pull out the trolley. A storage unit consists of a pair of upper and lower Roll Storage Modules 700 (FIG. 18), with a pair of upper and lower Note Transport Modules 601 and 602 sandwiched between them. To access the note transport path, it is necessary to open a storage unit by raising the upper section on its hinge.

The safe is fitted with a locked door 003 and an outer cover 002 (FIG. 3). The cover is fitted with magnets to keep it closed, but if it has drop boxes it will also be fitted with locks.

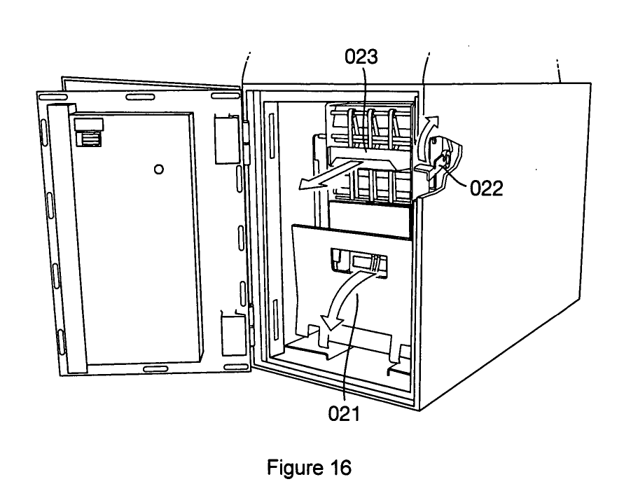

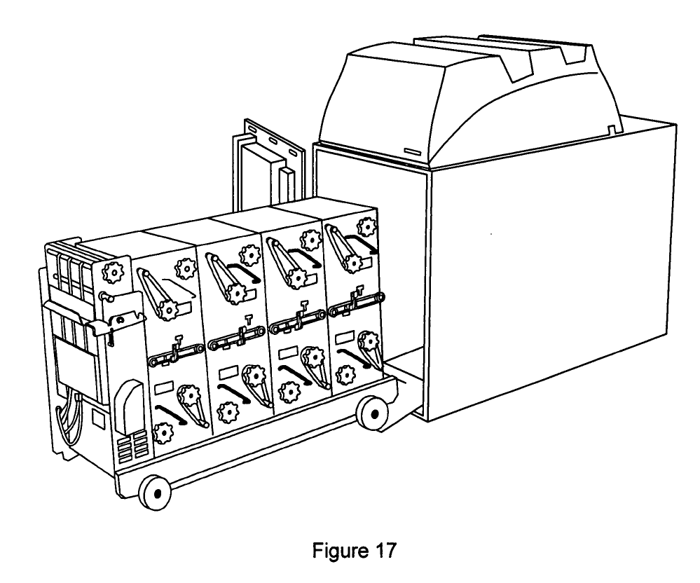

With the safe door open, the trolley can be removed by lowering the ramp 021 (FIG. 16) and releasing the green catch 022, then pulling on the handle 023. The fully removed trolley is shown in FIG. 17.

When the trolley is pulled out from the cabinet, it will disengage the following components:
The mains power sockets at the right-hand side.
The power and data sockets at the left-hand side which connect to the Note Handling Module above, and the Main Control Unit below. For details see Section 7.
The toothed wheel at the top of the Storage Transport Module, which drives the storage gateway at the bottom of the Note Handling Module. For details see Section 4.

When the trolley is returned to the storage cabinet, it is necessary to ensure that these components are fully engaged.

The handle 023 is an important safety feature, to prevent the operator's fingers from being crushed at the top of the trolley when returning it to the cabinet. A warning label is displayed on the top of the trolley to indicate that the handle should always be used.

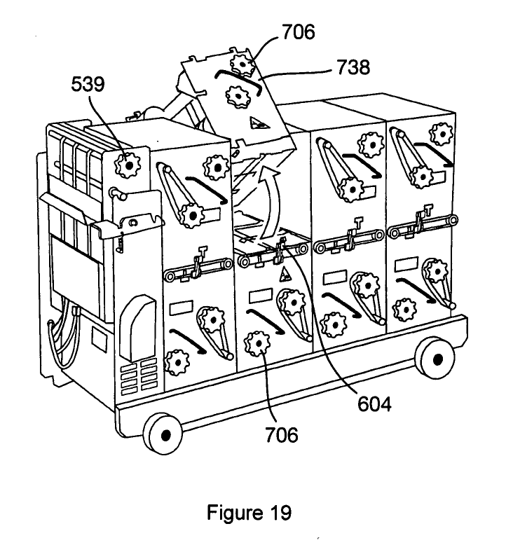

With the trolley removed from its cabinet, each of the storage units can be opened by pulling out the green clip 604 (FIG. 18) so that it disengages, then lifting the upper section of the storage unit using the handle 738 (FIG. 19). The hinge is designed so that it offers some resistance at a stop point when the unit is partially open. When the unit is lifted past the stop point and then gently lowered, it will remain in the elevated position, sufficiently open to enable the operator to retrieve banknotes. The unit can then be closed by pushing it down past the stop point and re-engaging the green clip.

0.10.3 Clearing Note Jams

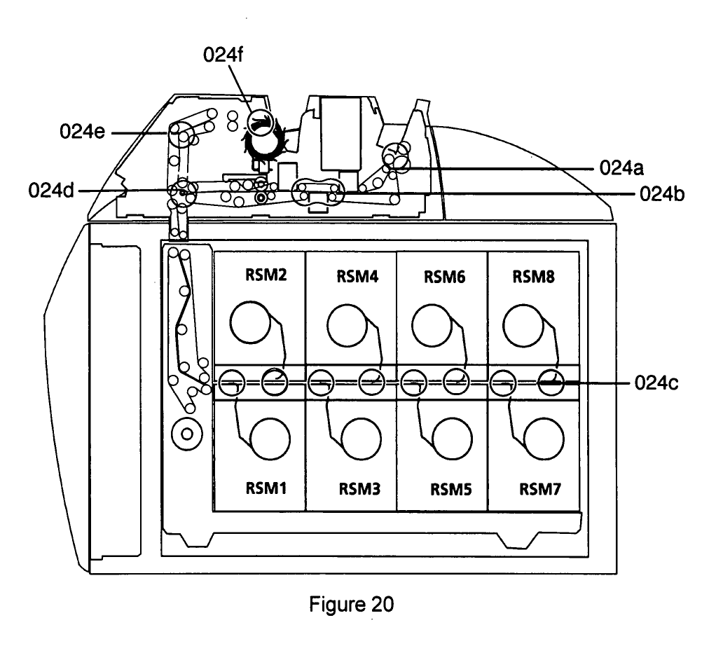

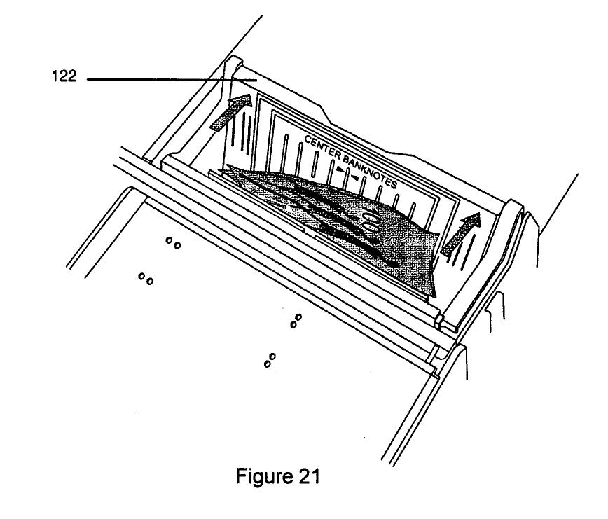

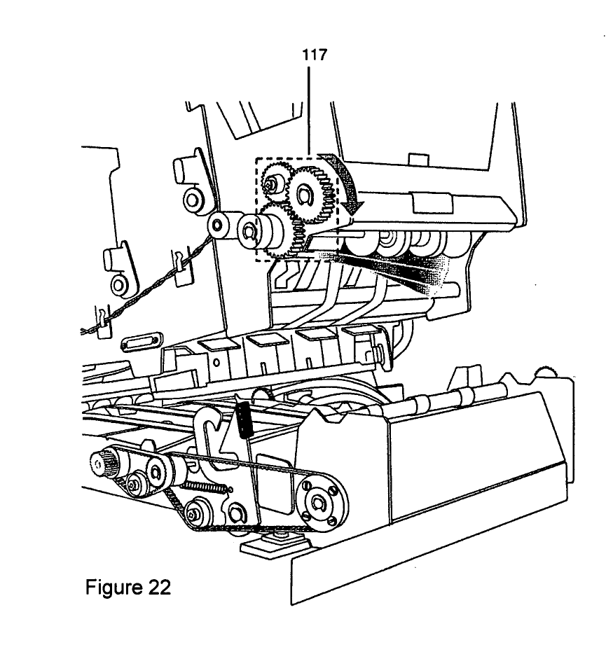

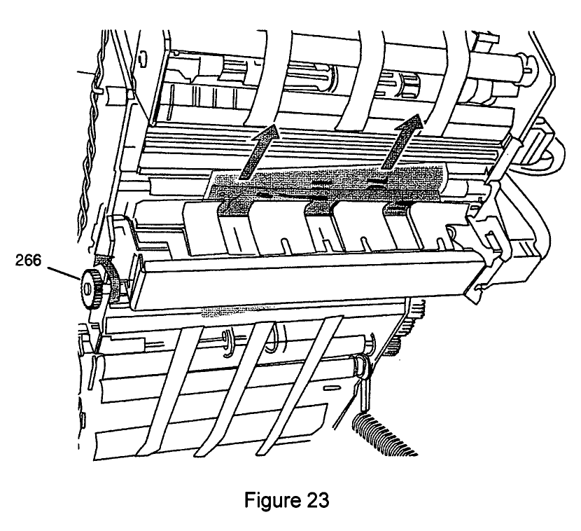

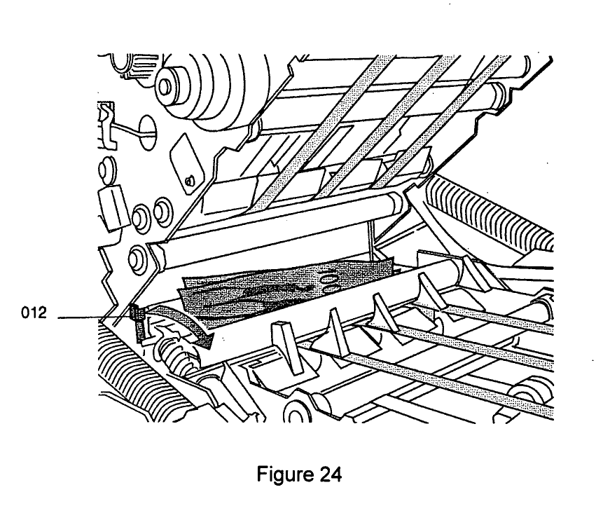

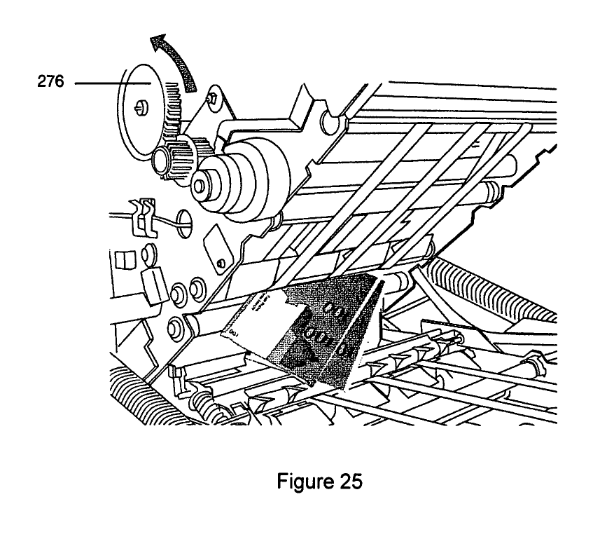

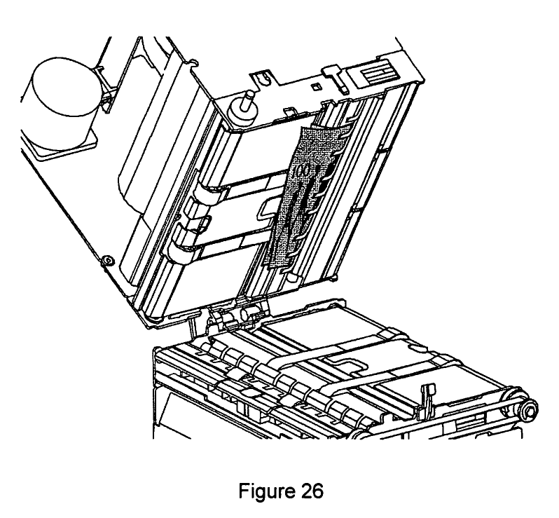

Trapped banknotes can be removed by opening the appropriate components to gain access to them. The points 024a-024f where notes are most likely to become trapped are shown in FIG. 20, and these can be dealt with as follows:
Notes can be removed from the input tray by pressing forward the front plate 122 (FIG. 21) in the direction of the arrows and pulling out the notes. In this case there is no need to open any components.
With the Note Handling Module open, notes can be removed from the following positions:
   From underneath the Input Module, by turning the system of toothed wheels 117 (FIG. 22) in the direction of the arrow.
   From the Note Reader Module by pulling them out and turning the toothed wheel 266 (FIG. 23) in the direction of the arrows.
   From the storage feedgate, by pulling the green lever 012 (FIGS. 6 and 24) to lift the feedgate mechanism away from the transport belt, and then pulling out the notes.
   From the entry to the Output Module, by carefully pulling them out. If they won't come out from the bottom, they can be sent to the output tray by turning the toothed wheel 276 (FIG. 25) in the direction of the arrow.
With a storage unit open, notes can be removed by opening the feedgate by hand, then pulling out the notes (FIG. 26). In the event that a note is trapped inside a storage unit, it can be directed toward the feedgate by turning the handwheel 706 (FIG. 19). The handwheel is ratcheted so it can only turn in one direction.

When a note becomes trapped and the system stops, other notes might become stranded at various points in the system, and can be removed as follows:
Notes that are stranded in the Note Handling Module can be removed by opening it up and retrieving them.
Notes that are stranded in the storage system can be removed by pulling out the trolley and turning the handwheel 539 (FIG. 19). This will remove the notes from both the vertical and horizontal sections of the transport path, provided they are not stuck in a feedgate. The handwheel is ratcheted so it can only turn in one direction.
   0.11 Extended Working Environment

The TCR Twin Safe can operate as a stand-alone system, or it can be connected to a host computer or network. It can also be connected to a journal printer and up to four Safemaster units, two on either side for use by the appropriate teller.

0.11.1 Stand-Alone System

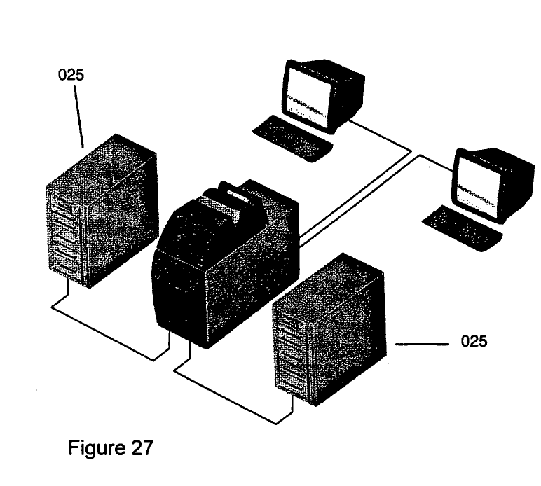

FIG. 27 shows a Twin Safe in stand-alone mode with two Safemaster units 025, one on either side.

The terminals and Safemasters have serial ports which connect to the Main Control Unit of the Twin Safe.

In stand-alone mode, the Twin Safe is operated from the terminals using the TSUser32 software, and is configured using the TSConfig32 software. These applications run in Windows 95, 98 or NT, although other operating systems are available on request.

0.11.2 Connection to a Host Computer

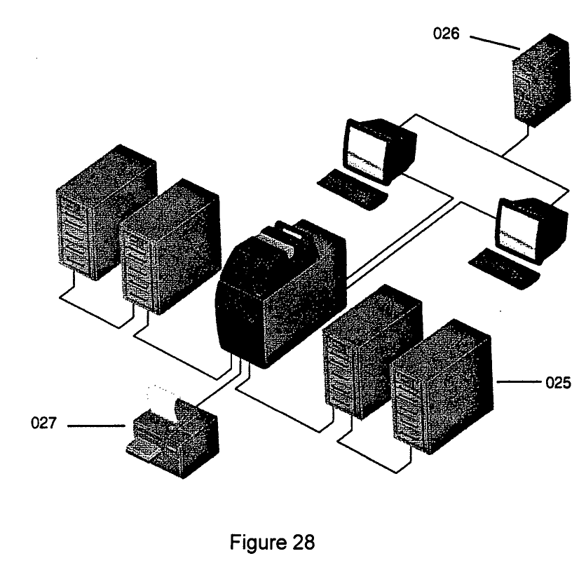

The Twin Safe can be connected to the Electronic Data Processing (EDP) host computer 026 of the bank, normally via the two terminals, as shown in FIG. 28. The terminals connect to the Twin safe in the usual way, but they also connect to the host computer. In this configuration, instead of running the TSUser32 software, they run a program on the host computer that integrates the standard functions of the Twin Safe.

The following packages are available for writing applications:
Communication Handler (Dynamic Linked Library)
XFS Service Provider, CEN CWA 13449
TCR Twin Safe Simulator package
Graphical User Interface with High Level API

FIG. 28 shows the Twin Safe connected to four Safemaster units 025 and a journal printer 027. There are connections on the Main Control Unit for only the first two Safemaster units, and the additional units are daisy-chained onto them. The journal printer is connected to a parallel port on the Main Control Unit.

0.11.3 Connection to a Network

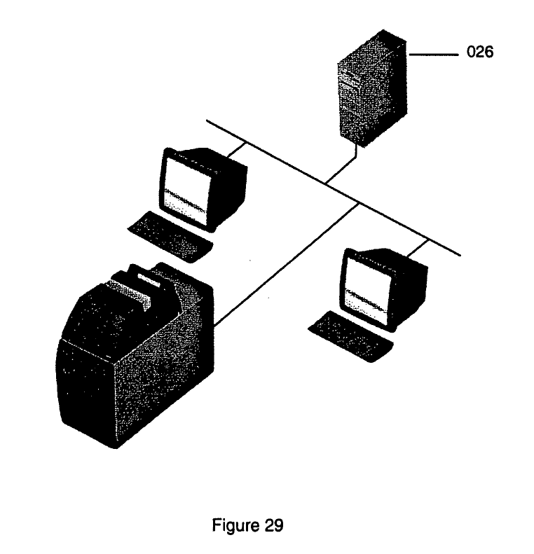

The Twin Safe can be connected to a standard network, for example Ethernet, as shown in FIG. 29, and in this configuration it can be controlled directly from the host computer. The network connection is through a Network Interface Unit, mounted alongside the Main Control Unit in the Main Control Box. The Network Interface Unit is an industrial PC with its own hard disk and can run standard network software and other applications as required.

0.12 Alarms

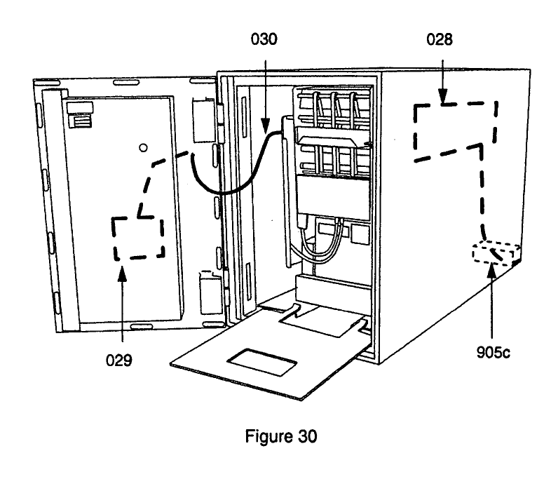

The Twin Safe can be fitted with an internal alarm 028 or 029, in the storage cabinet or in the safe door as shown in FIG. 30. The alarm is wired to a terminal block 905c in the cabinet, together with the alarm wiring from the Main Control Unit. If the alarm is fitted to the safe door, the cable 030, together with any other cables that are required for the door components, will be protected by metallic shielding or a ducting system.

The Twin Safe can also be connected to an external (bank) alarm, so that signals can be passed in both directions. If an alarm occurs on the Twin Safe, it will trigger the bank alarm, and if a bank alarm occurs as a consequence of other events, it will trigger the alarm on the Twin Safe.

The type of alarm depends on how the system has been set up. Normally they are silent, and withdrawals from the Twin Safe are suspended during an alarm condition. The operator can manually trigger a silent alarm from the terminal.

0.13 Electronic Control System

This section gives a brief summary of the control system, which consists of a number of controllers that communicate with each other, primarily through the Control Area Network (CAN) bus. Each control unit is identified by a unique address, and each CAN connector has two sockets so that the units can be daisy-chained together.

A brief description of the control units is given below, but for further details see Section 7.

0.13.1 Main Control Unit

The Main Control Unit is mounted in the Main Control Box 908 (FIG. 3), bolted to the floor of the storage cabinet underneath the storage trolley. It co-ordinates all the features of the Twin Safe and communicates with the other controllers through the CAN bus. It also connects to the following external units:
The two terminals used by the tellers.
A host computer, through the terminals.
Up to four Safemaster units, two connected directly and the other two daisy-chained onto them.
A journal printer.
The bank alarm and other alarms.
A modem, for accessing remote systems through the telephone networks.
A service PC, for setting up the unit.
Import and export of data is available through a memory card fitted to the PCMCIA slot.
   0.13.2 Network Interface Unit

This is an optional PC with a hard disk, mounted alongside the Main Control Unit in the Main Control Box 908 (FIG. 3). The Network Interface Unit provides the connection to a host computer over a standard network as shown in FIG. 29. It also connects to the following external units:
Keyboard
Mouse
Monitor
An external PC or other device, using a serial port.
   0.13.3 Note Handling Controller

The Note Handling Controller 939 (FIG. 3) is fitted to the back of the Output Module and controls the sensors, motors, switches and other components of the Note Handling Module. This includes the Input Module, Output Module, and the components of the transport base unit. However, it does not control the Note Reader Module which has its own controllers (although it does control the transport belt mounted under the Note Reader Module as this is part of the transport system).

The Note Handling Controller is linked to the Main Control Unit through the CAN bus, and the other CAN socket connects to the Service Display Module, if fitted, otherwise it connects to the Note Reader Module.

0.13.4 Note Reader Controllers

Within the Note Reader Module 300 (FIG. 3), there is one control unit for each of the sensor heads, up to a maximum of three. They are daisy-chained together on the CAN bus, and one socket in the chain connects to the Service Display Module, if fitted, otherwise it connects to the Note Handling Controller.

0.13.5 Storage Transport Controller

The Storage Transport Controller 977 (FIG. 3) is fitted to the back of the Storage Transport Module, and controls the motor and sensors within that module. It connects to the Main Control Unit through one of its CAN sockets, and the other socket connects to the first of the Roll Storage Controllers.

0.13.6 Roll Storage Controllers

A Roll Storage Controller (see Section 6) is fitted to each of the Roll Storage Modules, up to eight altogether, and controls the motors and sensors within the module. It also controls the associated upper or lower Note Transport Module, including the feedgate solenoid, check sensor and reflex sensor.

1. Input Module 100

1.1 Overview of the Input Module

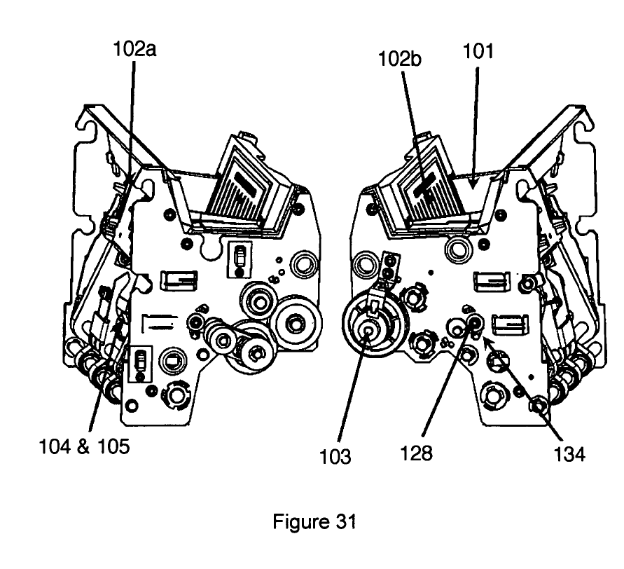

The Input Module overview is best shown in FIG. 31. The Input Module 100 accepts banknotes into the Twin Safe and separates them, placing a suitable distance between them. The Input Module passes the notes on to the Note Reader Module 300, after which the notes are then accepted into the safe one by one.

The Input Module 100 consists of an input compartment 101, a feeder system component and a transport system component. The sensor 102 controls the operation of the Input Module as it accepts and separates the bank notes.

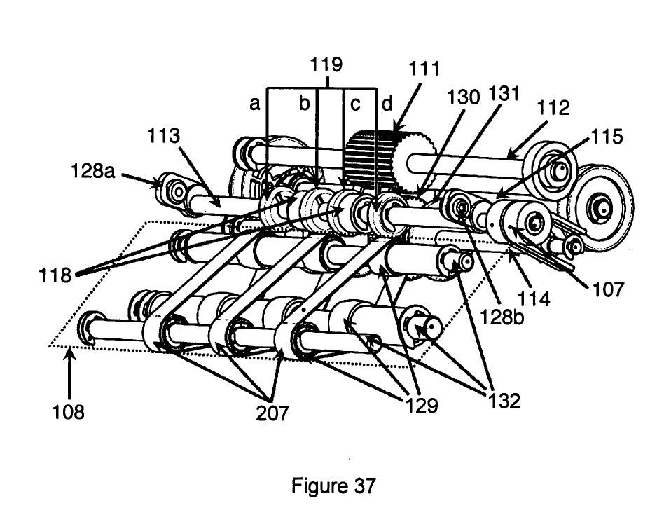

The input compartment 101 provides the entry point for the banknotes and initial separation. Each note is then fed into a transport system 108 (FIG. 37), which carries out further separation and moves the notes toward the Note Reader Module 300.

The input compartment 101 walls—including associated pusher plate 109—are made of a plastic material, whilst the outer plates 110 that form the chassis of the module are made from metal. The rollers 111, 118, 119 130 and 131 and toothed wheels 117 of the feeder and transport systems are mostly constructed of rubber or plastic on metal shafts.

1.2 Input Compartment 101

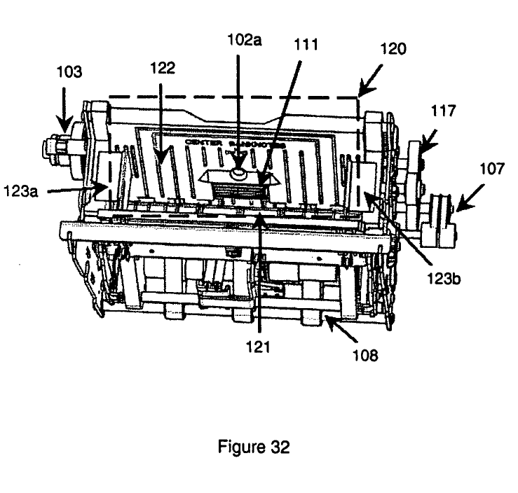

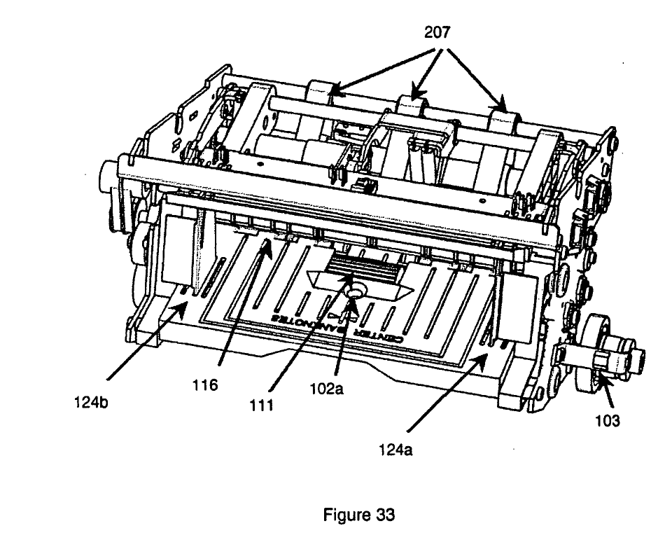

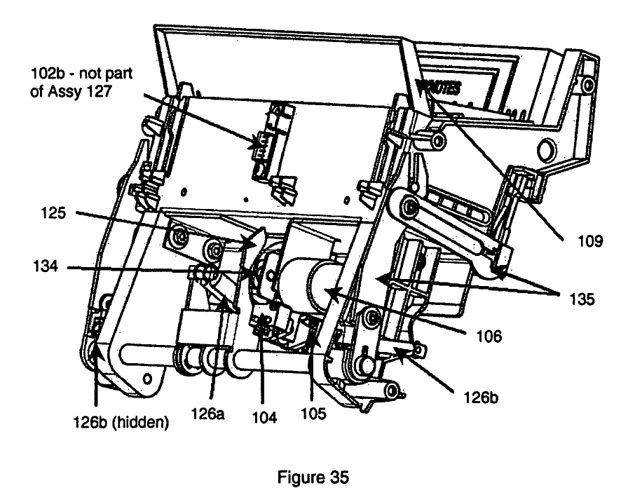

The input compartment 101 is best seen in FIG. 32 and comprises:
A sensor 102, comprising two components, which detects the presence of bank notes and initiates the note input procedure.
An input tray 120 into which a bundle of unsorted banknotes is placed
A feeder assembly 111 and 116 (FIG. 33) for feeding the banknotes from the input tray 120 into the transport system 108
A pusher plate assembly 127 (FIG. 35) for urging the banknotes into the feeder assembly
   1.2.1 The Input Compartment Sensor 102

The whole process begins when banknotes are introduced into the input compartment 101, where they cover the sensor unit 102. This unit consists of two sensor heads 102a and 102b at the front and rear of the input tray 120, one transmissive and the other receptive. There is a cut out in the pusher plate 109 that allows these two sensor heads to align to each other. When the infra-red beam passing between the two heads 102a and 102b is interrupted, the unit knows that banknotes have been inserted into the input tray. The sensor 102 is continuously monitored by the banknote separator electronics and software, and the deposit process starts when the presence of a banknote is detected in the input compartment 101. The sensor 102 is also used to terminate the deposit process when the input compartment 101 becomes empty. The sensor 102 activates both the pusher plate motor 106 and the clutch drive 103 that turns the control shaft 115.

1.2.2 The Input Tray 120

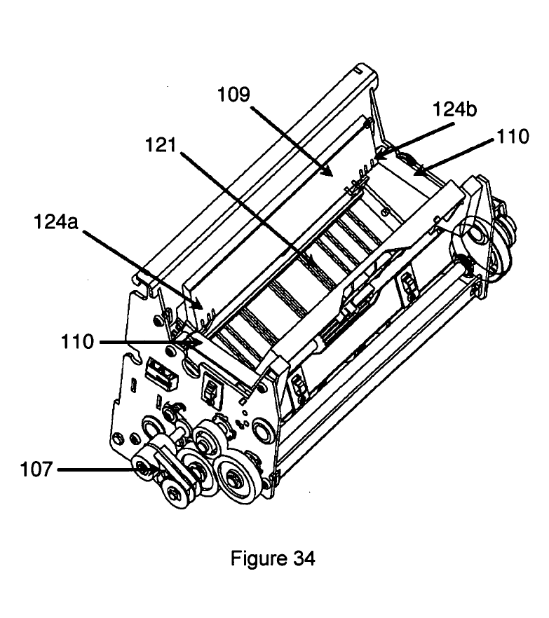

As shown in FIG. 32 and FIG. 34, the input tray 120 has a base plate 121 and is enclosed by the front plate 122, the pusher plate 109 and two opposing side walls 110.

When in use, banknotes are placed unsorted into the input compartment 101, resting on their long edges on the base plate 121, supported against the front plate 122.

Note guides 123a and 123b are provided parallel to the side walls 110 and can be adjusted along three slots 124a and 124b on each side of the input compartment 101 until they are separated by the maximum width of the banknotes to be sorted. These note guides 123a and 123b sit at the top of the opening to the input tray to guide the notes within a range width. The note guides 123a and 123b can be moved to one of three slots 124a and 124b depending on the currency (i.e. bank note width) that the user expects to encounter. Once set for a country's currency, they would not normally be adjusted in use.

The sizes of banknotes accepted are:
Minimum 119×60 mm
Maximum 195×110 mm

The input compartment 101 can hold up to 300 banknotes, and the safe will accept these banknotes at a speed of 5-8 notes per second.

1.2.3 Feeder Assembly 111 and 116

When the pusher plate assembly 127 is deployed (this is described in detail later), a narrow gap (feeder slot) 116 opens up between the input tray base plate 121 and the front plate 122 (see FIG. 32), through which each banknote is fed to enter the Twinsafe. The pusher plate 109 is deployed to force the banknotes against the front plate 122 and the feeder wheel 111. This action draws the notes down into the feeder slot 116 (see FIG. 33) one by one.

1.2.4 Pusher Plate Assembly 127

The pusher plate assembly 127 is best seen in FIG. 35. It consists of:
Pusher plate 109
Guide bars 135
DC Motor 106
Thumb roller on short arm 134
Over centre cam 125
Micro-switches 104 and 105
Springs 126a and 126b

Once the input compartment sensor 102 determines that banknotes have been inserted into the input compartment 101, the Input Module 100 will act to deploy the pusher plate 109, holding the banknotes in place whilst they are fed into the safe. The guide bars 135 open a feeder slot 116 at the base of the input compartment 101 as the pusher plate 109 moves into position. This feeder slot 116 is used to feed banknotes into the Note Reader Module 300.

The pusher plate 109 helps to ensure that the notes are centred and not skewed when they enter the Note Reader Module 300. It holds the notes against the feeder wheel 111, where they are drawn into the transport system 108 and onwards to the Note Reader Module 300.

Upon a signal from the sensor 102, the motor 106 releases the pusher plate assembly 127 from the parked to the deployed position; this assembly holds the notes against the feeder wheel 111. The notes are then drawn into the unit via the feeder slot 116 underneath the feeder wheel 111. To release the pusher plate 127, the motor 106 turns a thumb roller mounted on a short arm 134 to release the over centre cam 125. The movement of the over centre cam 125 permits the guide bars 135 to move under the force applied by springs 126b. The upright guide bar 135 is attached to the pusher plate 109 and moves it forward, whilst the attached horizontal guide bar 135 is attached to the input tray front plate 122 and moves it slightly forward to open the feeder slot 116. This brings the pusher plate 109 to bear on the notes, and opens the feeder slot 116 by spring pressure alone.

The rate of feed of banknotes is controlled by repeatedly engaging and disengaging the input clutch 103 on the control shaft 115. This prevents thick objects being drawn into the unit, and maintains a constant distance between successive notes.

A micro-switch 104 detects that the pusher plate 109 is in the parked position and another micro-switch 105 detects when the pusher plate assembly 127 is in the fully deployed position. Detection is achieved by monitoring the position of the thumb roller and short arm 134. As the motor 106 turns the thumb roller and short arm 134, the thumb roller comes into contact with one or other of the micro-switches. The purpose of these micro-switches 104 and 105 is to monitor the correct functioning of the release motor 106 as it turns the thumb roller and short arm 134, not the engagement of the pusher plate mechanism itself.

Once the input compartment 101 is empty the motor 106 returns the pusher plate assembly 127 to the parked position and locks it in that position through the use of an over-centre cam 125.

The additional middle set of springs 126a provide the “give” within the cam mechanism that allows the motor 106 to achieve an over-centre/locked position.

1.3 Shaft Assemblies

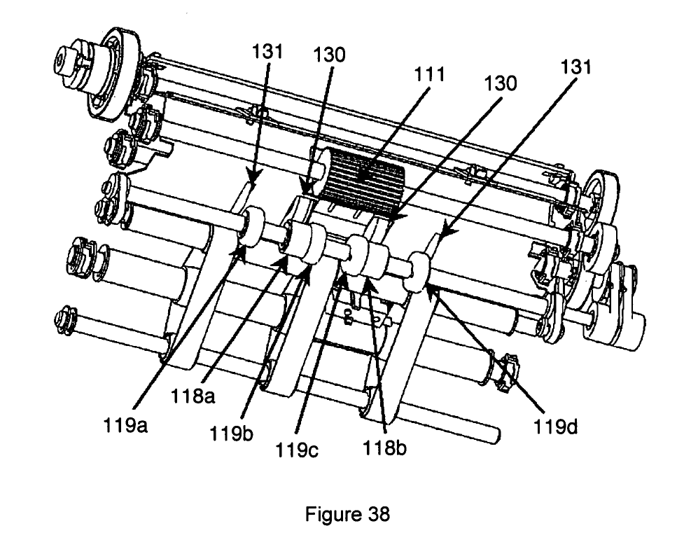

Banknotes are placed into the input compartment 101, where a sensor 102 detects their presence. The sensor activates a small DC motor 106 that releases the pusher plate 109, pressing the notes against a feeder wheel 111. At the same time a clutch drive 103 is engaged to turn the control shaft 115 which in turn, using three toothed wheels 117 and an over-run style clutch 107, drives three further shafts: a feeder wheel shaft 112, a slave shaft 114 and a contra-rotating shaft 113.
On the feeder wheel shaft 112 is mounted the feeder wheel 111 which extends into the input compartment 101 and feeds the banknotes downwards into a feeder slot 116.
On the slave shaft 114 are mounted four fixed rollers 130 and 131, the two inner rollers 130 have serrated edges and act with the black rollers 118a and 118b on the contra shaft 113 to separate banknotes, and two outer larger thin rollers 131 which act with the red rollers 119a, 119b, 119c, and 119d on the contra shaft 113 to crinkle the notes as they enter the feeder slot 116. See FIG. 38 to view the interaction between the various rollers.

On the contra shaft 113 are mounted two black rollers 118a and 118b and four red rollers 119a, 119b, 119c, and 119d (see FIG. 37). They have two purposes, firstly to provide friction against all the other rollers to ensure only single banknotes are fed into the feeder slot 116, and secondly to prevent notes becoming skewed as they are fed into the Note Reader Module 300.

A banknote is drawn into the feeder slot 116 by the action of the pusher plate 109 and the feeder wheel 111, and pressed onto the rollers 130 and 131 on the slave shaft 114 and contra shaft 113. The action draws the note towards the Note Reader Module 300, ensuring a suitable distance between each note. Each engagement and disengagement of the clutch mechanism 103 draws another note into the unit and determines the inter-note spacing.

1.3.1 Control Shaft 115

The control shaft 115 is best seen in FIG. 37. There is a gear wheel 103 (part of the input clutch drive, FIGS. 31 and 33) on the control shaft 115 that is driven by the transport system main motor 251 (see Section 2). This gear freewheels on the control shaft 115 until the input clutch 103 is engaged, locking the gear to the control shaft 115 and providing drive to the remaining Input Module shafts 112, 113, and 114.

As soon as the sensor 102 in the input compartment 101 detects the presence of banknotes, the control software engages the input clutch drive 103, which drives the control shaft 115. The clutch 103 locks the wheel to the shaft 115 and transfers drive to the feeder wheel shaft 112, the slave shaft 114 and the contra shaft 113 via the gear set 117.

1.3.2 Feeder Wheel Shaft 112

The feeder wheel 111 extends into the input compartment 101 and feeds the banknotes downwards into a feeder slot 116. The feeder wheel 111 is mounted onto the feeder wheel shaft 112, which runs outside of the input compartment 101, with the feeder wheel 111 itself positioned within a cutout in the wall of the input tray front plate 122 below one of the input compartment sensors 102. This shaft 112 is driven by the control shaft 115 via a set of toothed wheels 117. Because the rate of feed of the banknotes is controlled by repeatedly engaging and disengaging the clutch mechanism 103, the feeder wheel 111 turns in a pulsing action driving a single banknote down into the feeder slot 116 with each pulse.

1.3.3 Slave Shaft 114

The slave shaft 114 is driven by the control shaft 115 via a set of toothed wheels 117 and contains four rollers: inner rollers 130 (2 off) and outer rollers 131 (2 off).

FIG. 38 demonstrates the connection between the two inner rollers 130 and the two black contra rollers 118a and 118b, and the overlap with two of the red contra rollers 119b and 119c on the contra shaft 113.

The inner two rollers 130 act against the black contra rollers 118a and 118b on the contra shaft 113 to continue advancement of individual notes towards the transport system 108 after they have been initially drawn through the feeder slot 116 by the feeder wheel 111; they also work with the two inner red contra rollers 119b and 119c to aid in crinkling the centre part of the banknote (see below).

The two inner rollers 130 are fitted with one-way clutches that only allow rotational movement in one direction; thus they can freewheel in the direction of note feed, but are fixed to the shaft in the opposite direction. They are driven in the feed direction (along with the feeder wheel 111) until the note is in the transport system 108 and is accelerated away. The bearings in the inner rollers 130 act as over-run clutches thus providing the freewheel capability, this ensures that the note is not stretched if the belts 207 in the transport system 108 run faster; in addition, if the feed stops, then the note can still be pulled through and removed from this set of rollers because of the freewheeling action.

The two thin black outer rollers 131 (FIG. 38) are fixed to the shaft 114 and cannot freewheel in either direction. They act against the two outer red rollers 119a and 119d on the contra shaft 113 to crinkle the outer portions of the banknote. The relative positioning of all these rollers (131, 119, 118, 130) crinkles the notes slightly along its length; crinkling of the notes helps to separate multiple notes that may be sticking together and have been drawn thus far into the system in a single action.

1.3.4 Contra Shaft 113

The contra shaft 113 is driven by the two over-run clutches 107 and holds two black rollers 118a and 118b and four red rollers 119a, 119b, 119c and 119d. All six rollers on the contra shaft 113 are fixed and cannot freewheel. The contra shaft functions correctly when it is effectively stationary compared to the rotational velocity of the other shafts. However, to avoid uneven wear on these rollers 118 and 119, the contra shaft 113 is driven by twin over-run clutches 107. These clutches act to rotate the contra shaft 113 very slowly, just rotating it enough to provide even wear on the six fixed rollers 118 and 119. Having two clutches provides continuous drive and avoids the need for a gear set with massive speed reduction.

In addition to the functions of the contra shaft rollers described in the Section 1.1.3, the contra shaft 113 has two additional functions:
Prevents double feeding by controlling the gap between the rollers that grip the notes;
Prevents skewing of the notes in the transport system.

These two functions are described below.

The two black rollers 118a and 118b act with the inner rollers 130 on the slave shaft 114 to draw the banknote into the transport system 108. The four red rollers 119 act with all four rollers (130, 131) on the slave shaft 114 to crinkle the banknotes to ensure only one note is accepted at a time (see “1.3.3 Slave Shaft” above).

The contra rollers 118 and 119 are fixed to the contra shaft 113 and (with a note in the mechanism between the rollers) are subject to some friction with respect to the inner rollers on the slave shaft 114 in order to work correctly. Because rollers 118 are effectively stationary whilst rollers 130 advance the note into the mechanism, a shearing action is set up between the two sides of the note. The shearing force between the rollers 118 and 130 helps to separate two notes that may have been drawn into the machine as one; this shearing action is assisted by the crinkling action described above. The correct alignment of the contra shaft 113 with respect to the slave shaft 114 is critical for satisfactory performance of the Input Module 100. It is the distance between these two shafts (113 and 114) which is important and creates the shearing action described in the paragraph above. The necessary adjustment is achieved via two cam adjusters 128a and 128b.

The adjustment is obtained using the cam adjuster slots 133 on the outer plates 110. This adjustment must be accurate for all of the rollers 118, 119, 130 and 131 to apply the correct pressure and shearing to notes being pulled between the shafts 113 and 114. It is this even pressure along the length of the note that also ensures they are pulled through cleanly and are not skewed beyond the degree of tolerance allowed.

1.3.5 Transport System 108 in the Input Module

At the base of the Input Module 100 is the start of the Note Handling Module (NHM) Transport System 200, which carries the notes from the Input Module 100 to the Banknote Reader Module 300, then on into the rest of the safe.

Within the Input Module 100 this consists of three transport belts 207 that grip the banknote and move it along into the unit. The belts 207 are run on the pulleys 129 mounted on shafts 132.

The belts 207 are driven by contact with the lower belts 208 which are mounted on the NHM Transport System Base Unit 202 (see Section 2).

2. Note Handling Module (NHM) Transport System 200

2.1 Overview

The NHM Transport System 200 consists of a number of sequential transport belts within the Note Handling Module that carry notes through the system for examination, and then onwards for storage or discharge. When notes are placed in the input tray, they travel through the transport system and are examined by various sensors that are contained within the Note Reader Module 300. They are then fed to the storage system below, or the output tray above, depending on their category and condition.

The transport system also handles notes arriving from the storage system and discharges them to the output tray.

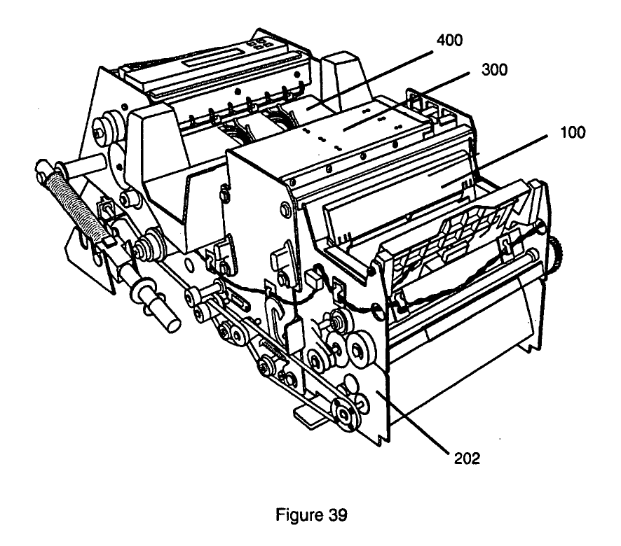

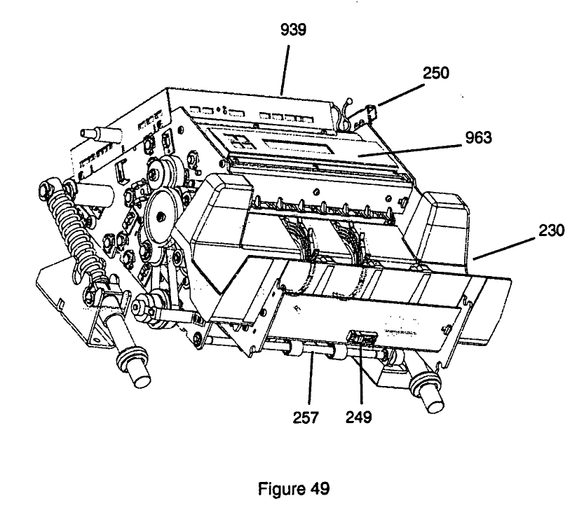

The Note Handling Module 201 (best shown in FIG. 39) is the top section of the Twin Safe, consisting of the following components:
Input Module 100
Note Reader Module 300 (See also FIG. 9)
Output Module 400 (See also FIG. 49)
Base unit on which the above three are mounted (202)

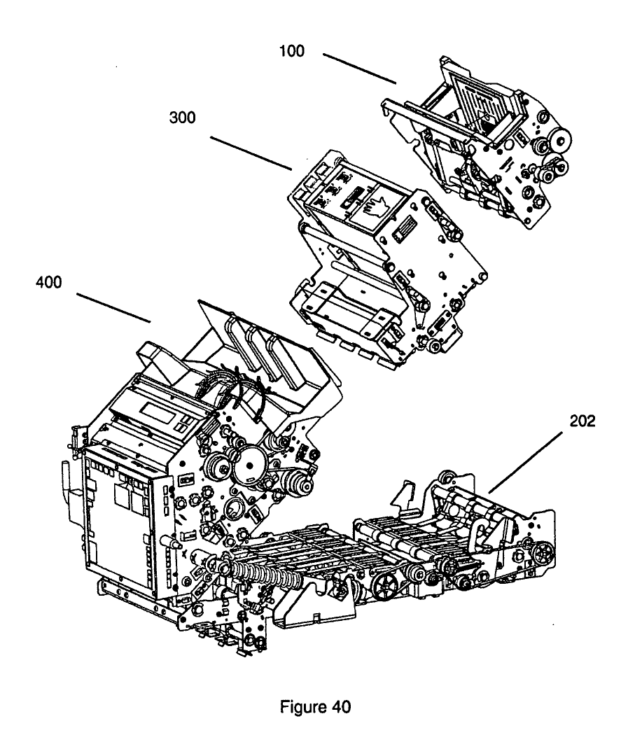

See also FIG. 40 which gives an expanded view of the Note Handling Module in the open position.

The transport belts that make up the NHM Transport System 200 are mounted within all four of these units, and their operation is managed by the NHM Control Unit, based on data collected from various sensors along the transport paths. The NHM Control Unit is mounted on the rear of the Output Module and is part of an integrated control system, managed by a Main Control Unit. For details of the NHM Control Unit see the documentation on the Twinsafe Control System 900.

The Note Handling Module can be opened as shown in FIG. 5, to retrieve trapped banknotes or to carry out maintenance. See Section 0 for details of opening and closing the module.

2.2 NHM Transport Paths

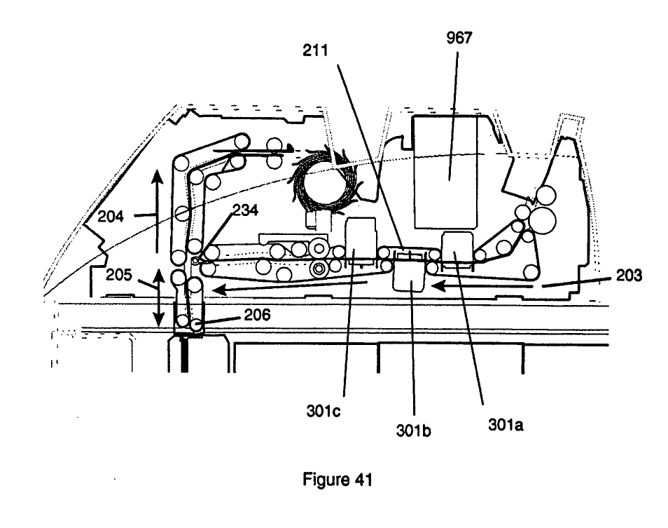

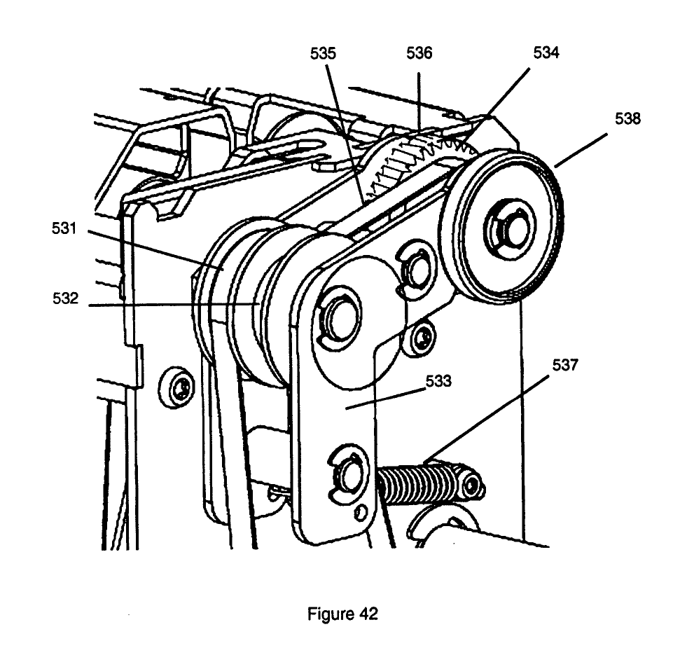

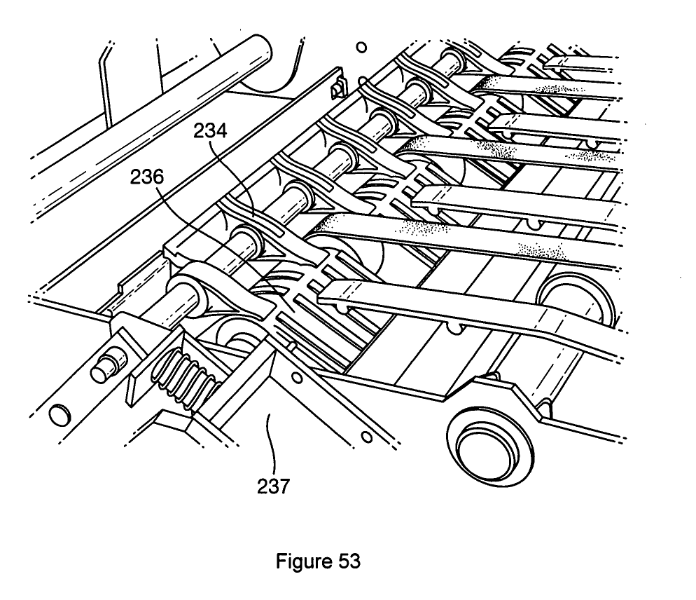

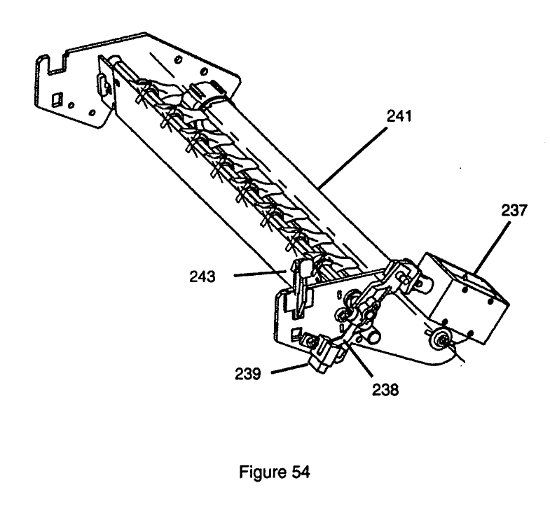

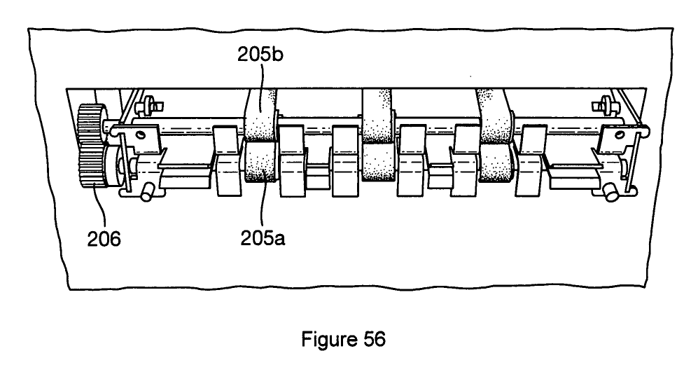

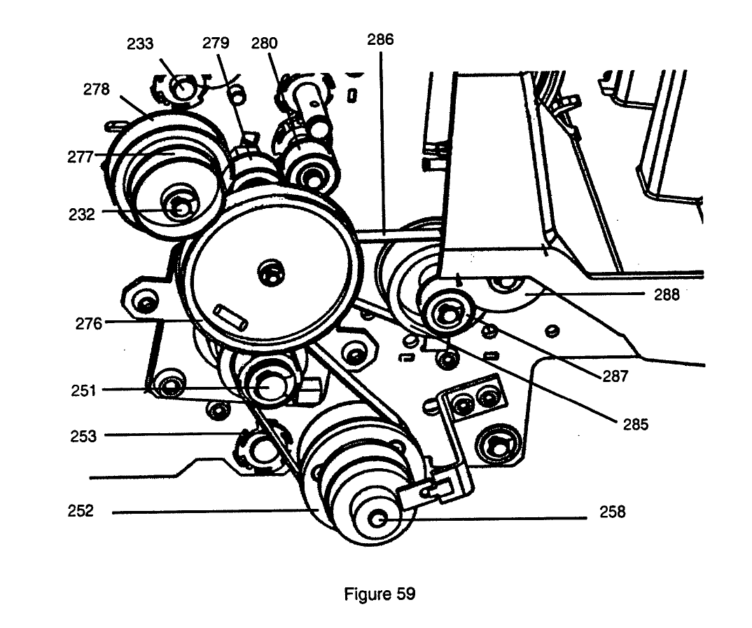

There are three transport belt systems (best shown in FIG. 41) within the Note Handling Module 201 (FIG. 39):
1. Input Path 203. When notes are placed in the input tray, a number of transport belts and other components begin to operate, extending from the Input Module 100 at the front of the Note Handling Module 201 to the storage feedgate 234 at the rear, located underneath the Output Module 400. The storage feedgate, in its normal position, sends the notes downwards into the storage system of the Twinsafe, but if the NHM Control Unit detects the arrival of a note that is not suitable for storage, a solenoid 237 (FIGS. 53 and 54) will activate and the feedgate will change to the alternative position, sending the note upward to the output path 204.
   Drive to the input path 203 is provided by a stepper motor 251, via a clutch 252 (FIG. 59). The motor supplies mechanical power to the entire Note Handling Module, including the Input Module, the Note Reader Module and the Output Module, but not the storage gateway 205.
2. Output Path 204. The output path is contained within the Output Module 400 and the components (described later) consist of a pair of transport belts followed by a pair of guide plates and rollers, then a stacking wheel that discharges notes to the output tray. Notes arrive in the output path when they are rejected at the storage feedgate 234, after travelling along the input path 203, or when they are discharged upwards from the storage system below.
   The output path is driven directly from the stepper motor 251, independently of the clutch 252.
3. Storage gateway 205. The storage gateway is the interface between the Note Handling Module and the storage system. It consists of a short pair of transport belts 205a and 205b (FIG. 56), mounted vertically behind the storage feedgate 234. Notes can pass in both directions through the gateway, either downwards from the input path to the storage system, or upwards from the storage system to the Output Module.
   The storage gateway is powered from the Storage Transport Module, which has its own stepper motor. When the safe is opened and the storage trolley is removed and replaced, the toothed wheel 535 (FIG. 42) at the top of the Storage Transport Module engages with the toothed wheel 206 (FIGS. 41, 56 and 62) at the bottom of the storage gateway.
      2.3 Transport Path Components
      2.3.1 Input Module

The Input Module 100 (FIG. 39) is the entry point to the NHM transport system, where notes are placed in the input tray and fed into the transport path, one at a time, at a controlled rate. For further details, see Section 1.

2.3.2 Input Path Transport Components

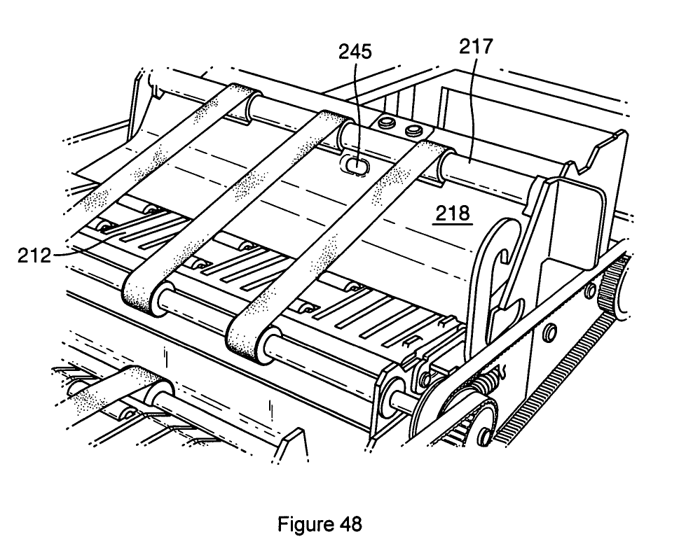

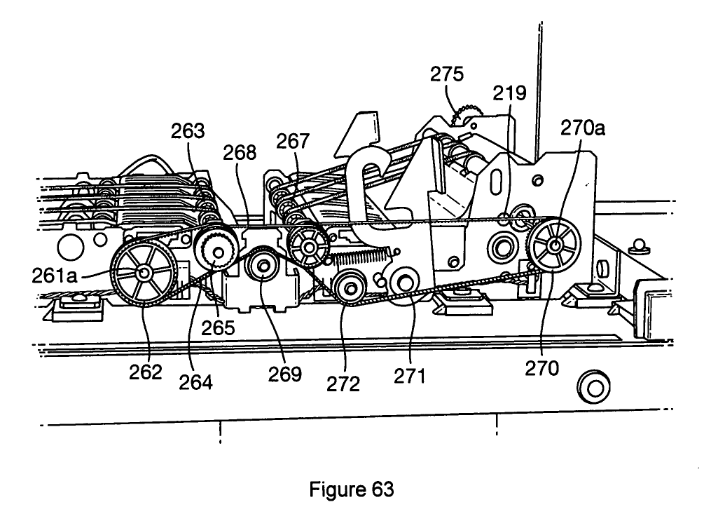

At the entry to the input path, the profile of the lower belt is maintained by the idler shaft 217 and metal guide plate 218 (FIG. 48) which are attached to a pivot shaft 219 (FIG. 63). When the NHM is closed, the idler shaft 217 and guide plate 218 tilt to their appropriate positions to accommodate the Input Module. Neither of these components is on springs. Instead, they are held in place by the tension within transport belts 208 and the trailing edge of the metal guide plate 218 rests on the plastic guide plate 212.

After passing through the Input Module, the notes enter a system of transport belts that carry them through the Note Reader Module towards the storage feedgate.

The belt drive components of the Input Path are best shown in FIG. 5. The figure shows the Note Handling Module in the open position, revealing the upper and lower belts which face each other when the unit is closed. The belts are:
The front belt 207, under the Input Module, which faces the lower belt 208.
The rear belt 209, under the Output Module, which faces the lower belt 210.

The note reader central head 301b fits into the gap between the two sets of belts 208 and 210. There are three heads altogether, 301a, 301b and 301c (FIG. 9). The heads 301a and 301c face downward toward the lower belts 208 and 210 (FIG. 5), but the central head faces upward towards the transport belt 211 (FIGS. 5, 9 and 43) which is integral with the Note Reader Module. In all three cases, there are no matching pairs of complementary transport belts and instead there is a single belt facing a note reader head. However, the system is designed so that the belts engage with each other in sequence, so that before a note disengages from the drive provided by one transport belt it is already engaged by the next belt along the transport path.

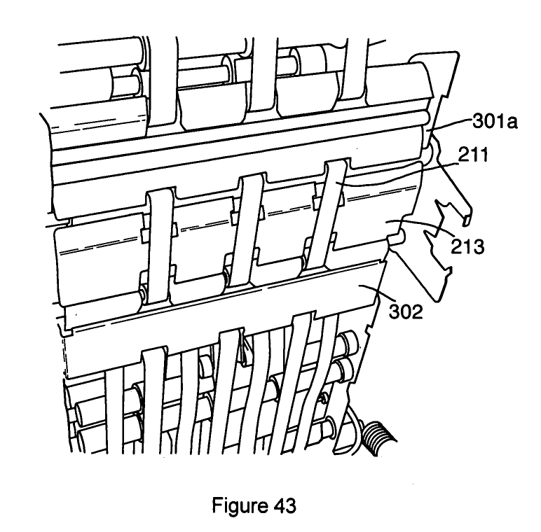

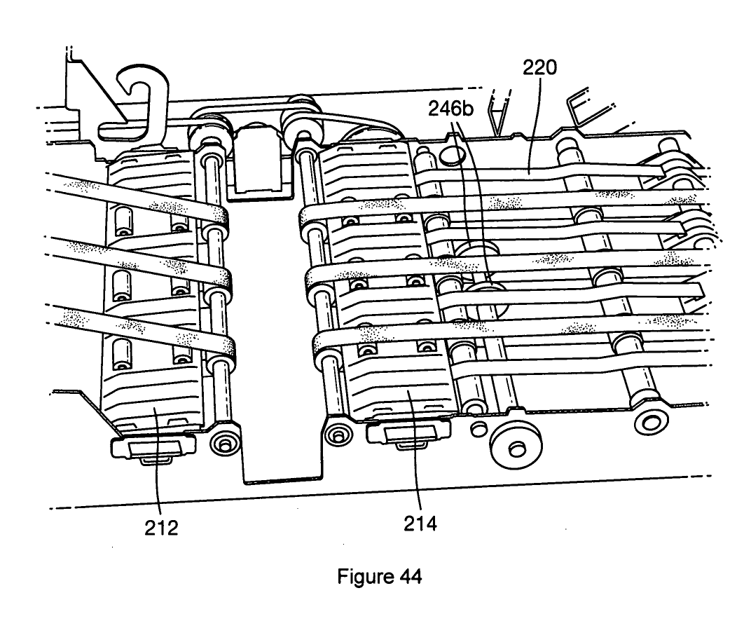

FIG. 43 shows the Note Reader Module with the central head removed, so that the belt 211 is fully visible. Above the belt there is a guide plate 213, mounted on springs, so that notes are held firmly against the sensor head 301b. There are also guide plates 212 and 214 (FIG. 44), mounted on springs under the lower transport belts, to hold the notes against the sensor heads 301a and 301c.

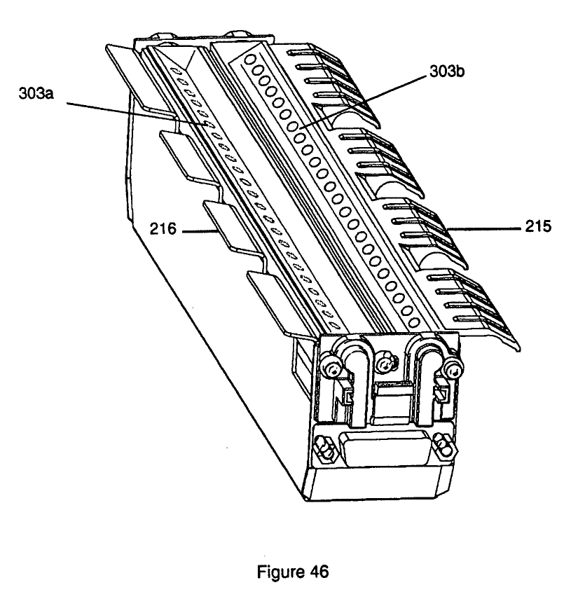

There are also guide plates on each of the three sensor heads, on their leading edges 215 and their trailing edges 216 (FIG. 46).

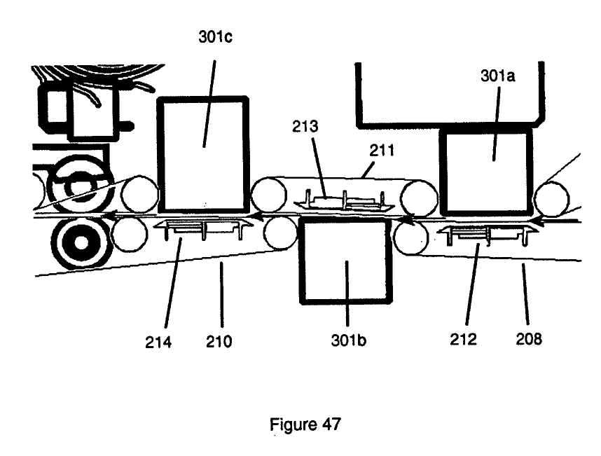

The transport path through the Note Reader Module, best shown in FIG. 47, is as follows:
The note passes under the first sensor head 301a, driven by the lower belt 208 and supported by the guide plate 212.
The note passes above the second (central) sensor head 301b, driven by the upper belt 214 and supported by the guide plate 213.
The note passes under the third sensor head 301c, driven by the lower belt 210 and supported by the guide plate 214.

The two spring-mounted guide plates 212 and 214 have the additional purpose of providing a cushioning effect to protect the sensor heads when the NHM is closed.

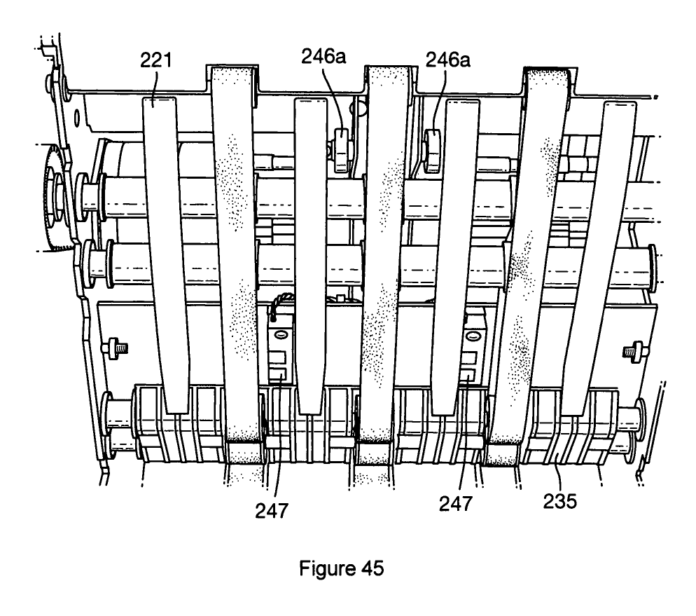

On the rear section of the input path, where the notes leave the Note Reader Module and proceed towards the storage feedgate, the transport belt assemblies have four fixed guide rails alongside the three parallel belts. These are the lower guide rails 220 (FIG. 44) and the upper guide rails 221 (FIG. 45).

2.3.3 Output Path Transport Components

The transport components of the Output Module are best shown in FIG. 44.

When notes are passed to the Output Module, from the feedgate 234 or the storage gateway 205 (FIG. 41), they travel upwards between the inner and outer transport belts 222 and 223. They pass the idler 224 which keeps the belts in contact with each other on the vertical path, then they pass the idlers 225a, 225b and 225c which take them round a corner, changing the belt path from vertical to almost horizontal. As they leave the belts at the upper end, they pass through a narrow slot between the two horizontal guide plates 226, assisted by a pair of inner and outer rollers 227 and 228. Then they are fed to the stacking wheel 229. The change of direction, from vertical to horizontal, enables the stacking wheel to pick up the notes and deposit them in the output tray 230.

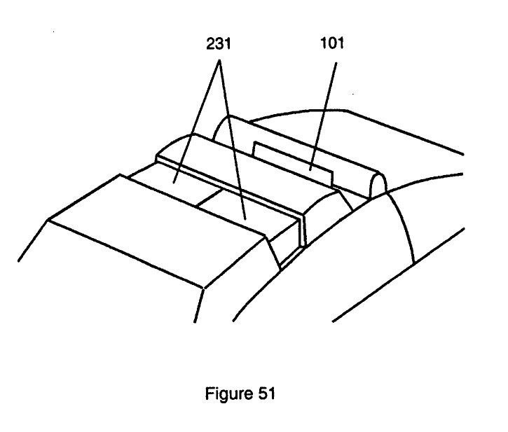

When notes arrive in the output tray, the appropriate output drawer 231 (FIG. 51) on the top cover opens, so that the teller can retrieve the notes. This will be the left or right drawer, depending on which teller has originated the transaction.

The inner and outer belts 222 and 223 are driven by the drive shafts 232 and 233 respectively.

2.3.4 Storage Feedgate

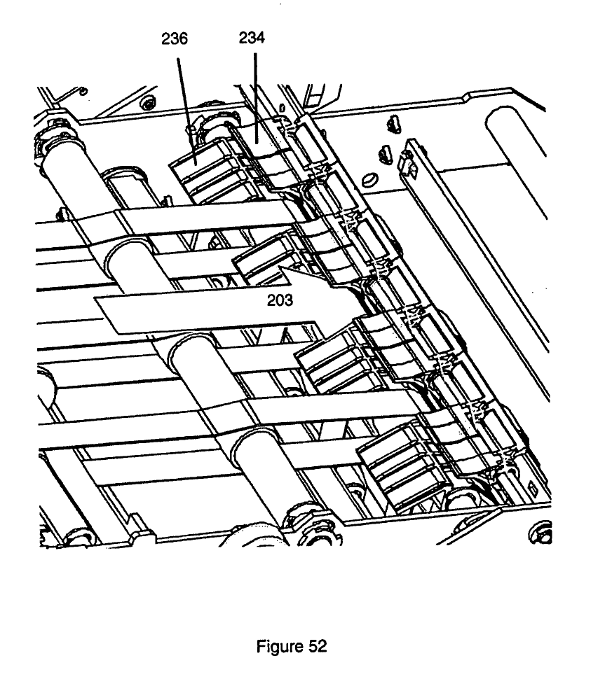

When notes arrive at the end of the input path, they reach the storage feedgate, which sends them downwards into storage or upwards to the Output Module. FIG. 52 shows the feedgate 234 in the normal position with the teeth pointing upwards so that notes can pass underneath them into storage (the input path is shown by the arrow 203). When the teeth are in the upward position (and the NHM is closed), they fit into recesses in the guide plate 235 (FIG. 45) on the Output Module.

When a note arrives that is unsuitable for storage, the solenoid 237 activates and the piston withdraws into the coil, so that the teeth move to the downward position (FIG. 53), sending the notes upward to the Output Module. When the teeth are in the downward position, they fit into recesses in the guide plate 236.

When the solenoid is activated, a lever 238 (FIG. 54) passes between the heads of the optical check sensor 239, which confirms that the solenoid has operated to its fullest extent. If the solenoid activates, but a signal is not generated from the check sensor, it means the feedgate has not operated correctly and the system will report a fault.

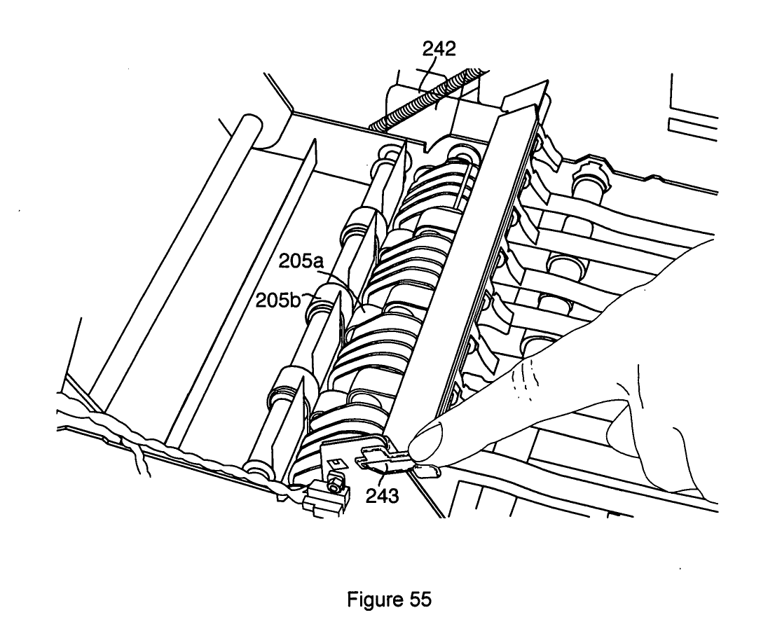

The feedgate assembly 240 is best shown in FIGS. 54 and 55. The assembly is mounted on a pivot shaft 241 and is held down by a spring 242, but it can be tilted upwards by pulling the lever 243 to access the storage gateway 205 (FIG. 41), consisting of two short transport belts 205a and 205b (FIGS. 55 and 56). These are driven by the toothed wheel 206 which engages with the toothed wheel 535 (FIG. 42) on the Storage Transport Module below. The feedgate assembly has to be tilted upwards to access the transport belts if a note has become trapped in the storage gateway.

2.4 Sensors

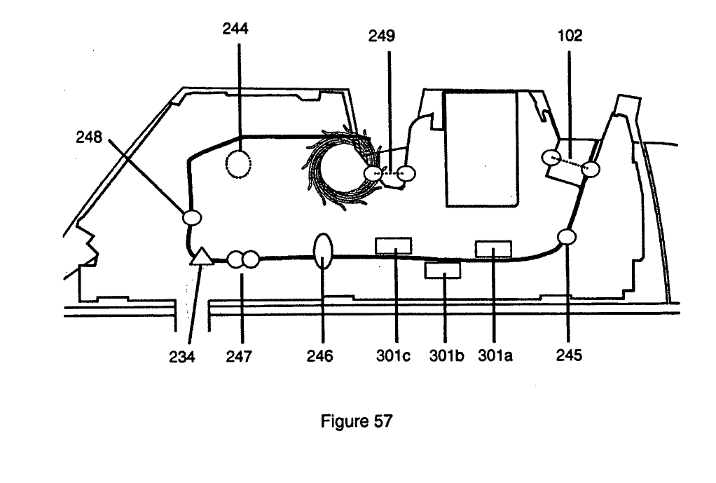

The Twin Safe uses a variety of different types of sensor, which are summarised in Section 0. The sensors in the Note Handling Module are best seen in FIG. 57 and are described in the sub-sections below.

2.4.1 Rotating Counter Sensor

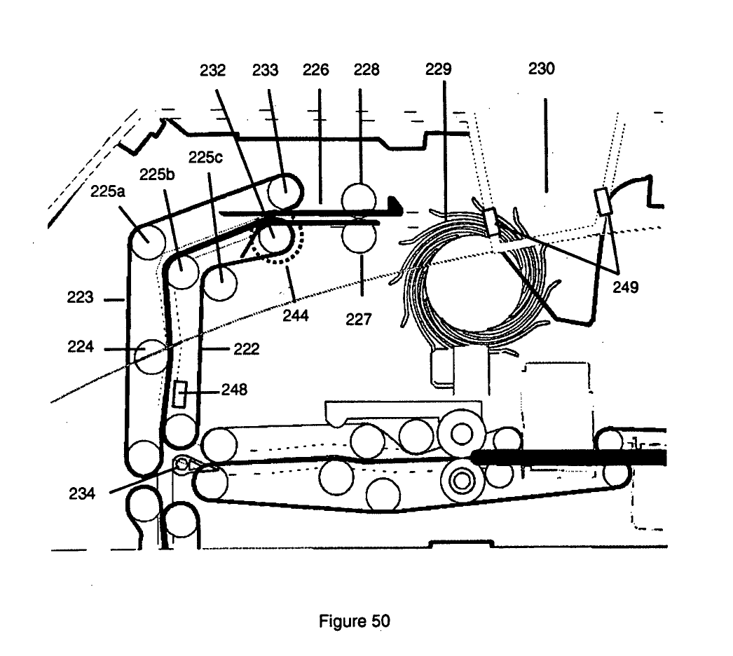

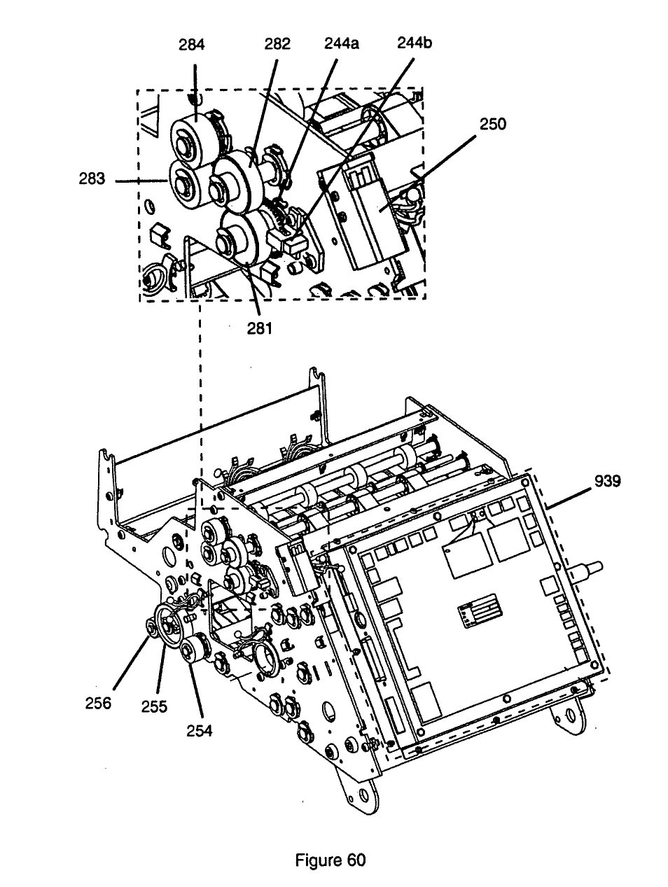

All the transport belts in the Twin Safe have to operate at matched speeds, to enable the accurate tracking of notes through the system, and to avoid snatching or crumpling as the notes are passed from one transport belt system to another. The speed of the motor 251 (FIG. 59) is monitored by the rotating counter sensor 244 consisting of a timing wheel 244a and a pair of optical sensor heads 244b (FIGS. 50, 57, 60). The timing wheel has long teeth known as “fingers” that pass between the sensor heads, breaking the light beam and creating a series of optical pulses that are measured by the sensor, so that the pulse rate indicates the speed of the belts. The wheel is mounted on the inner driveshaft of the Output Module transport belt, co-axial with the toothed wheel 281 (FIG. 60) on the left-hand side of the case.

All the transport belts in the Note Handling Module are mechanically linked (except the two short belts that make up the storage gateway 205), so the single rotating counter sensor monitors the speed of all the belts.

2.4.2 Input Path Sensors

When notes are placed in the input tray, their presence is detected by a direct beam optical sensor 102 (FIG. 57) with two heads, one at the front of the tray and the other at the rear. This activates the mechanical components of the input path, including the Input Module, and the notes are fed downwards and separated, so that they engage with the input path transport belts 207 and 208. For further details see the documentation of the Input Module 100.

When the notes engage with the input path transport belts, they pass a reflective optical sensor 245 (FIGS. 48 and 57). This type of sensor has two heads facing in the same direction towards the note so that when a note arrives, the light from the emitter is reflected back to the detector. This sensor indicates that a note has arrived from the Input Module, so that its progress can be monitored from that point onwards.

The notes then pass through the three heads 301a, 301b and 301c of the Note Reader Module (FIGS. 9 and 57). There can be up to three active heads, a master 301a and optionally one or two slaves 301b and 301c depending on the scanning requirements. If a slave is not used, a blanking plate replaces it.

The Note Reader Module electronically scans the notes determine their category and denomination, so that they can be directed toward the correct Roll Storage Module in the storage system below. If a note is unrecognised, or is identified as a possible forgery, it is sent to the output tray. The Note Reader Module also checks the alignment of notes, in case they have become skewed, and the size in case two notes have failed to separate. For further details, see Section 3.

When the note leaves the Note Reader Module it engages with the rear transport belts 209 and 210 under the Output Module and passes through the note thickness sensor 246 (FIG. 57) which consists of two components:
A pair of upper rollers 246a (FIG. 45) on a floating arm, mounted under the Output Module. The rollers are freewheeling, not linked to the transport drive system.
A pair of lower rollers 246b (FIG. 44) on a driveshaft, mounted on the transport base unit. The shaft and rollers are driven by the transport drive system.

As the note passes between the upper and lower rollers, the thickness is measured by the position of the floating arm, which is connected to a system of magnetic coils. The measured thickness is the average between the thickness on the left and right-hand sides.

The note thickness sensor detects notes that are too thick to be interpreted as a single, flat note. If a note is folded, or if two or more notes have failed to separate, they will be sent to the Output Module.

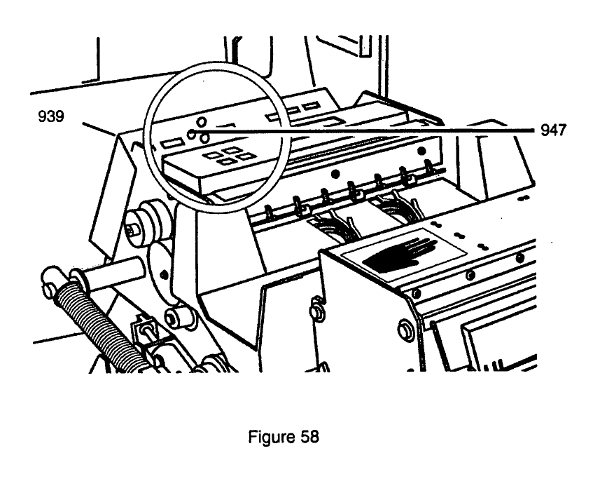

The note thickness sensor also detects a failure to close the NHM top section properly, after it has been opened for servicing or removal of trapped notes. If the NHM is not closed properly, the sensor will give a reading that is out of range and the red LED 947 on the Note Handling Controller will flash (FIG. 58).

When the note leaves the thickness sensor it continues towards the feedgate and reaches a pair of optical reflective sensors 247 (FIGS. 45 and 57). These are mounted transversely under the Output Module, immediately before the feedgate, to detect the leading edge of the note to make sure it has not become skewed.

If the note has passed all the tests thus far, the feedgate 234 (FIGS. 5 and 57) remains in its default position and the note passes down to the storage system. Otherwise, when it reaches the reflective sensors 247 the feedgate changes to the active position and the note passes upward through the output path. There is always a sensor (and in this case a pair of sensors), immediately before a feedgate. A sensor in this position is known as a “reflex” sensor because it indicates that a note has arrived and activates the feedgate if required.

When the feedgate is activated, the check sensor 239 (FIG. 54), discussed already, will ensure that the feedgate solenoid 237 has operated fully, otherwise it will report a fault.

2.3.3 Output Path Sensors

There are two sensors on the output path, shown in FIGS. 50 and 57.
An optical sensor 248 is mounted within the inner transport belt assembly, shortly after the entry point to the output path. This is the reflective type, with both sensor heads facing toward the outer belt, to detect the passage of notes as they travel upwards.
A direct beam optical sensor 249 is mounted on the output tray, with the emitter at the front of the tray and the detector at the rear. When notes arrive in the output tray, the appropriate output drawer 231 (FIG. 51) will open.
   2.3.4 Cover Closure Sensor

A micro-switch 250 (FIGS. 49 and 60) at the top left of the Output Module engages with a bracket under the top cover, to indicate that the cover has been closed. For details of the top cover, see Sections 0.1 and 0.10.

2.4 Transport Drive Mechanism

The mechanical drive for both the input and output paths is from a stepper motor 251 (FIG. 59) mounted on the right side of the Output Module. The toothed wheel on the motor engages with the Output Module drive wheel 276, and this drives all the mechanical components on the output path.

On the input side, the motor connects to the transport route clutch 252, via the drive belt 253. The clutch contains a solenoid that closes a pair of friction plates and transfers the drive from the outer drive wheel to the inner shaft. The clutch engages when notes are placed in the input tray, and it supplies drive to all the components on the input path.

2.4.1 Drive Mechanism for Input Path

The drive mechanism for the input path is activated when notes are placed in the input tray 101 (FIG. 51). The transport route clutch 252 (FIG. 59) engages and the central shaft rotates and drives the toothed wheel 254 (FIG. 60) on the other side of the Output Module. This engages with the idler 255 which drives the toothed wheel 256 on the end of the shaft which drives the upper rear belt 209 of the input path.

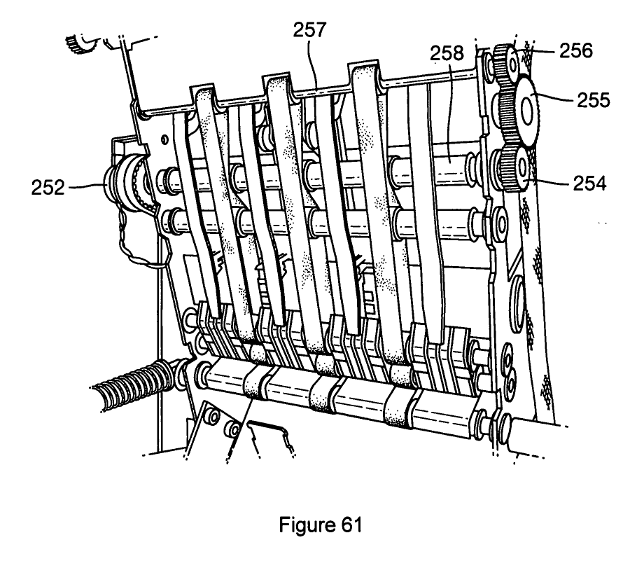

These two drive shafts are shown in FIG. 61. The main drive for the belt is from the driveshaft 257, at the front end of the belt. However, the clutch central shaft 258 also supplies some drive to the belt.

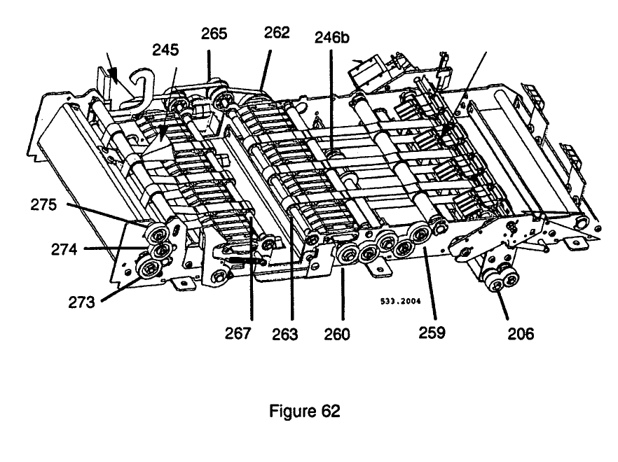

When the unit is closed, the toothed wheel 254 (FIG. 60) on the Output Module engages with the toothed wheel 259 (FIG. 62) on the transport base unit. This drives the note thickness sensor lower rollers 246b via an idler, and then the drive is transferred, via another idler, to the toothed wheel 260 mounted on the transfer shaft 261a. This shaft drives a system of wheels and pulleys on the right side of the transport base unit, best shown in FIG. 63. The system begins with the pulley 262, and from this point, drive is transferred to other components as follows:
The pulley 262 connects to a pulley on the shaft 263, via the drive belt 264. The shaft 263 is the driveshaft for the rear transport belt.
The toothed wheel 265 on the end of the driveshaft 263 engages with the toothed wheel 266 (FIG. 9) on the end of the transport belt shaft of the Note Reader Module.
A second pulley on the driveshaft 263 connects to a pulley on the shaft 267, via the drive belt 268. This belt passes across a tensioner 269, which can adjusted by slackening the central torx screw and moving the tensioner vertically in its slot, then re-tightening the screw. The shaft 267 is the driveshaft for the front transport belt.
A second pulley on the driveshaft 267 connects to the pulley 270, via the drive belt 271. This belt passes across a tensioner 272, which can adjusted by slackening the central torx screw and moving the tensioner horizontally in its slot, then re-tightening the screw.
The pulley 270 is on the shaft 270a which transfers drive to a system of toothed wheels on the left-hand side of the transport base unit, shown in FIG. 62. The toothed wheel 273 on the left end of the shaft 270a drives the idler 274 and then the toothed wheel 275 which supplies mechanical drive to the Input Module. For details of the Input Module, see Section 1.
   2.4.2 Drive Mechanism for Output Path

The transport drive components for the output path are best shown in FIGS. 59 and 60. The transport belt driveshafts, rollers and stacking wheel that are driven by these components are shown in FIG. 50.

The stepper motor 251 on the right-hand side of the unit (FIG. 23) drives a system of toothed wheels beginning with the output path main drivewheel 276 and then the toothed wheel 277 which is on the end of the inner belt driveshaft 232. The larger toothed wheel 278 on the same shaft drives the idler 279 and then the toothed wheel 280 which drives the inner roller.

On the left-hand side of the unit (FIG. 60), the toothed wheel 281 on the inner belt driveshaft engages with the drive wheel 282 on the outer belt driveshaft.

The toothed wheel 283 on the lower roller driveshaft engages with the drive wheel 284 on the upper roller driveshaft.

Returning to the right-hand side of the unit (FIG. 59), a small pulley, co-axial with the output path main drivewheel 276, drives the larger pulley 285 via the drive belt 286. The toothed wheel 287, co-axial with the pulley 285, engages with the toothed wheel 288 which drives the stacking wheel.

The output path is driven directly from the motor 251 and operates continuously, unlike the input path which only operates when the clutch 252 is engaged.

2.5 Control System

The mechanical and sensor components of the Note Handling Module are managed by the Note Handling Controller 939, (FIG. 60), except for the sensor components of the Note Reader Module which have their own controllers (see Sections 3 and 7). The Note Handling Controller is mounted behind the Output Module, and the data collected from the sensors is sent the Main Control Unit in the storage cabinet below. For details see Section 7.

The Service Display Module 963 (FIG. 49) is an optional unit which can be mounted on top of the Output Module. This is used by service engineers for analysis and diagnostic purposes.

3. Note Reader Module (NRM) 300

3.1 Overview

The Note Reader Module (best shown in FIG. 9) is a sub-assembly of the Note Handling Module (FIG. 39). It examines banknotes using optical scanning techniques to determine their currency, denomination and other relevant features, so that they can be directed to the appropriate compartment of the storage system, or rejected and returned to the teller.

The Twin Safe has a limited number of storage compartments (Roll Storage Modules), up to a maximum of eight. Normally, each Roll Storage Module is set up to store only one category of note, although it is possible to set up one module as a reject store, so that it accepts any denomination and currency. If there is no reject store, any notes that do not belong to a designated storage category are returned to the teller. For details of the Roll Storage Modules, see Section 6.

During the scanning process, the notes are compared with a number of standard optical profiles to determine whether or not they are valid members of a known category. The scanning process is capable of identifying forgeries, and if a note is placed in the system which apparently resembles a known category, but does not match the profile with sufficient accuracy, it will be rejected.

The passage of a note through the Note Reader Module can lead to a number of possible results:
The note is folded, skewed, or not centrally located on the transport system and is unsuitable for scanning.
The note does not correspond to any known profile.
The note corresponds to a known profile, but does not match the profile with sufficient accuracy and is rejected as a possible forgery.
The note is a valid member of a known profile, but does not belong to a category that has been designated for Roll Storage.
The note is a valid member of a known profile, designated for Roll Storage, and is sent to the appropriate Roll Storage Module. This is the only result that allows the note to be sent for storage as a known category. In all other cases the note is rejected and is sent to the reject store (if there is one) or returned to the teller.
   3.2 Transport System

The Note Reader Module 300 (FIG. 39) is mounted on the input path between the Input Module 100 and Output Module 400. All three modules are mounted on a transport base unit 202 and can be raised for access to the transport system components (FIG. 5). The Note Reader Module is integrated into the transport belt system so that one of the belt assemblies 211 (FIG. 9) is fitted to the bottom of the module and is driven by the toothed wheel 266. For an unobstructed view of the transport belt, see 43 where the central note reader head has been removed.

The input path 203 is shown schematically in FIG. 41, and is indicated by the arrows in FIG. 9, but for details of how the notes are transported along the path and through the Note Reader Module, see the NHM Transport System (Section 2).

3.2 Note Reader Heads

The Note Reader Module has up to three reader heads (FIGS. 9 and 41). There is a master 301a and there can be optionally one or two slaves, 301b and 301c, depending on the scanning requirements. The position of the heads in relation to the transport belt system is shown in FIG. 41. The master 301a and second slave 301c are fitted above the transport belt, facing downwards. The first slave 301b is fitted centrally between the master and second slave, facing upwards toward the transport belt 211. The reader heads can be removed and refitted as required, but if the Twin Safe is to be used with a reader head missing, a blanking plate 302 (FIG. 43) must be fitted to maintain the integrity of the transport system.

FIG. 46 shows a reader head that has been removed. Each head has two sensors, 303a and 303b so that the notes are illuminated first from the infra-red perspective and then from the green or ultra-violet perspective. The reflected picture is then scanned line-for-line and electronically interpreted to determine whether or not it conforms to one of the standard profiles.

A number of other features are measured, so that the complete sequence is as follows:
The length and width of the note are measured, so that during the scanning process the note can be compared with profiles corresponding to the appropriate dimensions. If the note is too small it is rejected on the basis that it might have become folded.
The lateral position of the note on the transport belt is measured, and the note is rejected if it is out of centre.
The angle is measured, and the note is rejected if it is skewed by more than 8°.
The scanning process compares the note with the standard profiles and determines its currency and denomination. The note is rejected if it does not match any known profile.
Further tests are performed to validate that the note is a genuine member of the currency and denomination. The note is rejected as a possible forgery if it does not match the profile with sufficient accuracy.

There are various other sensors throughout the transport system, to detect the position of notes and ensure that they have not become folded or skewed. For details of these, see Section 0 and the sections on the appropriate modules.

3.3 Control System

Each note reader head has its own electronic control unit, mounted in the control box 967 (FIGS. 9, 41 and 65) at the top of the Note Reader Module. The control units are connected to their respective reader heads using cables with the appropriate plugs (FIG. 9):
Master: 970a and 971a
Slave 1: 970b and 971b
Slave 2: 970c and 971c

The controllers are daisy-chained together on the CAN-bus using the connectors 975a,b,c, so that they communicate data with other controllers in the system.

Power is supplied to the Note Reader Module, at 5V and 24V, through the plug 973a (FIG. 9) which connects to the controller for the master note reader. Power for the two slave units is distributed within the control box using internal cables.

For further details of the CAN bus and power supplies, see Section 7.

3.4 Calibration

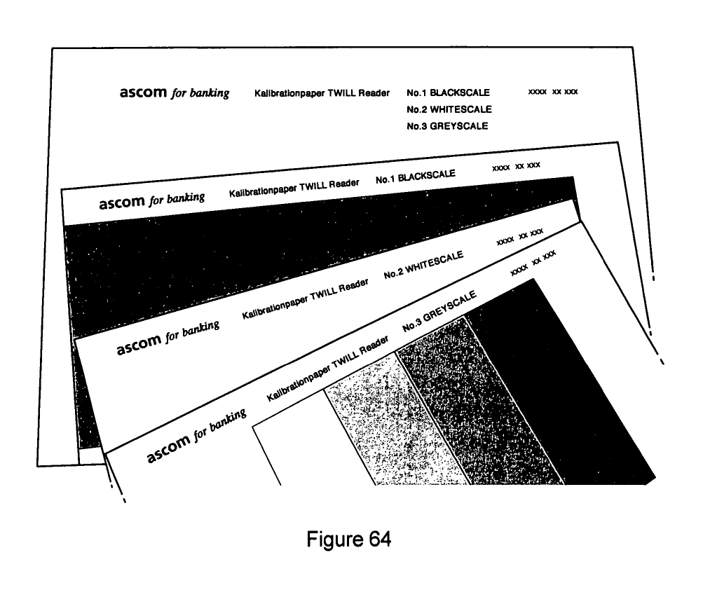

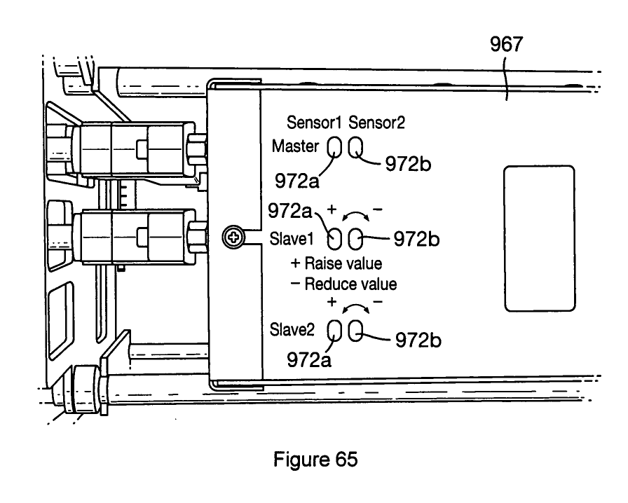

The sensors have to be periodically calibrated whenever a reader head has been removed for cleaning or replacement. Calibration is achieved by feeding a set of calibration papers 304 (FIG. 64) through the Twinsafe system and turning the adjustment screws 972a and 972b (FIG. 65) underneath the small holes at the top of the control box. There are two screws for each of the three note readers, for adjustment of the two sensors on the note reader head:
Sensor 1: infra-red
Sensor 2: green or ultra-violet

While running a calibration program, the appropriate calibration papers are placed in the input tray and then fed through the system. This will give a reading, which has to be within a specified range. If it is out of range, the screws 972a and 972b have to be adjusted and the process repeated with new calibration papers until the correct values are achieved. Depending on the calibration program, it may also be necessary to feed some banknotes of a specified category through the system.

The calibration papers, which must be originals, not copies, are used only once, in case they pick up dirt while being transported through the system.

4. Storage Transport Module 500

4.1 Overview

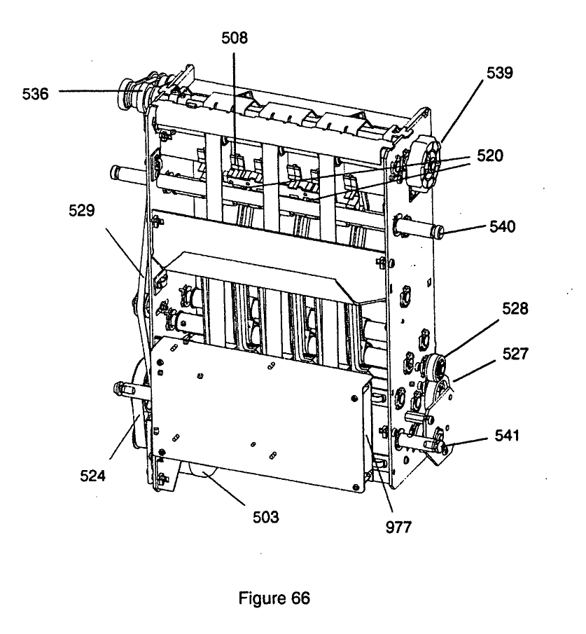

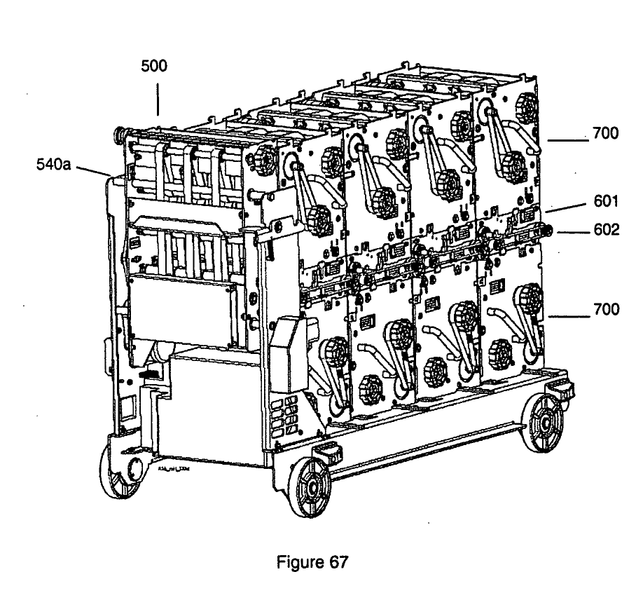

The Storage Transport Module 500 is best shown in FIGS. 66 and 67. It is mounted vertically on a retractable trolley upon which are also mounted one, two, three or four Roll Storage Units (see Sections 5 and 6). The storage transport module feeds notes in both directions, downward from the Note Handling Module into storage or upward from storage to the Output Module (see Section 2).

At its upper end, the Storage Transport Module connects to the storage gateway underneath the Note Handling Module. At its lower end it turns the notes through an angle of 90° and sends them to the first of a series of up to four Note Transport Modules (see Section 5) that lie horizontally between the upper and lower Roll Storage Modules. (A Roll Storage Module and the upper or lower half of a Note Transport Module makes up a Roll Storage Unit).

The storage transport module contains a complementary pair of transport belts 511 and 512 that face each other and are in contact with each other so that notes are held securely between them as they pass through a set of guide rails 515.

A control unit 549 is fitted to the Storage Transport Module to operate the motor 508 that drives the transport belts and also monitor the sensors 527 and 528 within the module.

4.2 Storage Transport Module Construction

The storage transport module 500 is a frame construction comprising two metal side plates supporting a number of shafts, bars and further folded metal plates between them that collectively give the storage transport module its structure.

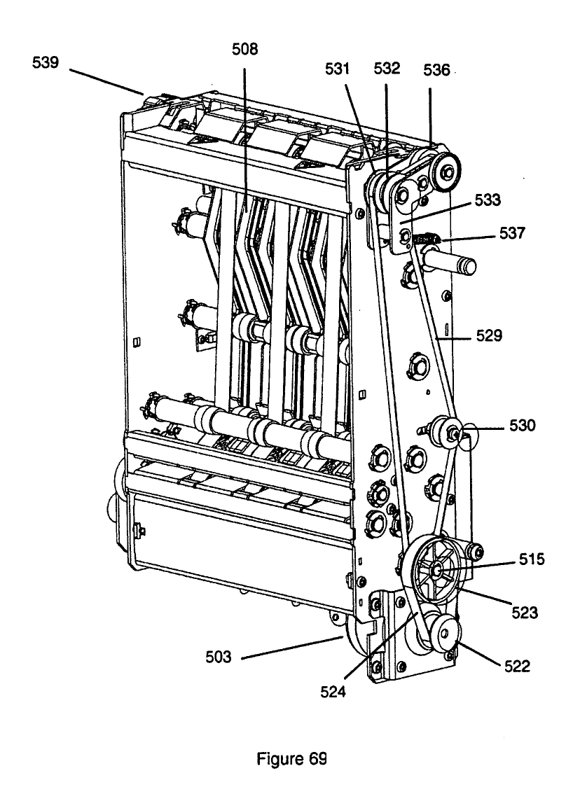

A number of shafts are mounted between the side plates; on these shafts are mounted various guide rollers for two transport belts 511 and 512. The shafts for the transport belts are mounted in bearings that are set into the side plates. An electric motor 508, that drives the transport belts and thus provides the basic note transport function of the storage transport module, is mounted directly onto the left side plate (FIG. 69).

A Control unit 549 that manages the function of the storage transport module is mounted on the rear of the module between the side plates.

4.3 Transport Paths

The transport paths for passage of notes into and out of storage are best shown in FIG. 4.

The Storage Transport Module 500 provides the storage transport path 502—the vertical section of the transport system—for the passage of notes in both directions between the Note Handling Module 201 and the storage system 501.

The Note Handling Module 501 provides the input and output paths 203 and 204, where banknotes are passed in one direction, from input to output. When the notes reach the end of the input path, they can be directed upward to the output module, or downward into storage.

The storage gateway 205 is part of the Note Handling Module, although it is driven from the Storage Transport Module. It provides the connection with the storage system below so that banknotes can pass in both directions, up or down.

The storage transport path 502 connects with the storage gateway 205 at one end and the note transport path 603 at the other, so that banknotes are transported in both directions along the entire route, driven by the stepper motor 503 (FIG. 66), mounted within the Storage Transport Module.

4.4 Transport Belts

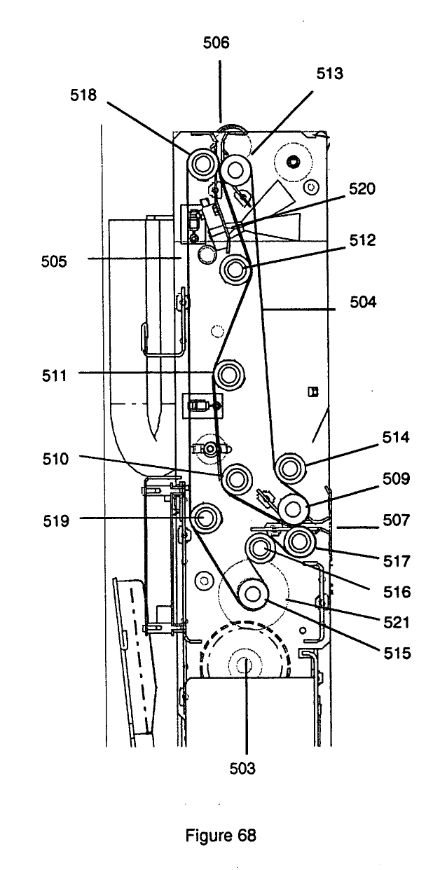

The note transport belt system of the Storage Transport Module is best shown in FIG. 68. The notes are held between a complementary pair of front and rear transport belts 504 and 505 that face each other on a central vertical path. There are note guides 506 and 507 at the upper and lower ends of the transport path to feed the notes into and out of the system, and there are six sets of guide rails 226 (FIGS. 66 and 69) running parallel with the belts on either side of the notes to hold them in position along the belt path.

Both the front and rear transport belts are driven from their lower end, and they pass over a system of idler shafts as follows:
The front transport belt is driven from the driveshaft 509 and, noted in the clockwise direction (as seen from FIG. 68), which represents the motion of the transport belt during the storage of notes, it passes over the idler shafts 510, 511, 512, 513 and 514, and then it returns to the driveshaft 509.
The rear transport belt is driven from the driveshaft 515, and, because it faces the front belt, it travels in the opposite direction (anti-clockwise instead of clockwise) during the storage of notes. In the anti-clockwise direction it passes over the idler shafts 516, 517, 510, 511, 512, 518 and 519, and then it returns to the driveshaft 515.

The idler shafts 510, 511 and 512 are common to both the front and rear drive belts, holding them together so that the banknotes are transported securely.

4.5 Sensors

The following sensors are fitted to the Storage Transport Module, to monitor the passage of banknotes:
Two optical sensors 520 (FIGS. 66 and 68) are mounted transversely alongside each other behind the common belt path, near the top of the module. They detect the leading edge of the banknotes as they travel in either direction, up or down—out of or into storage, and measure their alignment in case they have become skewed. Each of these sensors is the reflective type with two heads pointing in the same direction towards the banknote.

An optical pulse sensor (rotating counter sensor) 521 (FIG. 68) is fitted to the rear transport belt driveshaft 515, to regulate the speed of the stepper motor 503 and ensure that the associated transport belts run at the same rate as the other transport belts in the system. The speed measurement also enables the system to calculate the position of banknotes and the time when they should arrive at their intended destinations.

4.6 Mechanical Drive Components

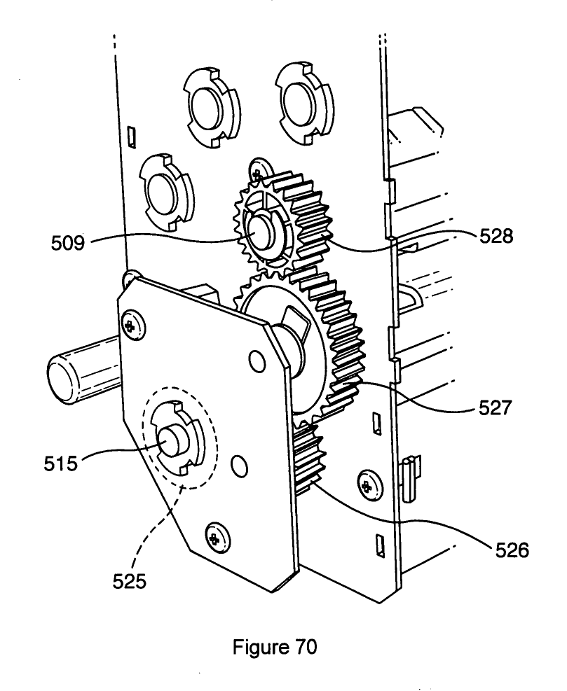

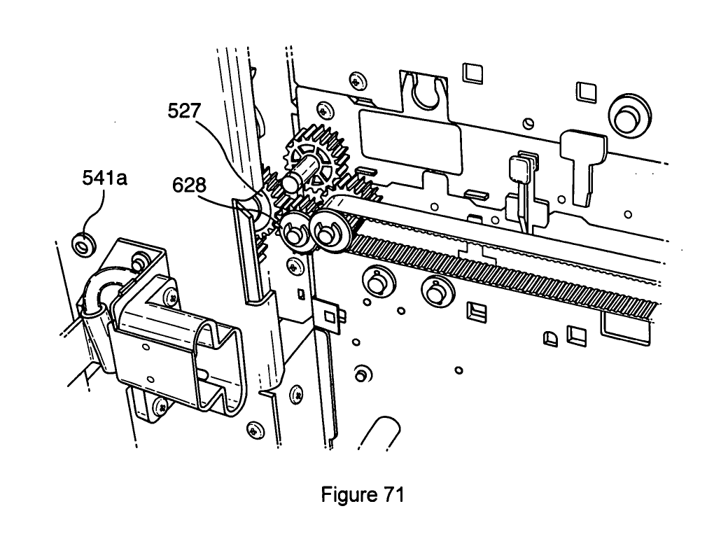

The mechanical drive for the Storage Transport Module 500 and other linked components (detailed below) is provided by the stepper motor 503 mounted on the left-hand side of the storage transport module (FIG. 69). The motor drives the pulley 522 which drives the large pulley 523 via the drive belt 524. The large pulley 523 is on the rear belt driveshaft 515. The other end of the driveshaft 515 connects to a system of toothed wheels on the right-hand side of the storage transport module, best shown in FIG. 70. A toothed wheel 525 on the driveshaft 515 connects to the idler 526, this drives the large idler 527, then idler 534 drives toothed wheel 528, which is the drive wheel for the front belt driveshaft 509. The large idler 527 also connects to the drive wheel 552 (FIG. 71) for the first in the sequence of up to four Note Transport Modules. For details see the documentation of the Note Transport Module 600.

Returning to the left side of the unit (FIG. 69), the long drive belt 529 connects to the pulley 531 at the top of the module, at the pivot point of a floating arm 533, which connects to the storage gateway (FIG. 56) at the bottom of the Note Handling Module. The drive belt 529 has a tensioning adjuster 530 that can be moved horizontally in its slot by slackening and then re-tightening the central torx screw.

The floating arm 533 and the associated components are best seen in FIGS. 69 and 42. Alongside the pulley 531 there is a second pulley 532 which drives the pulley 534 at the end of the floating arm, via the short drive belt 535. Alongside the pulley 534 there is a toothed wheel 536 which engages with the toothed wheel 206 (FIG. 56) on the storage gateway at the bottom of the Note Handling Module. The purpose of the floating arm 533 is to enable the toothed wheels 536 and 206 to engage correctly when the storage trolley is removed and refitted. The arm is held up by the spring 537 which connects to its lower end, holding the toothed wheel 536 in its uppermost position but allowing it to be depressed slightly when the trolley is moved in and out of the storage cabinet. Also at the top of the floating arm there is a smooth plastic wheel 538 which protects the toothed wheel 536 against impact when the trolley is returned to the storage cabinet.

4.7 Storage Transport Controller

The Storage Transport Controller 977 (FIG. 66) is fitted to the back of the Storage Transport Module. It controls the stepper motor 508 and receives and interprets signals from the sensors 527 and 528 within the storage transport module. The storage transport controller has a pair of CAN bus sockets that connect to the Main Control Unit and also to the first in a sequence of Roll Storage Module Controllers. For further details see the documentation of the Control System 900.

4.8 Manual Removal of Banknotes

The idler shaft 513 (FIG. 68) on the front transport belt has a hand wheel 539 on the right-hand side (FIGS. 66 and 69) that may be operated by the teller to manually retrieve notes that have become trapped in the system. The hand wheel incorporates a freewheel mechanism so that it can only be turned clockwise to feed the notes upwards out of the storage system. To retrieve notes in this way, it is first necessary to open the safe door and remove the storage trolley. For details see Section 0.

4.9 Removal and Refitting the Storage Transport Module

The mountings for the Storage Transport Module are best seen in FIG. 66. The ends of the upper shaft 540 fit into slots 540a (FIG. 4) in the retractable trolley, and are held in position by two torx screws at the ends of the lower shaft 541. With the retractable trolley removed from the safe, the storage transport module can be removed by disconnecting the power and CAN-bus cables from the control unit, then removing the torx screws on the lower shaft, and lifting the module upwards.

The torx screws are fitted to horizontal slots in the casing, for adjustment purposes.
The right-hand screw 541a is shown in FIG. 71. When the module is refitted, it has to be moved to the correct position so that the large toothed wheel 527 engages with the toothed wheel 628 on the first of the Note Transport Modules, whilst maintaining a small amount of play in the engagement of the gear teeth. When the adjustment is correct, the screws are tightened on both sides
   5. Note Transport Module 600
   5.1 Overview

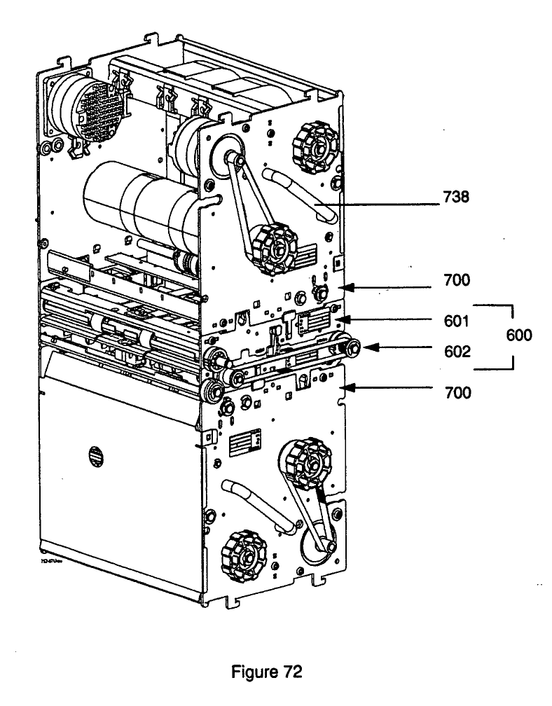

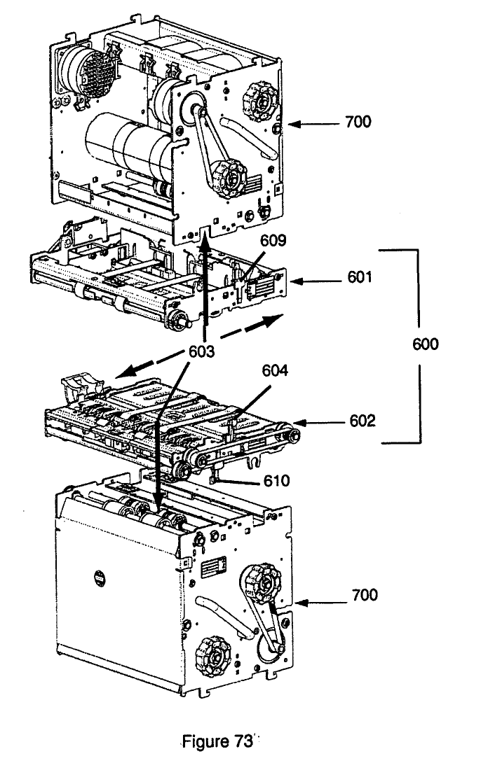

The Note Transport Module 600 is best shown in FIGS. 72 and 73. A complete module consists of an upper and lower module, sandwiched between upper and lower Roll Storage Modules within a roll storage unit (see Section 6). One, two, three of four roll storage units (dependent upon customer specification) are mounted onto a retractable trolley together with a storage transport module (see Section 4) within the Twinsafe, these items collectively forming the Roll Storage System (see Section 6).

Notes arriving from the storage transport module are passed along a series of complementary pairs of upper and lower transport belts and associated rollers within each of a number of note transport modules that are daisy-chained together within the Twinsafe. Collectively, these multiple note transport modules (one, two, three or four, dependent upon the specification of the Twinsafe) comprise the note transport path of the roll storage system. Notes continue to pass along the note transport path until they reach the appropriate feedgate (according to note denomination and type) and are passed into the designated roll storage module. The feedgates themselves are incorporated into the note transport modules.

When notes are being retrieved from storage, the system works in reverse and the notes are passed along the series of transport belts and associated rollers toward the Storage Transport Module for onward transportation to the output module (see Section 2).

5.2 Note Transport Module Construction

The note transport module 600 is a frame construction comprising two metal side plates supporting a number of shafts, bars, further folded metal plates and a tablet-shaped plastic moulding between them that collectively give the storage transport module its structure. Mounted within the plastic moulding is a feedgate system, comprising a shaft with plastic tongues that move in unison, to direct the movement of notes to the appropriate roll storage module.

A number of shafts are mounted between the side plates; on these shafts are mounted various guide rollers for two sets of transport belts 617 and 618. The shafts for the transport belts are mounted in bearings that are set into the side plates.

A complete note transport module is assembled from two smaller assemblies (the upper and lower note transport modules). The two assemblies are largely constructed from common components; however, those components are assembled in a different orientation within the upper note transport module when compared to the lower module.

The upper and lower note transport modules are held together by a two-part plastic hinge that allows the modules to hinge open, to remain in a locked-open position and also allows for the two assemblies to be easily separated without the use of tools.

Mechanical drive for the note transport module comes from an external motor (mounted within the Storage Transport Module (see Section 4). A toothed plastic drive belt, in conjunction with pulleys, provides mechanical drive to the transport belts within both the upper and lower note transport modules and also transfers drive to the adjacent note transport module (if fitted).

5.3 Note Transport Path

The note transport path 603 is best shown in FIGS. 4 and 73. A roll storage unit consists of a pair of note transport modules 601 and 602 and their associated pair of identical roll storage modules 700. There can be up to four roll storage units mounted alongside each other on the retractable trolley, so that notes can be fed to a maximum of eight roll storage modules altogether. The roll storage units are joined together so that the note transport modules make up the note transport path.

Notes on the note transport path are sent to the appropriate destinations by a system of feedgates that change their position from closed to open when they are activated by solenoids. A feedgate is considered to be “open” if the associated feedgate solenoid has been activated, allowing the note access to the designated roll storage module, otherwise it is “closed”.

Each upper and each lower note transport module has a feedgate that provides access for the note to the associated roll storage module. Within the roll storage system, an incoming note first arrives at the lower feedgate of the first note transport module, and then the upper feedgate of the same module. If both feedgates are closed, the note continues to the next roll storage unit, first the lower feedgate and then the upper feedgate of the note transport module. The note continues in this manner along the note transport path until it encounters an open feedgate, and consequently is directed into the associated roll storage module.

The designation of notes to a specific roll storage module is determined by the Note Reader Module (see Section 3) in conjunction with the Control System (see Section 7). The note reader module examines the notes to determine their currency and denomination.

During the storage of notes, the passage of the notes through the note transport path is monitored by an optical sensor at the entry to each feedgate that is mounted within the note transport module (one sensor each in the upper and lower modules), and their expected time of arrival is calculated by the system, on the basis of readings from other sensors.

If a note reaches the end of the note transport path without finding an open feedgate, it will fall down into the front of the roll storage system and the Twinsafe will report an error. In this circumstance, the retractable trolley will have to be removed and the note retrieved, and the system will require maintenance.

The note transport path works in both directions, in and out of storage. When a note is discharged from a roll storage module, the appropriate feedgate will open and the system will work in reverse.

At the rear end of the note transport path, the first module connects to the Storage Transport Module so that notes are fed in and out of the storage transport path 502. This in turn connects to the storage gateway 205 at its upper end, where incoming notes are received from the Input Module, and outgoing notes are ejected to the Output Module.

5.4 Design and Operation

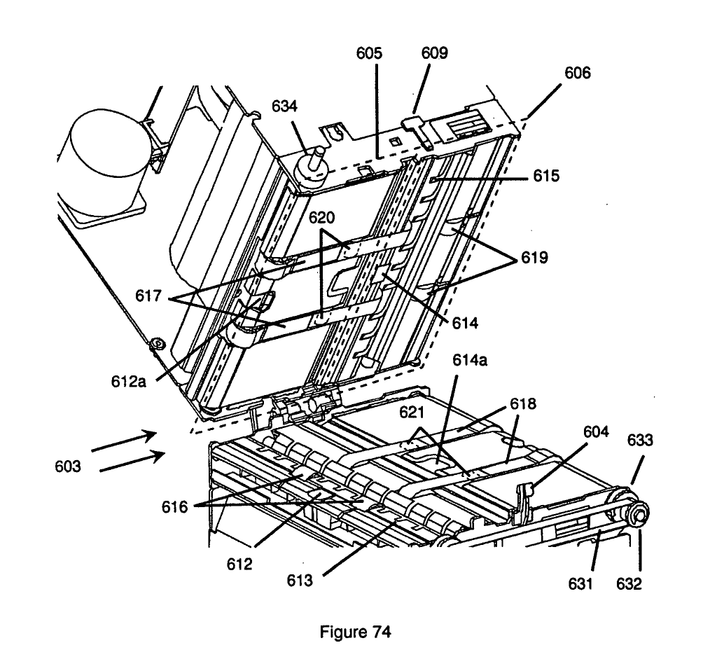

The transport path components of the upper and lower note transport modules are best shown in FIG. 74, where the upper module is raised on its hinge above the lower module. The upper module can be raised in this way by undoing the green clip 604 and lifting it by the handle 738 (FIG. 72) on the roll storage module. The hinge has a stop point, so that if the upper module is raised past this point it can be released and will remain in position so that trapped banknotes can be retrieved.

The upper and lower note transport modules have complementary components, each consisting of a metal guide plate assembly 605 and a plastic guide plate assembly 606 (FIG. 74). The metal guide plate on the upper module faces the plastic guide plate on the lower module, and vice-versa. The transport belts and rollers mounted on these components are complementary, facing each other to hold the notes securely.

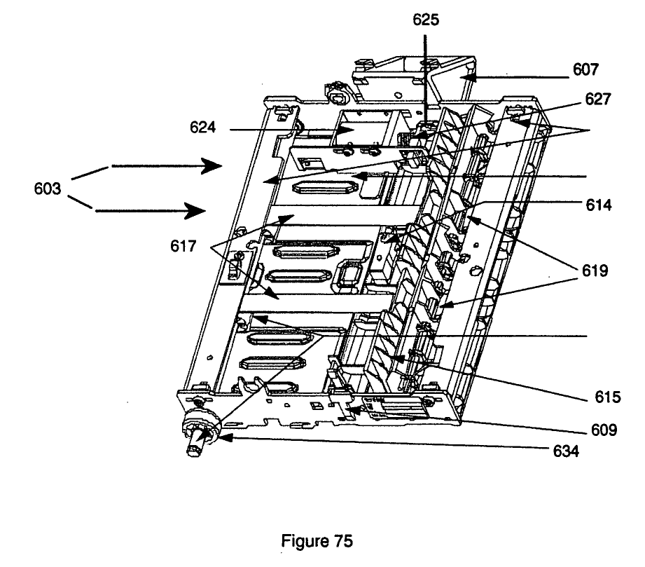

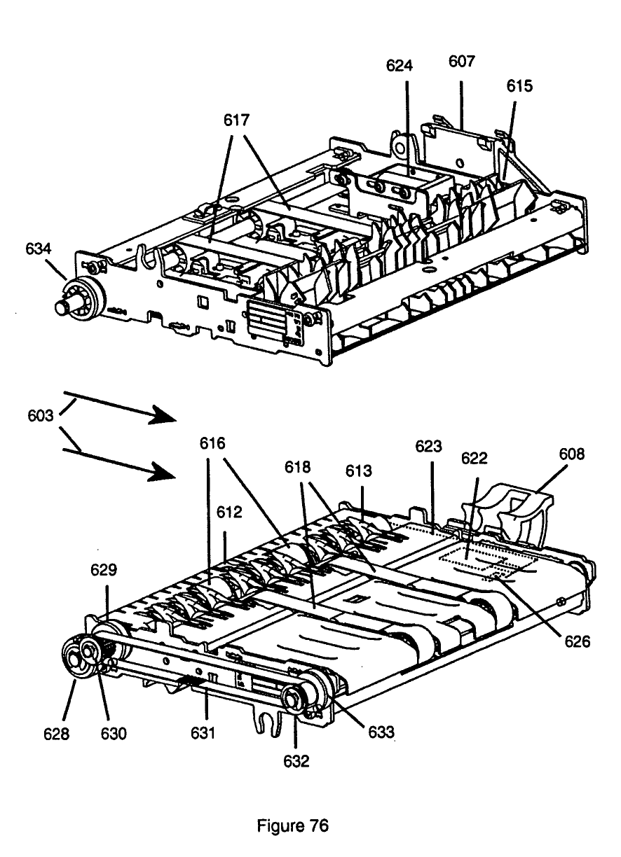

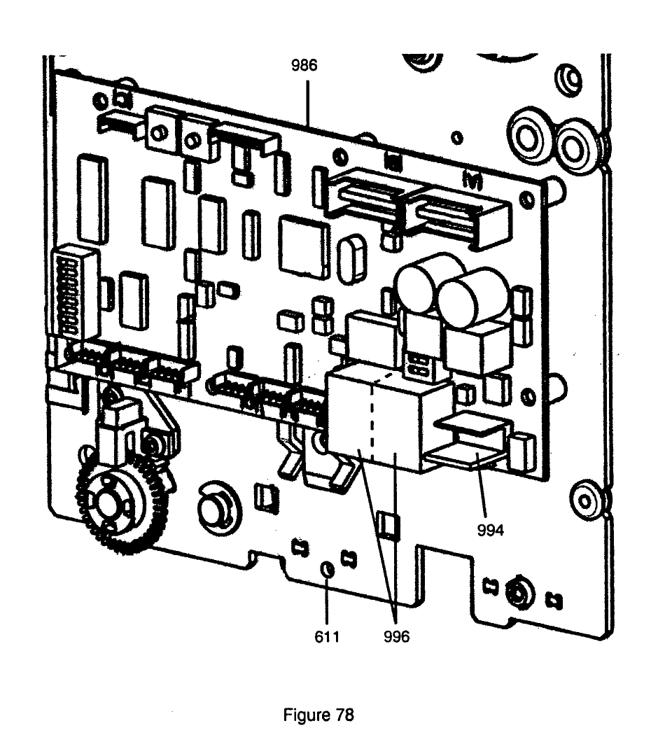

After raising the upper module on its hinge, the complete upper section of the storage unit (upper note storage module and attached roll storage module) can be lifted off, by disconnecting the upper hinge component 607 from the lower component 608 (FIGS. 75 and 76); the operation of the hinge mechanism is described in detail below. The upper and lower note transport modules can then be separated from their respective roll storage modules by undoing the white clips 609 and 610 (FIG. 4) on one side, and removing the appropriate screws from the hinge components at the other side, for example the central torx screw that fits the hole 611 (FIG. 78) in the Roll Storage Module. When disconnecting components in this way, it is also necessary to unplug any associated electrical cables.

The passage of a note between the upper and lower Note Transport Modules is shown with reference to FIGS. 74, 75 and 76. An incoming note first arrives at the optical sensor 612, and, if the note is designated for the lower roll storage module underneath, the feedgate 613 opens. Otherwise the note continues along the transport path to the next feedgate. The sensor 612 is the reflective type with two sensor heads facing in the same direction towards the banknote, so that when a note arrives the light from the emitter is reflected back to the detector. The hole 612a in the metal section of the upper module prevents the light from being reflected back when a note is not present.

When an incoming banknote has passed the closed feedgate on the lower note transport module, it reaches the optical sensor 614 and the feedgate 615 on the upper module. If the feedgate opens, the note is fed upwards to the upper roll storage module, otherwise it continues to the next storage unit. The sensor 614 is the reflective type, the same as sensor 612. The hole 614a in the metal section of the lower module prevents the light from being reflected back when a note is not present.

The arrows 603 show the incoming note path, and the outgoing path is in reverse. The sensors 612 and 614 are known as “reflex” sensors for the incoming direction because they are located immediately in front of the feedgates, causing them to open when a designated banknote arrives. When notes travel in the reverse direction, out of storage, their position is detected by reflex sensors within the roll storage modules, causing the feedgates to open. For details of this operation, see Section 6.

The transport system in the note transport module is best seen in FIG. 74. As the note enters the module, it engages with the lower roller 616 and upper transport belt 617. As it leaves the roller and passes the closed lower feedgate, it engages with the lower transport belt 618 while still in contact with the upper transport belt 617. As it passes the closed upper feedgate 615, it leaves the upper transport belt and engages with the upper roller 619, while still in contact with the lower transport belt 618. Then it engages with the lower roller 616 and upper transport belt 617 on the next storage unit. The rollers 616 and 619 are freewheeling on their shafts, providing a point of support for the banknotes as they are transported by the transport belts. In this way, drive is constantly applied to the note as it passes through the Note Transport Module.

The free-wheeling rollers 620 on the upper belt provide additional support immediately after the note has engaged with the lower belt. Similarly, the rollers 621 on the lower belt, provide support immediately before the note leaves the upper belt.

5.6 Feedgate Solenoids

The feedgate solenoids and associated components are best shown in FIGS. 75 and 76. The components for the lower section of the Note Transport Module are underneath the guide plates, but their locations are shown with dotted lines.

On the incoming note path, a note first encounters the feedgate of the lower section of the note transport module, then the metal guide plate that houses the solenoid. In the upper note transport module, this arrangement is the other way round, with the solenoid first and then the feedgate. However, both feedgates have to open in the same direction, which means the solenoids have to be mounted in opposite directions in relation to the feedgate.
The lower module has the solenoid 622 pointing away from the feedgate, and it operates the feedgate from the long pushrod 623.
The upper module has the solenoid 624 pointing towards the feedgate, and it operates the feedgate from the short pushrod 625.

In both cases, the solenoid has an optical check sensor (626 on the lower module and 627 on the upper module) to make sure it has operated to its maximum extent when activated, otherwise the system reports a fault.

5.7 Mechanical Drive Components

The mechanical drive components for the note transport modules are best shown in FIGS. 74, 76 and 71.

The modules are daisy-chained together so that each module is driven from the previous module, except for the first module in the note path, which is driven from the Storage Transport Module. The mechanical drive for the note transport path, together with the storage transport path 502 and the storage gateway 205 (FIG. 4), comes from a stepper motor mounted in the Storage Transport Module. For details, see Section 4. Whilst this motor provides drive for the entire length of the note transport path, drive does not extend to the roll storage modules which have their own motors.

The toothed wheel 628 on the lower note transport module is driven from the previous lower note transport module (or the Storage Transport Module if this is the first module in the note transport path). It engages with the toothed wheel 629 which connects to the toothed wheel 634 on the upper module, to drive the upper transport belt set 617. The pulley 630 drives the drivebelt 631 which connects to the drive pulley 632 for the lower transport belt set 618. The toothed wheel 633 connects to the toothed wheel 628 for the next storage unit.

For a view of the drive mechanism with the upper module in the closed position, see FIG. 72.

FIG. 71 shows the toothed wheel 527 on the Storage Transport Module, driving the toothed wheel 628 on the first note transport module. The torx screw 541a is an adjuster in a slotted hole to allow the Storage Transport Module to be moved horizontally in its housing on the trolley. There is also an adjustment screw at the other side of the module, and they both have to be slackened to make the adjustment, then re-tightened again. The adjustment allows for a small amount of play between the toothed wheels 628 and 527.

5.8 Storage Unit Hinge

The hinge on the left-hand side of each of the storage units consists of two components, an upper section 607 and a lower section 608 (FIGS. 75 and 76). The storage unit can be opened so that the upper section remains in position on the stop point as shown in FIG. 74, so that trapped notes can be retrieved, or it can be opened fully and the upper section can be removed. Before removing the upper section, the power and CAN bus cables have to be disconnected from their sockets on the upper Roll Storage Controller (FIG. 78). The power cable disconnects from socket 994 and the CAN bus cables from the twin socket 996. The CAN bus cables can be disconnected from either end, but if a cable connecting an upper and lower module is disconnected at its upper end, it has to be disengaged from the clip 635 (FIG. 78).

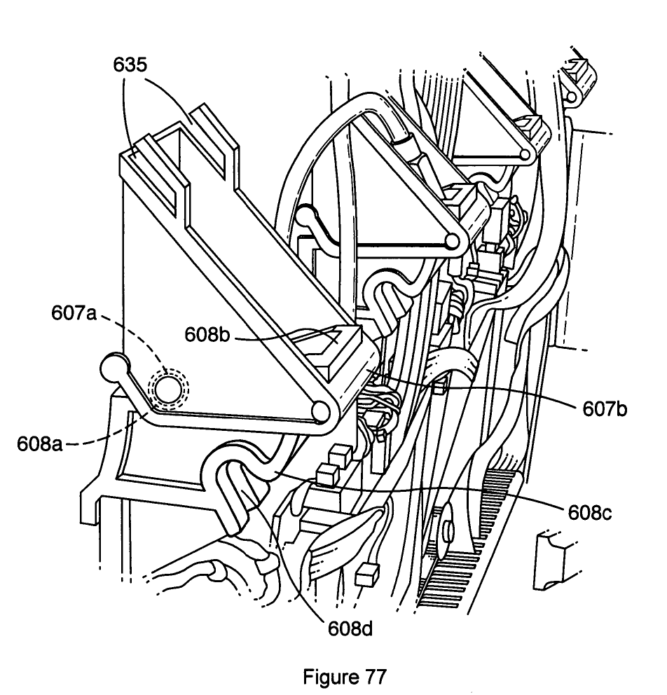

The two hinge components in their closed position are shown in FIG. 77. The upper section has a pair of inner pegs 607a extending towards each other and an outer peg 607b extending the complete width of the hinge. The lower section has an inner slot 608a, an outer tongue 608b, a stop point 608c and a lower slot 608d.

When the hinge is in the closed position, the inner pegs 607a rest in the slot 608a, and the outer peg 607b rests underneath the tongue 608b.

When the upper section of the storage unit is raised, the outer peg 607b moves downward until it reaches the stop point 608c and there is some resistance to movement. When the storage unit is opened further, the peg goes past the stop point and rests on the edge of the lower slot 608d. In this position, the unit will remain open at the stop point.

The upper section of the storage unit can be removed by raising it to the vertical position, then pulling it upwards so that the outer peg 607b goes fully into the lower slot 608d. The inner pegs 607a will come out of their slot 608a and can be lowered onto the upper surface of the lower hinge, between the slot 608a and the outer tongue 608b. In this position, the outer peg 607b will also be out of its slot 608d and the unit can be moved sideways, past the tongue so that the two hinge components are completely separated.

5.9 Roll Storage Controller

The Roll Storage Controller 986 (FIG. 78) is fitted to the left side of each roll storage module, and it manages the components of both the roll storage module and the associated upper or lower note transport module. For further details of the Roll Storage Controllers, see the documentation of the Control System 900.

6. Roll Storage Module 700

6.1 Overview

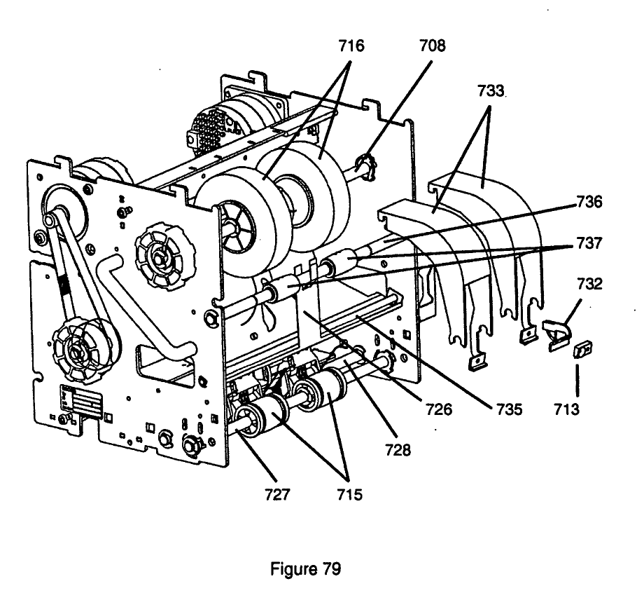

The Roll Storage Module 700 is best shown in FIG. 79. The purpose of the roll storage module is to store bank notes that have been introduced into the Twin Safe until they are required, at which point they are dispensed. A Twin Safe installation will include two, four, six or eight roll storage modules mounted on a retractable trolley within the Twin Safe, depending on customer specification. FIG. 72 illustrates a retractable trolley fitted with eight roll storage modules. The retractable trolley, fitted with roll storage modules and associated Note Transport Modules, is called the Roll Storage System.

Each roll storage module within the Twin Safe is used to store a particular bank note denomination or type, which is defined in the Twin Safe operating system setup.

6.2 Roll Storage System

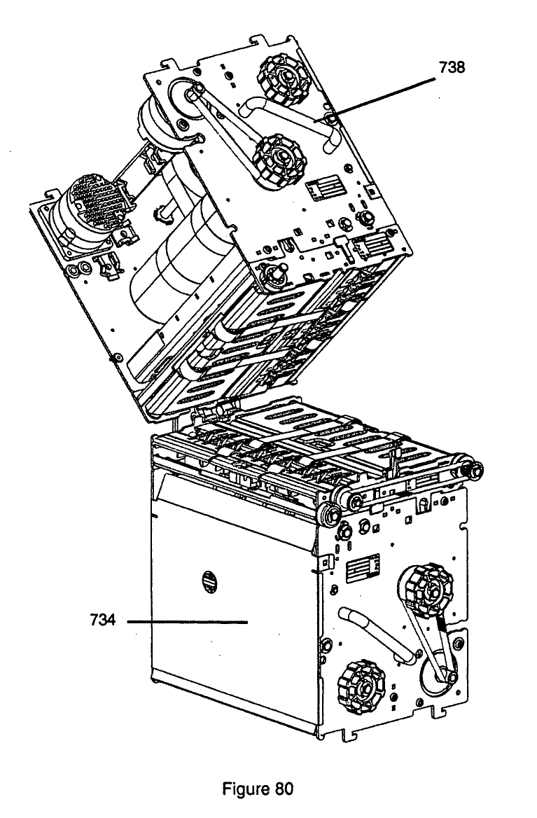

Two roll storage modules are mounted in opposite orientations onto a note transport module. This assembly of two roll storage modules and a note transport module is called a storage unit, which is illustrated in FIGS. 72 and 80.

One, two, three or four storage units are mounted together onto the retractable trolley to form the roll storage system, FIG. 72.

6.3 Interaction with Note Transport Module

The operation of multiple (one two, three or four) note transport modules working together as part of the overall transport mechanism for notes within the Twin Safe is described in Section 0.

To construct a storage unit, a note transport module is positioned between two roll storage modules; a single note transport module together with two roll storage modules comprises a storage unit (FIG. 80).

One, two, three or four storage units (dependent upon customer specification for the Twin Safe) are arranged onto the retractable trolley alongside each other (FIG. 72). In this arrangement, the note transport modules are aligned with each other and together they form a continuous transportation mechanism that is capable of transporting bank notes from the input side of the roll storage system to any of the roll storage modules within the Twin Safe, where they are stored until required.

The selection of the correct roll storage module for each bank note entering the Twin Safe is undertaken and managed by the Main Control Unit 909, which is the central control system of the Twin Safe.

The note transport module comprises two sections 601 and 602. Both sections are constructed from the same basic assembly; however, minor adaptations are made to each section, making them non-interchangeable. The adaptations define a section as either a Top or Bottom section of the note transport module, and they concern the mechanism for providing drive to the transportation components within the note transport module, the feedgate mechanism for diverting notes into the roll storage module, and the method of joining (by use of a hinge and retaining clip) the two sections of the note transport module together.

6.4 Principle of Operation

A roll storage module 700 stores bank notes by winding them onto a large diameter drum (the note storage drum 705) mounted on a shaft between the side plates. The notes are held onto the drum by use of two tapes (Mylar™ tapes 704) that are stored on reels (note storage reels 716) on another shaft within the roll storage module. As the tapes are wound onto the drum, bank notes are trapped between successive windings of the tapes, effectively holding them in place.

Two electric motors 710a and 710b power the notes storage drum and the tape storage reels.

The storage process is reversed when bank notes are dispensed from the roll storage module.

The entire storage and dispensing processes are managed by a controller unit 986 that is fitted to one of the side plates of the roll storage module. The controller unit communicates with the Twin Safe main control unit.

6.5 Roll Storage Module Construction

The roll storage module 700 is a frame construction comprising two metal side plates 701, 702 supporting a number of shafts and bars between them that collectively give the roll storage module its structure. A protection plate 734 (FIG. 80) is fitted on one face of the roll storage module.

A number of shafts are mounted between the side plates; on these shafts are mounted a Note Storage Drum, two Mylar Tape Storage reels and various guide rollers for two Mylar tapes. The shafts for the notes storage drum and the tape storage reels are mounted in bearings that are set into the side plates. Two electric motors, that drive the Mylar tapes and thus provide the basic storage and dispensing function of the roll storage module, are mounted directly onto the side plates (FIG. 79).

6.5.1 Tape storage Reels

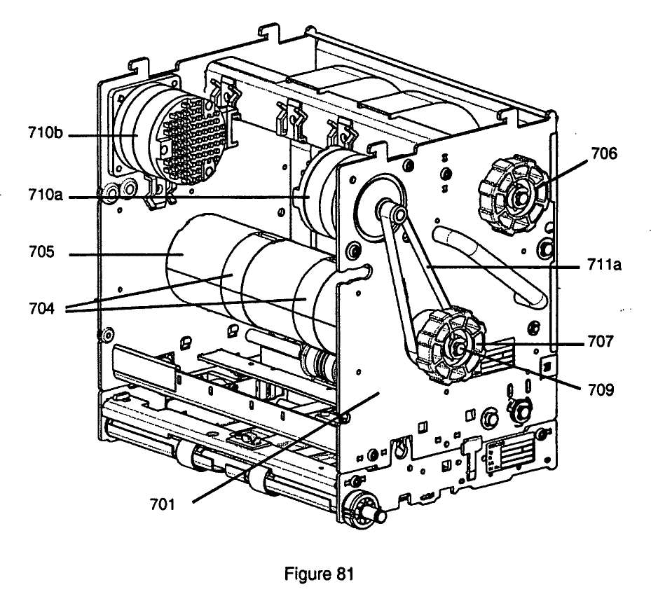

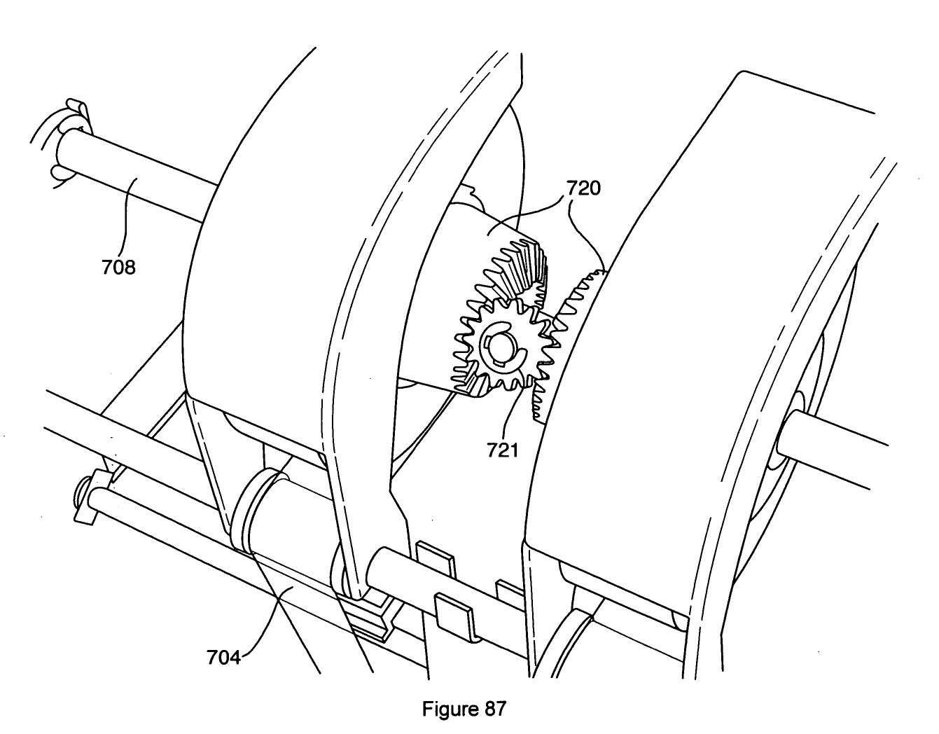

Two tape storage reels 716, mounted on a shaft 708, are used to store two Mylar tapes 704 (FIG. 79, FIG. 87). The shaft 708 runs in bearings mounted into the roll storage module side plates 701 and 702. Mounted on one end of the shaft 708, on the outside face of side plate 701, is a large hand wheel 706 (FIG. 81). Also mounted on the shaft at the opposite end, on the outside face of side plate 702, is a gear wheel, around which a drive belt 711b passes. The drive belt also passes around a gear wheel mounted on the end of the driveshaft of electric motor 710b; this arrangement allows motor 710b to provide drive to the tape storage reels.

The two tape storage reels are used to store Mylar tape that is not being used by the roll storage module to store bank notes, which are held on the note storage drum 705 by the tapes.

The hand wheel 706 allows the operator of the Twin Safe to manually wind bank notes back out of the roll storage module in case of jammed/stalled bank notes or a drive failure or general failure of the roll storage module. The hand wheel is fitted with a freewheeling mechanism so that the tension on the tapes that is maintained by the roll storage module for their efficient operation cannot be inadvertently released by turning the hand the wrong way. The freewheeling mechanism also prevents the operator winding notes further into the machine by mistake. To wind the tapes in the opposite direction, the operator would use hand wheel 707.

6.5.2 Note Storage Drum

The note storage drum 705 is mounted on a shaft 709 that runs in bearings mounted into the roll storage module side plates 701 and 702. Mounted on one end of the shaft 709, on the outside face of side plate 701, is a large hand wheel 707 (FIG. 81). Also mounted on the shaft, located between the hand wheel 707 and the outside face of side plate 701, is a gear wheel, around which a drive belt 711a passes. The drive belt also passes around a gear wheel mounted on the end of the driveshaft of electric motor 710a; this arrangement allows motor 710a to provide drive to the note storage drum.

Two Mylar tapes 704 are attached to and partially wound onto the note storage drum, each being attached at a point on the drum that is approximately ⅓ of the drum's width from the edge, on each side of the drum (FIG. 81).

The note storage drum is used to store bank notes within the roll storage module. Storage of the notes is achieved by winding the two Mylar tapes 704 off the reels 716 (on which they are stored) and onto the drum 705. As the tapes are wound onto the drum, bank notes are introduced into the successively wound layers of the tapes, thus holding the bank notes tightly against the drum's surface.

The hand wheel 707 allows the operator of the Twin Safe to manually wind bank notes into the roll storage module 700 in case of jammed/stalled bank notes or a drive failure or general failure of the roll storage module. The hand wheel is fitted with a freewheeling mechanism so that the tension on the tapes that is maintained by the roll storage module for their efficient operation cannot be inadvertently released by turning the hand wheel the wrong way. To wind the tapes in the opposite direction, the operator would use hand wheel 706.

6.5.3 Mylar Tapes

Two Mylar™ tapes 704 are each secured to a tape storage reel 716 at one of their ends and to the note storage drum 705 at their other ends. Between the tape storage reels and the drum, the tapes pass over a number of guide rollers that manage the tapes' path through the roll storage module. See Section 6.9.1.

Whenever the roll storage module 700 is not storing any bank notes, the tapes are fully wound onto the tape storage reels; only a minimum amount of tape is left wound out, passing around the guide rollers and wound on the note storage drum.

The tapes are substantially wound onto the note storage drum at any time when the roll storage module is full of bank notes, only a small length of tape is left wound around the guide rollers and on the tape storage reels.

6.5.4 Swivel Arms

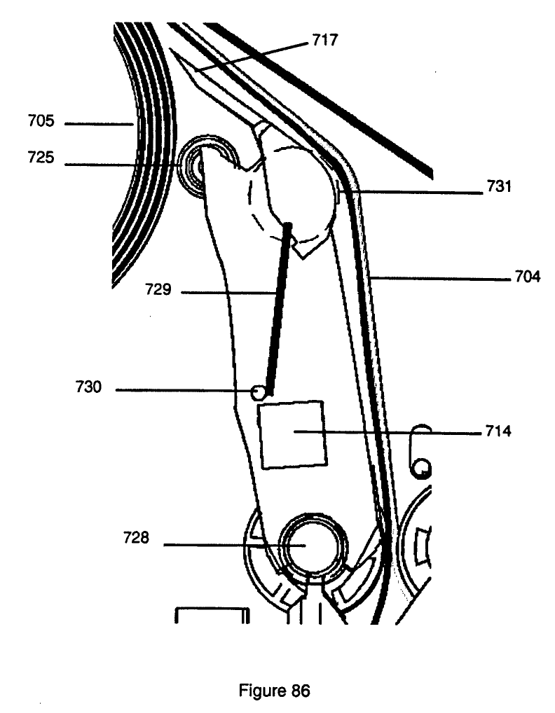

Two swivel arms 724 (FIG. 86) are mounted on a shaft 728 that is mounted between the side plates 701 and 702.

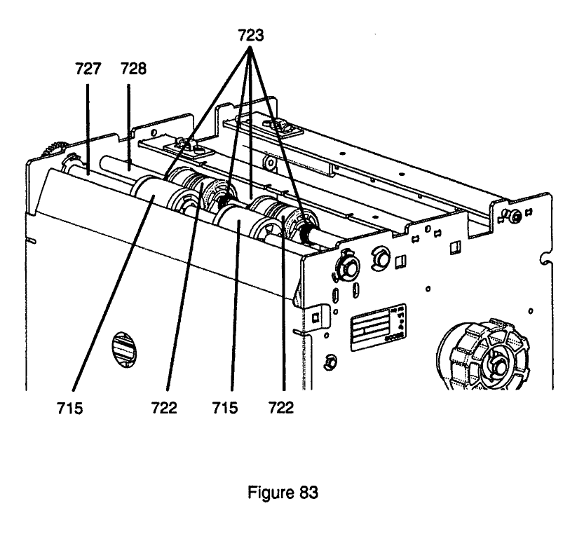

Through the function of coil springs 723 (FIG. 83) mounted on shaft 728, the swivel arms are spring-loaded and rest against the note storage drum 705. The springs ensure that the swivel arms are always in contact with the note storage drum, despite the constantly changing diameter of the drum as it winds bank notes and Mylar tape onto or off of its outer surface.

Specifically, the swivel arms make contact with the note storage drum through the windings of Mylar tape 704 on the drum's surface, contact is made through a roller 725 that is mounted within the swivel arm at the opposite end of the arm to the shaft 728 (FIG. 86).

At the end of the swivel arms, adjacent to the contact roller 725, a small plastic moulding—the note guide 717—is mounted (FIG. 86). Through the action of a leaf spring, the tip of the note guide is held in contact with the winding of Mylar tape at a position very close to the point where the Mylar tape breaks contact with the note storage drum; its function is to separate notes from the drum during the dispensing operation (FIG. 86). See Section 6.10.2.

In each swivel arm assembly, a second roller 731 is mounted on the opposite side of the swivel arm to that which is facing the note storage drum. The Mylar tape passes over this roller, which ensures a smooth path for the Mylar tape as it passes both onto or off the note storage drum, regardless of the diameter of the drum with its stored notes and windings of Mylar tape.

Mounted within one of the two swivel arms is a detector 714, which monitors the passage of notes onto and off the note storage drum. The data from the sensor is passed back to the controller unit 986.

6.6 Controller Unit

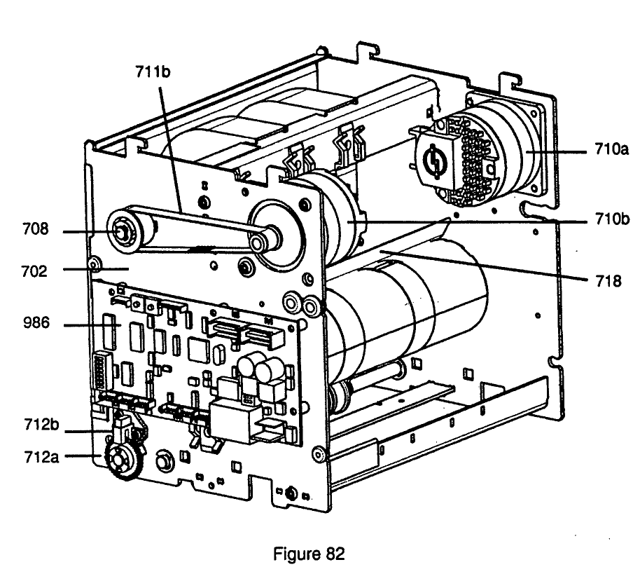

The roll storage modules 700 within the roll storage system are each equipped with their own individual controller unit 986, situated on the outside of the side plate 702 (FIG. 82). The controller unit communicates with the main control unit in the Twin Safe and manages the operation of both the roll storage module itself and also the note transport module section (top or bottom) to which it is attached.

Furthermore, the controller unit distributes power to the roll storage module components and receives, interprets and acts upon signals from the three sensors 712b, 713, and 714 that are mounted within the roll storage module.

Instructions from the main control unit of the Twin Safe, such as an instruction to store a specific bank note that is being presented to the roll storage system, are “addressed” to an individual roll storage module within the roll storage system. The roll storage modules each “know” their identity and position within the roll storage system and are thus able to identify which instructions are addressed to them. This is achieved by setting a DIP-switch on the roll storage module controller unit to a unique, pre-defined setting during initial setup of the Twin Safe.

The main control unit of the Twin Safe audits the movements and storage of notes within the machine. In addition, the semi-autonomous controller units 986 of the roll storage modules each also audit the movement of notes into and out of their own note storage facility (the note storage drum) through data received from sensor 714. By communicating this information to the main control unit, the Twin Safe is able to “cross-check” the process of storing notes by comparing the two sets of independently obtained data. If a storage count error should occur, the operator of the Twin Safe is informed, since this would indicate a malfunction somewhere within the Twin Safe.

6.7 Motors

Two identical electric motors 710a and 710b are fitted to the roll storage module 700; one is mounted on each of the side plates 701 and 702.

The roll-in motor, 710a (FIG. 81 and FIG. 82), drives the note storage drum shaft 709 via a drive belt 711a (FIG. 81).

The roll-out motor, 710b (FIG. 81 and FIG. 82), drives the tape transport reels shaft 708 via a drive belt 711b (FIG. 82).

Only one motor is operational at any one time, with the roll storage module either storing notes by driving the roll-in motor, dispensing notes by driving the roll-out motor, or remaining idle—in which state both motors are stationary.

The motors are of a design that allows them to run at a variable speed. The controller unit 986 of each roll storage module individually manages the speed of its onboard motors to ensure that the Mylar tapes run at a consistent speed. To achieve this consistency of tape speed, it is necessary to constantly adjust the speed of the driven shafts since the circumference of each Mylar tape winding on both the note storage drum and the tape storage reels alters with each revolution of the drum and reels.

The motors are of a design that permits their speed of rotation to be accurately controlled. Through this capability, the controller unit of the roll storage module is able to exactly match the speed of the Mylar tapes to the requirements of the roll storage system as a whole. It is imperative that the notes are accepted into the roll storage module at exactly the same speed at which they are transferred from the note transport module: if the tapes of a roll storage module (during the transfer of notes into the module) were running too quickly, the notes would be “snatched” from the note transport module and may be subject to stretch and tear forces that could damage the notes. Similarly, if the tapes were running too slowly, the note would be subject to folding, crumpling or other similar damage. The same possibilities also occur during the dispensing of notes, if the tapes were running at a speed that was not matched to that of the note transport module.

The motors are also of a design that permits the torque applied by the motor to the Mylar tapes to be both accurately measured and controlled. Through this capability, the tension on the Mylar tapes is carefully managed to ensure that sufficient tension is maintained on the tapes for them to perform satisfactorily without applying so much tension that the tapes may be stretched. Furthermore, should a jam of one or other of the tapes occur, the motors can sense the increase in tension within the Mylar tapes and limit torque to the tapes to prevent stretching or breaking.

6.8 Timing Wheel

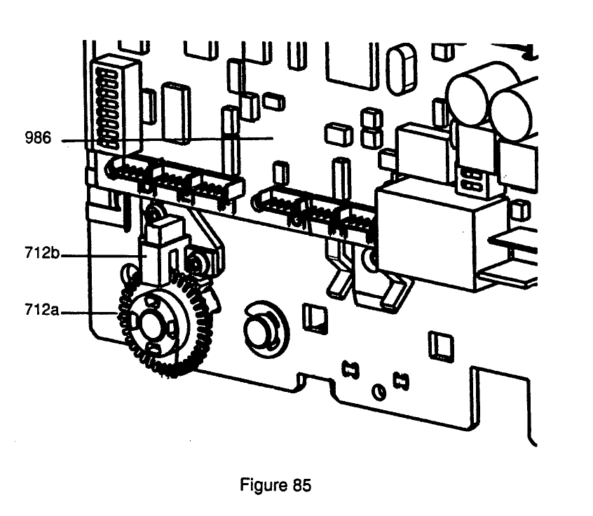

On the outer side of the side plate 702 is sited the timing wheel 712a (FIG. 85) which measures the speed of the Mylar tapes 704. The timing wheel is attached to the shaft 727 on which guide rollers 715 are mounted, over which the Mylar tapes run. The timing wheel consists of a black plastic wheel with fingers all around the outside edge. These fingers pass through a gap between the transmitter and receptor elements of the timing wheel optical sensor 712b (FIG. 85), creating breaks in the light path from the transmitter to the receiver as the fingers pass through. The frequency of the light pulses is transmitted by the sensor to the controller unit 986, indicating how fast the shaft—and thus the grey rubber rollers 715—is turning. As the Mylar tapes 704 are running around the grey rubber rollers 715 and providing the drive to the shaft and thus the timing wheel, the controller unit can measure the speed of the Mylar tapes. If the Mylar tape is running too fast or too slow, the controller unit will adjust the speed of the appropriate motor 710a or 710b to compensate.

6.9 Management of the Mylar Tapes

6.9.1 Path of the Mylar Tapes

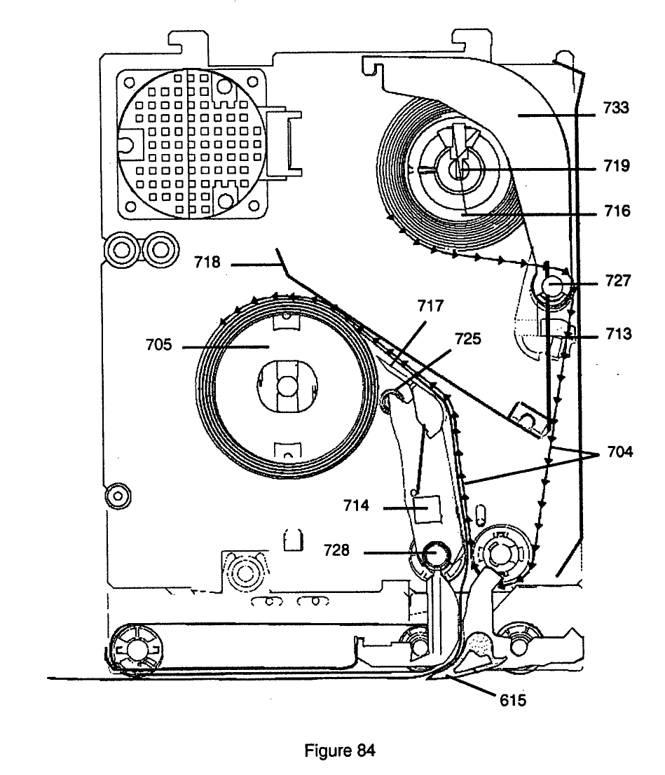

The complete tape path is best shown in FIG. 84.

The Mylar™ tapes 704 are held on tape storage reels 716, shielded by plastic covers 733 (FIG. 79, FIG. 84). From the tape storage reels, the tapes travel to and pass over guide rollers 737 (mounted on shaft 736, FIG. 79), and then onwards to pass over guide rollers 715 (mounted on shaft 727, FIG. 79). The guide rollers 715 are bowed to create a convex surface over which the tapes run in order to re-centre the Mylar tapes should any lateral displacement occur.

On the path of one of the Mylar tapes, a sensor 713 (FIG. 84) is mounted between the tape storage reel 716 and the guide roller 737. This sensor detects the ends of the tape. See Section 6.9.2.

Onwards from the guide rollers 715, the Mylar tapes then travel to pass over the guide rollers 731, mounted within the swivel arms 724, before winding directly onto the note storage drum 705.

6.9.2 Sensing the End of the Mylar Tape

Between a Mylar tape storage reel 716 and a guide roller 737 is an inductive sensor 713 over which one of the Mylar tapes 704 runs. The sensor is mounted onto a bracket incorporated into the plastic cover 733 for the tape storage reel (FIG. 79). A shield 732, also attached to the cover, prevents stray light from reaching the sensor.

The Mylar tape that passes over sensor 713 is fitted with six metal strips at each end to indicate that it is coming to the end of its range of movement—this also indicates that the note storage drum 705 is full. When one of the metal strips passes over the inductive sensor, a signal is sent to the controller to indicate this state. Multiple strips provide a progressive warning to the controller unit and allow for the loss of a strip through wear and tear.

6.9.3 Tension in the Mylar Tapes

Maintaining the correct tension in the Mylar tapes 704 is critical to the correct functioning of the roll storage module 700. The use of sophisticated electric motors 710a and 710b to drive the Mylar tapes ensures that the tapes are always maintained at the correct tension and are never strained through the application of excessive drive torque. See Section 6.7 for further information.

Also critical to the correct functioning of the roll storage module 700 is the ability of the Mylar tapes 704 to run at slightly different speeds to each other and thus to be dispensed from their tape storage reels at different rates. This capability is necessary in order to accommodate variations that occur in the outside diameter of the note storage drum together with its windings of bank notes and Mylar tape. The variation in diameter occurs between the two points where the Mylar tapes wind onto the drum during normal operation of the roll storage module. These variations occur, for example, when more tape is wound onto one side of the note storage drum than the other in order to accommodate the metal strip within a bank note, which causes a variation in the note's thickness across its width.

To accommodate this requirement, the Mylar tape storage reels 716 are driven by a differential gear set 719 (FIG. 87).

6.9.4 Differential Gear Set

See FIG. 87.

A very short shaft is fixed to shaft 708, at the centre point of shaft 708, in a perpendicular direction. This short shaft acts as a stub axle with small bevel gear 721 mounted at its end, which is free to rotate. Both tape storage reels 716 have a bevel gear 720 moulded into one of their side faces and are free to rotate on shaft 708.

When the roll storage module 700 is storing bank notes, the Mylar tapes 704 are wound from the tape storage reels 716 onto the note storage drum 705. If the Mylar tapes are wound onto the note storage drum at an equal rate, both tape storage reels are turned at an equal rate by the tapes being drawn off them. Because the bevel gears 720 are thus turning at the same rate, small bevel gear 721 remains stationary on its axis and the stub axle drives shaft 708 round at the same rate as the tape storage reels.

The electric motor 710b is not energised during note storage, but it has an in-built resistance to rotation. This resistance acts as a brake on the rotation of the tape storage reels and maintains tension in the Mylar tapes as they are wound onto the note storage drum.

If the bank notes vary in thickness across their width (or some other situation arises causing a variation in note thickness, such as a folded note), this will cause a variance in the diameter of the two tape windings on the note storage drum. More of one tape than the other will then be required to complete a single winding of both tapes onto the drum. In this situation, the tape with the larger diameter winding will be pulled off its tape storage reel at a faster rate than the other tape. To allow this to happen, small bevel gear 721 starts to rotate on its axis setting up a differential in the relative speeds of the two tape storage reels. The speed of rotation of small bevel gear 721 is such that, whilst the tapes may be dispensed at different rates, the tension in the tapes is equal. The inbuilt resistance-to-rotation of the electric motor 710b still maintains tension in the two tapes, the tension being equalised between the two tapes by the action of the differential gear set.

When the roll storage module 700 is dispensing bank notes, the Mylar tapes are wound from the note storage drum 705 onto the tape storage reels 716.

If during the storing of the notes, the two tapes were dispensed in equal amounts from their tape storage reels, they will be wound back at an equal rate by the action of the electric motor 710b driving shaft 708. Drive is transferred to the note storage reels via the stub axle and small bevel gear 721. In this situation, the small bevel gear remains stationary on its axis.

If, during the storing of the notes, more of one tape was dispensed than the other, the tension on the two tapes will still be equal because of the compensating action of the differential gear set 719 during tape deployment (see above). Initially, as dispensing commences and the tapes are wound back onto the tape storage reels, small bevel gear 721 will be stationary on its axis because of the equal tension in the Mylar tapes. Shaft 708 will turn and the tapes will be wound onto the tape storage reels at an equal rate. As the tape winding progresses, the amount of tape fed back from the note storage drum will differ between the tapes. At this point, the tension in the tape that was deployed in greater length will drop and the differential gear set will start to operate in compensation. Small bevel gear will start to turn and will rotate the tape storage reel of the tape in which there is least tension at a faster rate than the other reel. Small bevel gear 721 will accelerate its axial rotation until a speed is attained whereby tension in the tapes is once more equal. Small bevel gear 721 will then turn at a constant speed until a difference in the tension of the tapes occurs.

Throughout the process of winding the tapes back onto their storage reels, the differential gear set will constantly adjust the relative speed of the two reels to ensure an equal tension always exists on both tapes at all times. Simultaneously, the differential gear set manages any difference in the amount of tape deployed automatically by creating a difference in speed of the tape storage reels.

The electric motor 710a is not energised during the dispensing of notes, but it has an in-built resistance to rotation. This resistance acts as a brake on the rotation of the note storage drum and maintains tension in the Mylar tapes as they are wound onto the tape storage reels.

Because the two tapes are able to travel at different speeds, the guide rollers 737 are not keyed to shaft 736 are able to turn independently of each other and the shaft.

Because the two tapes are able to travel at different speeds, the guide rollers 715 on shaft 727 are able to turn independently of each other. Because the rotational speed of shaft 727 is measured using timing wheel 712a and sensor 712b, one of the two guide rollers 715 is keyed to the shaft so that the shaft and guide roller turn together.

6.10 Bank Note Path

6.10.1 Bank Note Storage Process

Bank notes are directed into the roll storage module 700 by a feedgate tongue 615 (FIG. 84) in the attached note transport module (or the feedgate tongue 613 in the corresponding lower note transport module, see Section 5).

The notes pass into the roll storage module between two closely set pairs of rollers: guide rollers 715 and pinch rollers 722, which guide the note into the roll storage module (FIG. 83). Neither of the shafts 727 and 728, on which these four rollers 715 and 722 are mounted, are driven by a motor; they are driven by the movement of the Mylar tape 704 over one guide roller 715 that is keyed to shaft 727 (the other guide roller 715 freewheels on shaft 727 to allow the tapes to run at different speeds, see “6.9.4 Differential Gear Set”, above).

The pinch rollers 722 are set so close to the guide rollers 715 that the outer serrated edge of the black plastic pinch rollers 722 contact with their matching guide roller 715 and are thus are turned by friction. The serrated edges of the pinch rollers are flexible enough to permit the passage of a bank note between the two sets of rollers; this presses the bank note against moving rollers 715 and the Mylar tapes, causing the note to be drawn into the roll storage module.

The two guide rollers 715 are bowed to provide a convex surface to prevent any lateral movement in the Mylar tapes 704.

Once the note has entered the roll storage module, it is drawn past reflex sensor 714; the bank note breaks the light path between the sensor's sender and receiver units. This reflex sensor 714 reports to the controller unit 986 that a note has passed into the roll storage module.

The note is then fed over the Swivel arms 724 and the swivel arm rollers 731, held in place by the Mylar tapes 704. Guide plate 718 presses upon the bank note and the Mylar tapes, and guides them onto the note storage drum 705. The guide plate 718 is held in constant contact with the note storage drum and the note & tape windings, and prevents notes from folding over as they are wound on.

Guide plate 718 pivots on shaft 735 and obtains its spring action though a spring clip 726, which is slotted onto the guiding roller shaft 736 (FIG. 79). Because it is sprung, the guide plate maintains its position resting on the note storage drum 705 at all times, regardless of the drum's changing diameter occasioned by the storage of notes on the drum.

During the note storage process, the Mylar tapes are always kept at an equal tension as they are wound onto the note storage drum. This is achieved through the controlling function of the differential gear set 719. See “6.9.4 Differential Gear Set” on page 80 for further information.

6.10.2 Bank Note Dispensing Process

To dispense notes from the roll storage module 700, the storage process is reversed. The motor 710a, driving the note storage drum 705, is inactivate and motor 710b, driving the Mylar tape storage reels 716, is activate.

During the note dispensing process, the Mylar tapes are always kept at an equal tension as they are wound onto the tape storage reels. This is achieved through the controlling function of the differential gear set 719. See “6.9.4 Differential Gear Set” on page 80 for further information.

As the Mylar tapes are wound back onto the tape storage reels 716, they are pulled off note storage drum 705, causing it to rotate. A stored bank note is unwound from the note storage drum and the note guides 717 ensure that it is lifted from the note storage drum and over the back of Swivel arms 724 (see below). The note then passes over reflex sensor 714, which detects its presence and sends a signal to the controller unit 986 indicating that the bank note is leaving the roll storage module. The bank note is passed out between the two sets of rollers 715 and 722 into the note transport module 300.

The note storage drum 705 changes its overall diameter as it stores or dispenses bank notes during use of the roll storage module. At all times, the angle between the note guide 717 and the outer surface of the note storage drum needs to be kept constant so that the note guide is always at the correct angle to peel bank notes off the windings of Mylar tape.

To achieve this, firstly the roller 725 of the swivel arm 724 is held in constant contact with the Mylar tape windings that are on the note storage drum. This is achieved through the use of coil springs 723; see “6.5.4 Swivel Arms” on page 75 for more information.

Secondly, the tip of the note guide 717 is also kept in constant contact with the Mylar tape windings that are on the note storage drum. The note guide is attached to the end of the Swivel arm 724, mounted on pivots that protrude from each side. Two leaf springs 729, mounted on pegs 730, pivot the note guide toward the note storage drum so that the tip of the note guide rests on the windings of Mylar tape on the drum. The leaf springs are designed to exert the correct amount of pressure to achieve satisfactory “peeling” of the notes from the storage drum without causing undue wear of the Mylar tapes.

7. Control System 900

7.1 Overview

The TCR Twin Safe is managed by a Main Control Unit together with a number of other controllers associated with individual modules. The Main Control Unit connects to the operator terminals, and it can also connect to a number of other components including a host computer, journal printer and up to four Safemaster units. It is housed in a control box, to which an optional Network Interface Unit can be fitted, so that the Twin Safe can be run from any terminal on the network.

The module controllers have connections to the working components of the Twin Safe such as motors, sensors and switches.

The controllers are connected to each other through the Control Area Network (CAN) bus, and each of them is identified with a unique address, which can be set using a dipswitch. Each CAN bus connector has two network sockets so that the controllers can be daisy-chained together.

7.2 Power Management

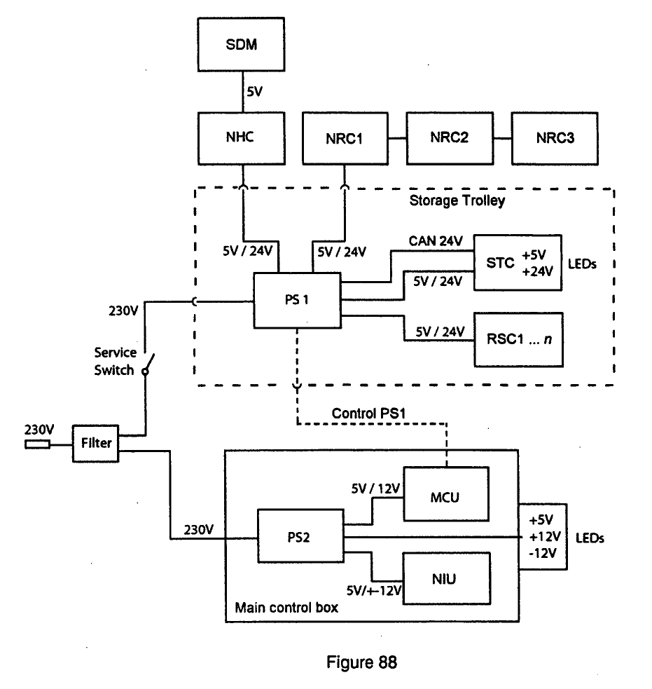

The power management system for the Twin Safe is shown in FIG. 88. It begins with a filter to obtain clean power from the mains, free of spikes and surges. The output from the filter goes to two separate power supplies as follows:
The power supply PS1 supplies 5 V and 24 V to the control units for all the modules. It also supplies 24V to the CAN bus via the Storage Transport Module. However, it is switched off by a control signal from the Main Control Unit, to conserve power when the Twin Safe is not in use. It is also switched off by the service switch when the safe door is opened.
The power supply PS2 supplies 5 V and 12 V to the Main Control Unit (MCU). Only 5 V is required for the MCU, but 12 V is also available in case it is required for the electronic locking system. A higher rated power supply is used when the Network Interface Unit (NIU) is fitted, giving 5 V and +/−12 V. The power supply PS2 remains switched on at all times as long as the Twinsafe system is connected to the mains.

The components mounted on the storage trolley are shown within a dotted rectangle in FIG. 88. These include the power supply PS1, the Storage Transport Controller (STC) and the Roll Storage Controllers (RSC1 . . . RSCn) where n represents the number of Roll Storage Modules which can be 2, 4, 6 or 8.

The components at the top of the Twin Safe, above the storage cabinet, are as follows:
The Note Handling Controller (NHC).
The Note Reader Controllers up to a maximum of three:
   NRC1 (master)
   NRC2 (slave 1)
   NRC3 (slave 2)
The Service Display Module (SDM), if fitted. This is an optional unit which takes 5 V power from the NHC.
   7.3 CAN Bus

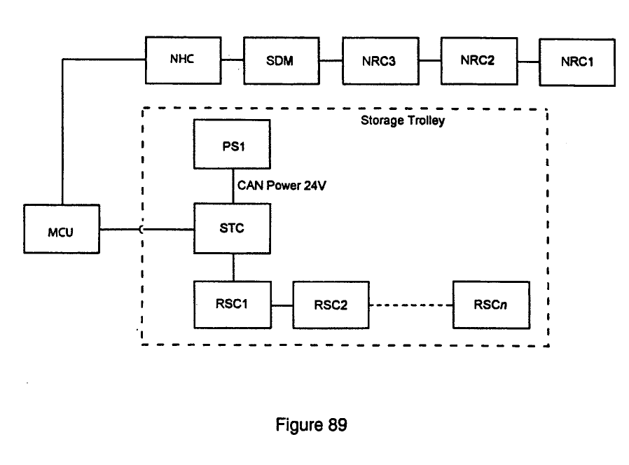

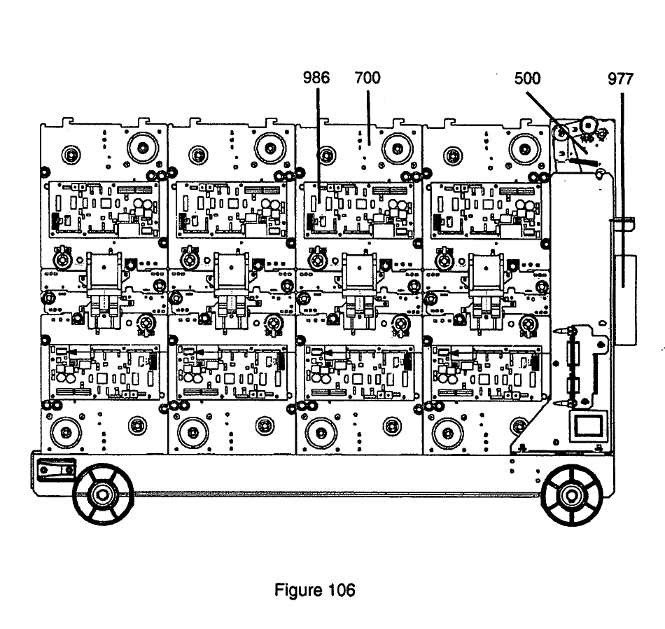

The CAN bus connections between the control units are shown in FIG. 89. The Main Control Unit (MCU) connects to the Storage Transport Controller (STC) and the Note Handling Controller (NHC), and from these two points the CAN bus continues as follows:
The Storage Transport Controller connects to the first in the series of Roll Storage Controllers (RSC1, RSC2, . . . RSCn), which are daisy-chained together (FIGS. 89 and 106). The numbering of the Roll Storage Controllers is determined by their position on the CAN bus, which does not necessarily follow the numbering for transport purposes, in which the feedgates open to the lower modules first, then the upper modules.
The Note Handling Controller connects to the Service Display Module (SDM) which in turn connects to the last in the series of Note Reader Controllers. If all three sensor heads are fitted, this will be NRC3. If two heads are fitted, it will be NRC2, otherwise it will be NRC1.

Each controller on the bus has to be given a unique address, set from an eight-pin dipswitch. The controllers at the end of the bus are terminated using a two-pole dipswitch. These are:
The first Note Reader Controller (NRC1), for the master sensor head.
The last Roll Storage Controller (RSCn)

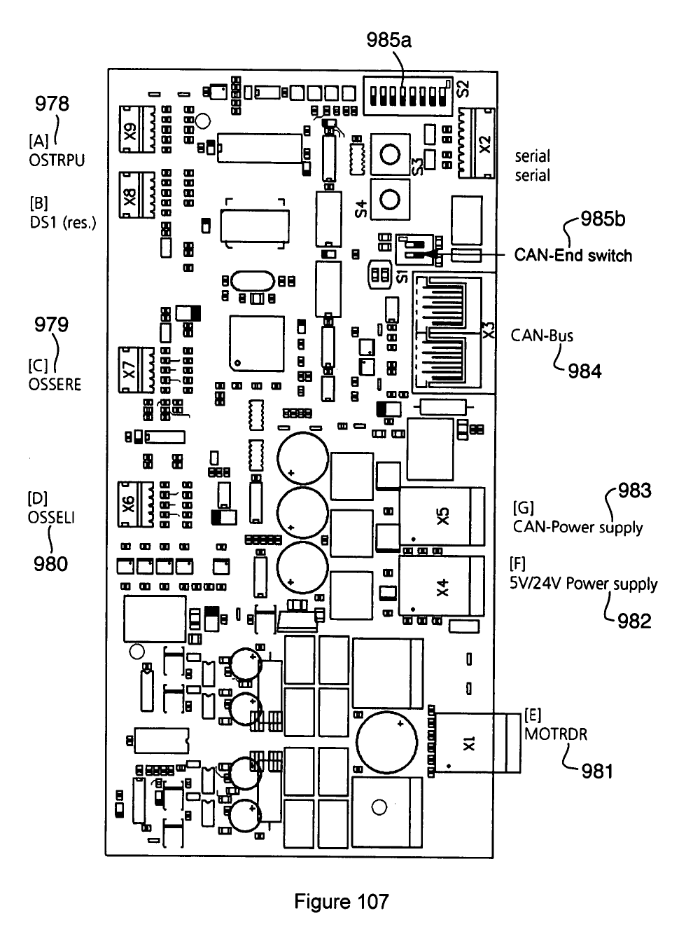

The power supply from PS1 to the CAN bus is through the Storage Transport Controller because it is situated at a convenient point at the centre of the bus. There are two separate power sockets 982 and 983 (FIG. 107) on the Storage Transport Controller, one for the module and the other for the bus.

The Storage Transport Controller and Roll Storage Controllers are mounted on the storage trolley (FIG. 106), represented by the dotted rectangle in FIG. 89.

7.4 Storage Trolley Electrical Connectors

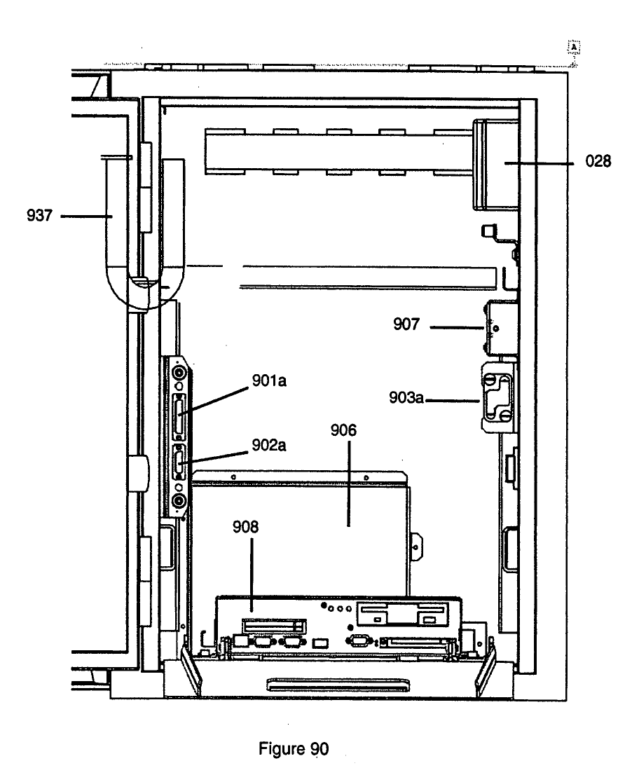

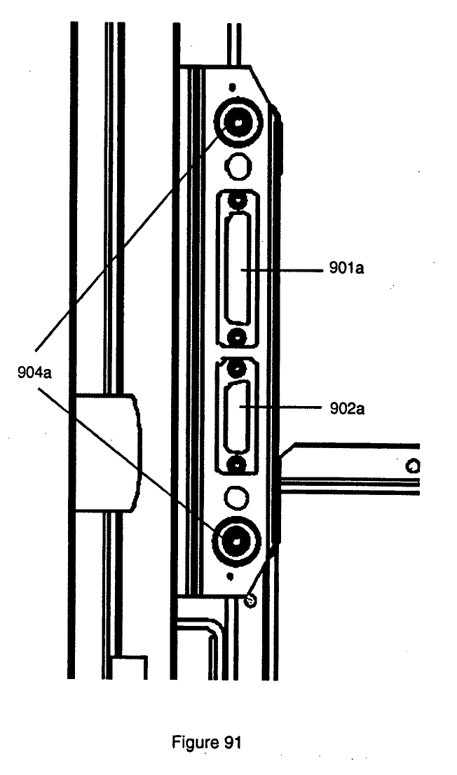

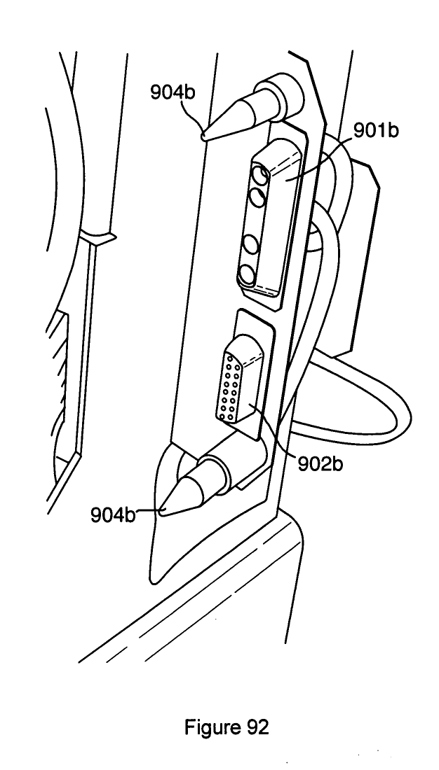

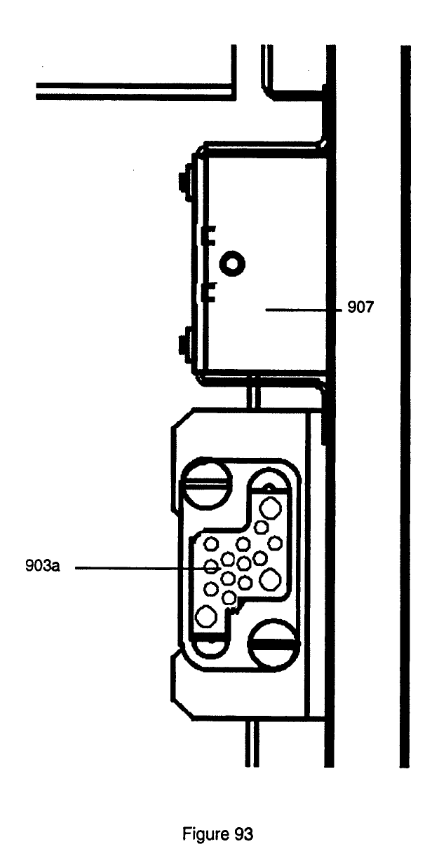

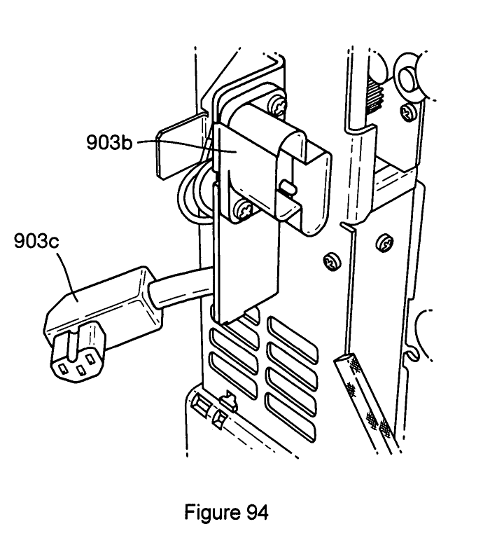

When the storage trolley is removed from the cabinet, a number of electrical connectors become disengaged, and then they are re-engaged when the trolley is returned. The connectors are designed so that this occurs automatically and there is no need for the operator to disconnect and re-connect any wiring. The sockets are mounted on the left and right sides of the cabinet (FIGS. 90, 91 and 93) and their matching components are on the left and right sides of the trolley (FIGS. 92 and 94).

The socket 901a on the left side of the cabinet has four pins, supplying 5 V and 24 V power to the Note Handling Controller and the first in the series of Note Reader Controllers. These pins engage with the corresponding socket 901b on the trolley, which connects to the power supply PS1.

The socket 902a on the left side of the cabinet has 15 pins although not all of them are used. This socket engages with the corresponding component 902b on the trolley, and provides the following connections with the Main Control Unit:
The CAN bus connection from the MCU to the Storage Transport Controller
The control connection from the MCU to the power supply PS1, to switch it off when it is not being used.

The socket 903a on the right side of the cabinet has three pins (live, negative and earth) connected to the mains via the filter 906 and service switch 907 (FIG. 90). It engages with the socket 903b on the trolley, which connects to the power supply PS1 using the plug 903c.

When the trolley is returned to the cabinet, and the electrical connectors engage with each other, the correct alignment is achieved as follows:
The two alignment pins 904b on the left side of the trolley fit into their sockets 904a on the left side of the cabinet.
The three pins on the power supply connector 903b are large enough to engage with the socket 903a, without the need for alignment pins. They will engage easily when the left side is engaged, if the components have been fitted to their mountings correctly.
   7.5 External Connectors

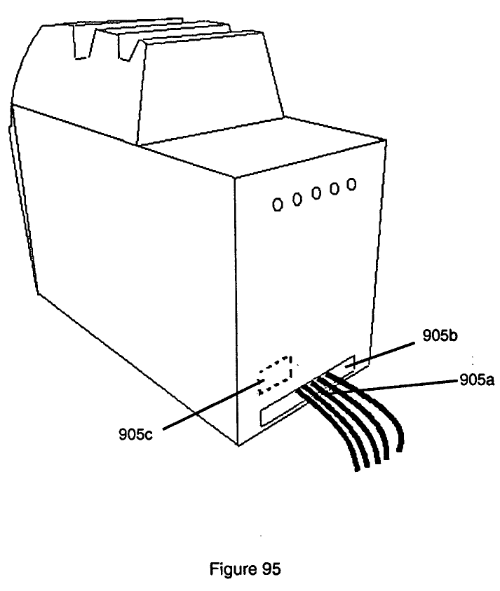

The Twin Safe connects to its environment through the cables 905a (FIG. 95), which run through an aperture 905b at the front of the cabinet. Most of the cables are fitted with plugs so that they connect directly to the Main Control Box. If an alarm is fitted, the cables will be connected to a terminal block 905c located at a suitable point in the cabinet. If it is necessary to hide the alarm cables, they will go down through the floor, instead of using the aperture 905b.

7.6 Main Control Unit and Network Interface Unit

The Main Control Unit (MCU) and the optional Network Interface Unit (NIU) are located in the main control box 908 (FIG. 90) on the floor of the storage cabinet. It is mounted so that the “front panel” is towards the rear of the Twin Safe and the “rear panel” is at the front. To avoid confusion of terms, the front panel is called the “service panel” because it faces the service engineer when the safe door is opened and the trolley is removed. The rear panel is called the “wiring panel” because it contains only cable connections to other devices.

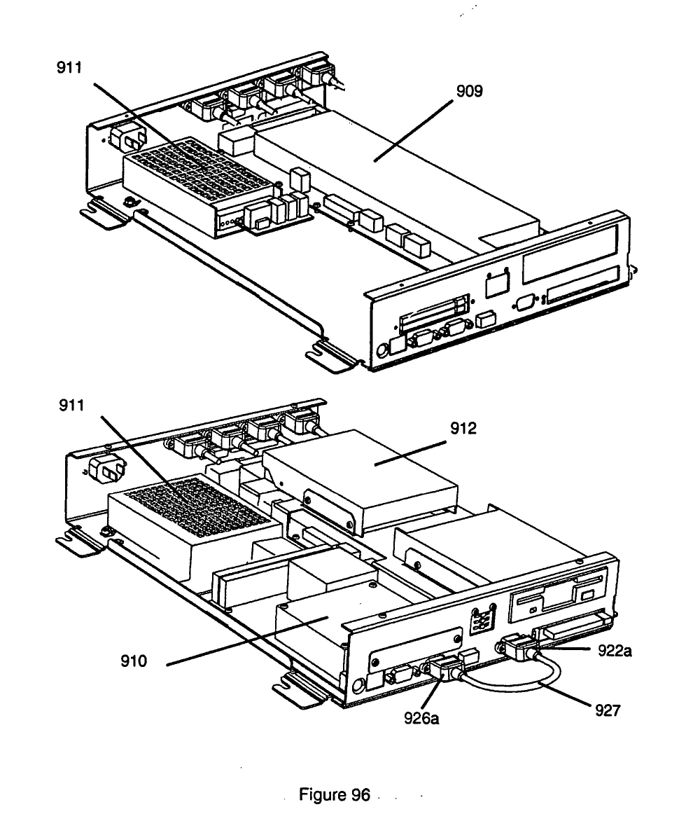

FIG. 96 shows the internal components of the main control box, with and without the NIU. The MCU circuit board 909 occupies the right side of the box. The Network Interface Unit (NIU) circuit board 910, if fitted, is at the left side next to the PS2 power supply 911.

The NIU is an industrial PC with a hard disk 912 mounted above the MCU circuit board.

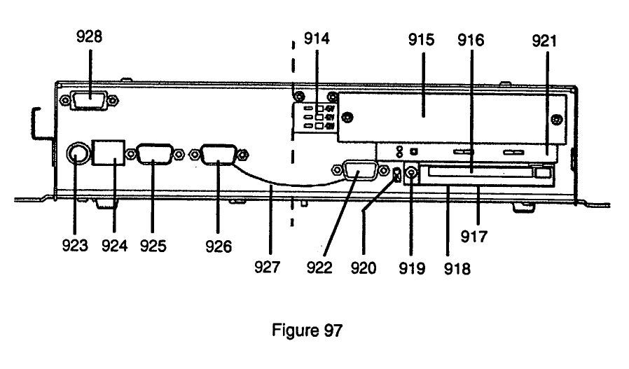

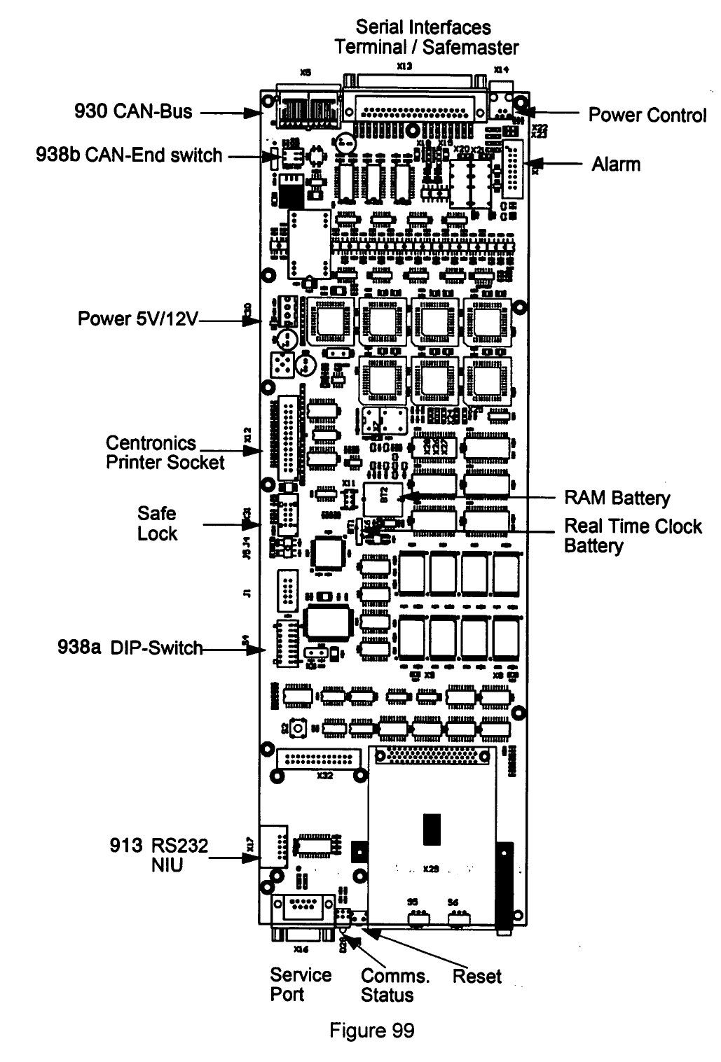

The NIU and MCU are connected to each other both internally and externally as follows:
The NIU connects to an internal RS232 socket 913 (FIG. 99) on the MCU.
The NIU and MCU connect externally using the RS232 sockets shown in FIGS. 96 and 97. The socket 926 on the NIU connects to the socket 922 on the MCU using the cable 927 with RS232 plugs 926a and 922a. The cable is in place during normal operation, but has to be disconnected from the MCU socket 922 when the service PC is used.

FIG. 97 shows the service panel components. The vertical dotted line marks the boundary between the NIU on the left and the MCU on the right. The MCU components are as follows:
LEDs 914 to indicate MCU/NIU power-on 5 V/+12 V/−12V. The −12 V LED is applicable only if the NIU is fitted.
Floppy disk drive 915, for initial preparation only. When the preparation is complete, the drive is removed.
PCMCIA slot 916, for import and export of programs and data using a PCMCIA flash memory card.
Boot switch 917. This can have the following values:
   Onboard, for normal operation.
   PC Card, for maintenance purposes involving the download of programs from a PC card.
Download switch 918. This can have the following values:
   Betrieb, for normal operation.
   DL, for the initial software download to the MCU.
Reset button 919. This is equivalent to shutting down and restarting the MCU. The system will execute a batch file called exec_mcu.bat if it is present on a flash memory card in the PCMCIA slot.
LEDs 920 to indicate MCU status and communication.
Label 921 for boot switch 917, download switch 918, reset button 919 and MCU status and communication LEDs 920.
9-pin RS232 socket 922, for connection to a service PC, to collect journal and operational data from the Twin Safe. This socket connects to the NIU when the service PC is not in use.

Since the Network Interface Unit is a standard industrial PC, the following additional components will be on the service panel if the NIU is fitted:
DIN socket 923 for connection to a keyboard and mouse. Two cables are connected to this socket, both wired to the same DIN plug.
Ethernet socket 924 for connection to an external network.
15-pin VGA socket 925 for connection to a monitor.
9-pin RS232 socket 926 which connects to the socket 922 on the MCU, using the cable 927 when the service PC is not connected.
9-pin RS232 socket 928 for remote access.

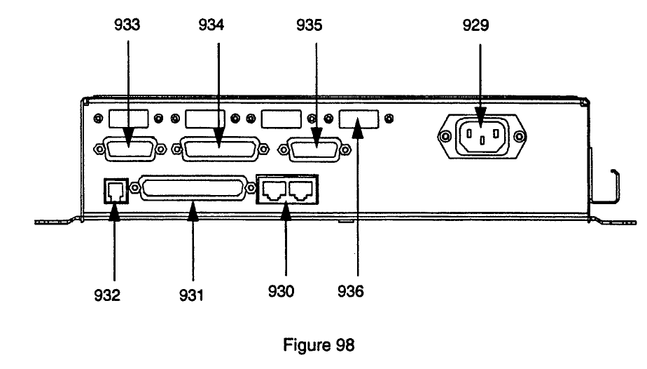

FIG. 98 shows the connections to the wiring panel of the main control box. In this case there are no additional sockets if an NIU is fitted. The sockets are as follows:
Power socket 929 for mains input from the filter.
Pair of CAN bus sockets 930. One of these connects the Note Handling Controller and the other to the Storage Transport Controller.
37-pin socket 931 for the two operator terminals and a modem. The modem is used for communication with other devices over the telephone networks. Three cables are connected to this socket, all wired into a 37-pin plug. At the other end, two of the cables have 9-pin RS232 plugs for the operator terminals and the other cable has a 25-pin RS232 plug for the modem.
12-pin RJ socket 932 to send a control signal to the power supply PS1 on the storage trolley, to turn it off when not in use.
15-pin socket 933 for the bank alarm, Twin Safe alarm and operation of two Safemaster units. Four cables are connected to this socket, all wired into a 15-pin plug. At the other end, two of the cables have 9-pin RS232 plugs for the Safemaster units. The other two cables, for the alarms, have no plugs and are wired directly into the terminal block at the front of the storage cabinet. FIG. 90 shows an alarm 028 fitted to the side of the cabinet.
25-pin Centronics socket 934 for the journal printer.
9-pin RS232 socket 935 for the safe door solenoid. This is for use with electronic door locks, if fitted.
Provision is made for up to four USB sockets 936, for future use.

FIG. 99 shows the MCU circuit board. The address for the CAN bus 930 is set using the dip switch 938a. The CAN bus termination is set using the dip switch 938b and in this case the termination should be OFF.

7.7 Module Controllers

7.7.1 Abbreviations

The connections from the module controllers to the various devices within the system are given abbreviations which are made up from standard acronyms. For example, the optical sensor on the Input Module, which detects the presence of banknotes in the input tray, has the abbreviation OSINCA, made up from:

OS Optical sensor

IN Input

CA Cassette

The first two characters indicate the component type and the remaining characters, up to six, indicate their use, so that there can be up to eight characters altogether.

The abbreviations are sometimes printed on the circuit board covers, for example on the Note Handling Controller. There may also be labels such as A, B, C etc., printed on the circuit boards or on the covers.

The component types for the abbreviations are:

| Acronym | Description |
|---|---|
| CL | Clutch |
| IS | Inductive sensor |
| LD | LED |
| MO | Motor |
| MS | Microswitch |
| OS | Optical sensor |
| SO | Solenoid |

The uses are:

| Acronym | Description |
|---|---|
| BA | Band |
| CA | Cassette |
| CL | Close |
| CV | Cover |
| DR | Drive |
| IN | Input |
| LE | Left |
| NT | Note thickness |
| OP | Open |
| OU | Output |
| PA | Path |
| PO | Position |
| PS | Path selector |
| PU | Pulse |
| RE | Right (German recht) |
| RI | Right |
| SE | Separator |
| ST | Storage |
| TR | Transport |

7.7.2 Note Handling Controller

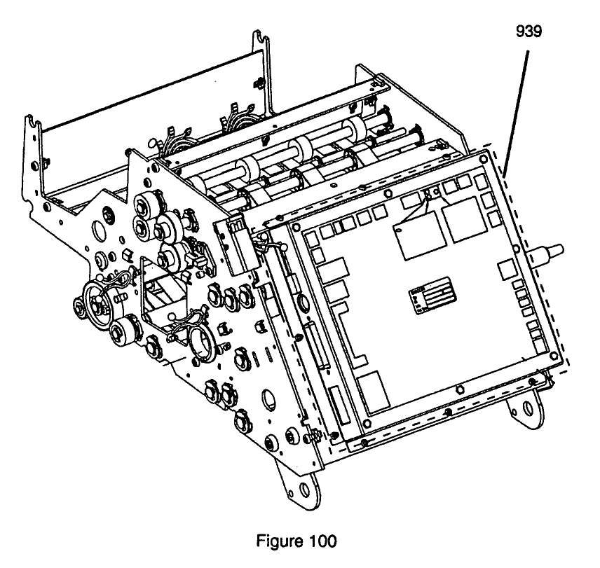

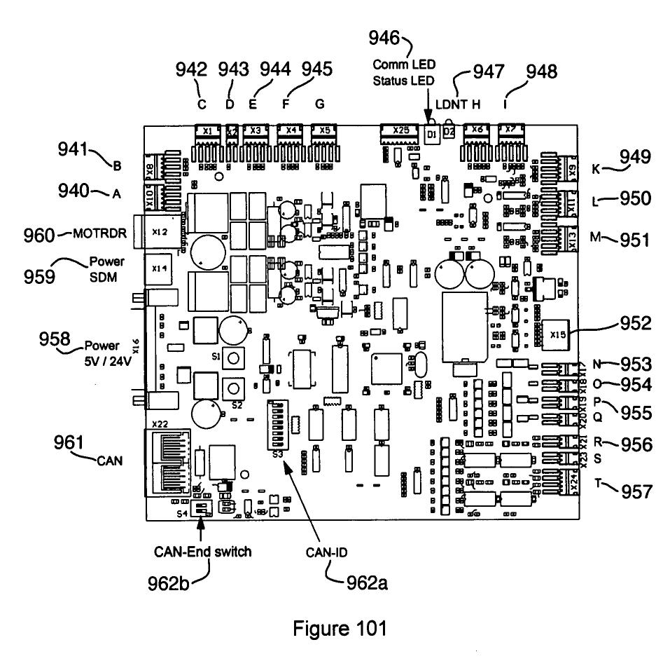

Note Handling Controller 939 is best shown in FIGS. 100 and 101.

The table below shows the connections.

| Num- | | | |
|---|---|---|---|
| ber | Label | Abbreviation | Description |
| 940 | A | MSINCACL | Two micro-switches on |
| | | MSINCAOP | Input Module |
| | | | (closed / open) |
| 941 | B | OSINCA | Optical sensor on Input Module, |
| | | | detects banknotes in tray. |
| 942 | C | OSOUCA | Optical sensor on Output |
| | | | Module, detects |
| | | | banknotes in tray. |
| 943 | D | MSCV | Micro switch on Output Module, |
| | | | engages with pin on |
| | | | cover to detect |
| | | | that cover is closed. |
| 944 | E | OSTRPU | Optical sensor, transport pulse, |
| | | | (rotating counter |
| | | | sensor) at left of |
| | | | Output Module. |
| 945 | F | OSPS1PO | Solenoid check sensor |
| | | | (optical), to ensure that the |
| | | | feedgate has moved fully to |
| | | | the active position, sending |
| | | | notes to the output path. |
| | G | OSPS2PO | Not used |
| | Serial | | Not used |
| 946 | 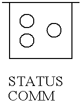 | | This pair of LEDs shows software status and communications status. green: OK yellow: warning red: error |
| 947 | 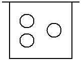 | ISNT (LDNT in FIG. 90) | This LED indicates status of note thickness sensor. red continuous: OK red flashing: bad A flashing LED means the Note Handling Module has not been closed properly or the thickness sensor needs adjustment. |
| | H | AS1 | Not used |
| 948 | I | OSPSPARI | Optical sensor, right, before |
| | | | feedgate. |
| 949 | K | OSOUPA | Optical sensor at entry to Output |
| | | | Module, after feedgate. |
| 950 | L | OSPSPALE | Optical sensor, left, |
| | | | before feedgate. |
| 951 | M | OSSEPA | Optical sensor on transport base |
| | | | unit, under the Input Module. |
| | | | Detects the arrival of notes |
| | | | on the input path, |
| | | | after they have been |
| | | | separated by the Input Module. |
| 952 | | ISNT | Note thickness sensor, inductive. |
| 953 | N | CLINTR | Transport route clutch, drives |
| | | | the input path. |
| 954 | O | OLSE | Separator clutch on Input |
| | | | Module. |
| 955 | P | SOPS1 | Feedgate solenoid. |
| | Q | SOPS2 | Not used |
| 956 | R | MOINCA | Motor (DC) on Input Module, to |
| | | | operate pressure plate. |
| | S | MOI | Not used |
| 957 | T | MODOLE | Motors (DC) for left and |
| | | | right sliding |
| | | MODORI | doors on cover, to allow access |
| | | | to output tray. |
| 958 | 5 V/24 V Power | | Power supply from PS1. |
| | | | Connects to the 4-pin |
| | | | plug at the left of the |
| | | | storage cabinet. |
| 959 | DISC Power | | Power, 5 V, to Service Display |
| | | | Module |
| 960 | | MOTRDR | Motor (stepper) for NHM |
| | | | transport drive. |
| 961 | CAN | | Two CAN bus connections. |
| | | | One to the Main Control |
| | | | Unit and the other |
| | | | to the Service Display Module, |
| | | | if fitted, otherwise |
| | | | to the Note Reader Module. |
| 962a | | | DIP switch to set CAN ID |
| 962b | | | DIP switch to set CAN |
| | | | termination: OFF |

7.8 Service Display Module and Note Reader Module

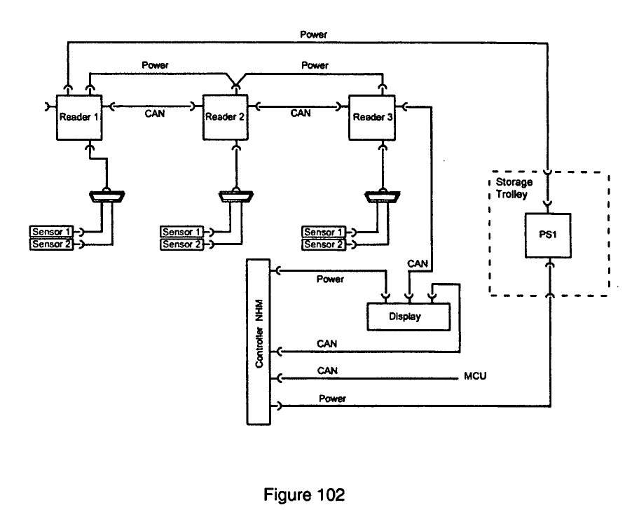

FIG. 102 shows the connections between the Note Handling Controller, the Service Display Module and Note Reader Module.

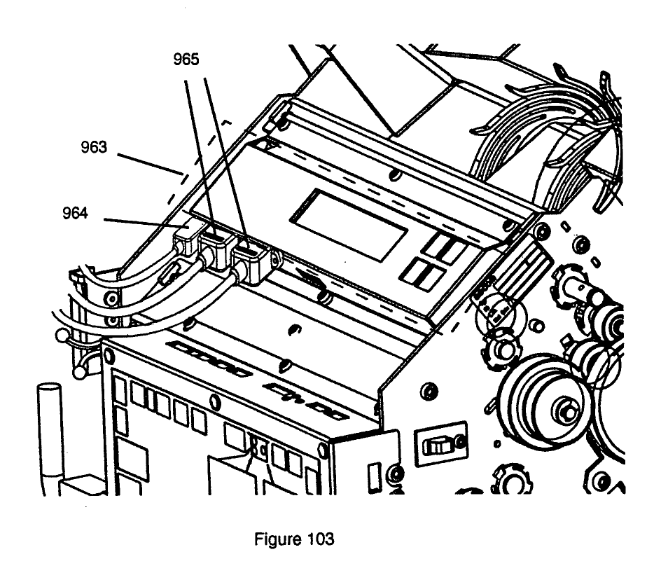

FIG. 103 shows the Service Display Module with the following connections:
5V power input 964 from the NHC output 959 (FIG. 90).
Pair of CAN bus connectors 965, one to the NHC and the other to Note Reader Module.

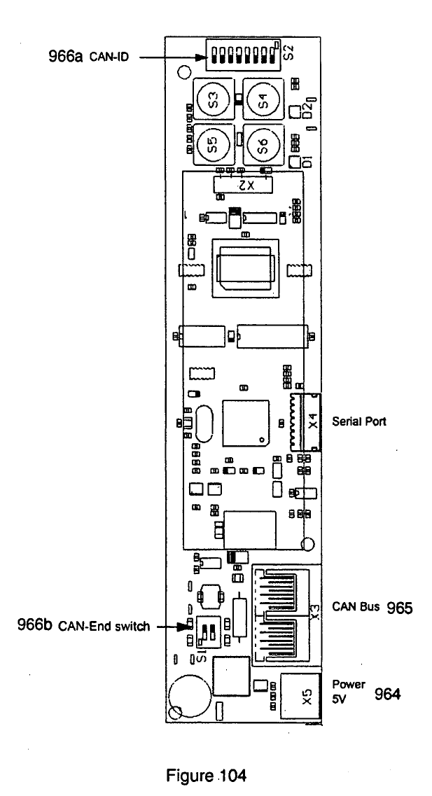

FIG. 104 shows the Service Display Module circuit board. The CAN bus address is set from the dip switch 966a and the CAN bus termination is set from the dip switch 966b. In this case the termination should be OFF.

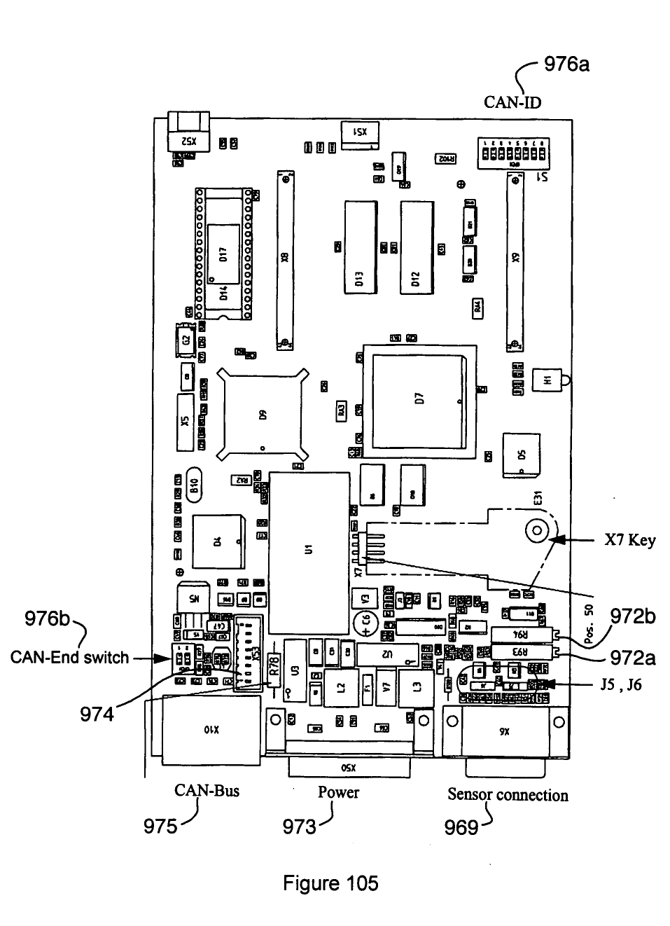

FIG. 9 shows the Note Reader Module with the control box 967 at the top and up to three sensor heads 301a, 301b and 301c at the bottom. The control box contains up to three circuit boards 968 (FIG. 105), one for each sensor head, and the connections and other components are as follows:
Each circuit board has a socket 969 (FIG. 105) which connects to a sensor using a cable. There are three cables with plugs 970a, 970b and 970c connecting to the circuit boards, and plugs 971a, 971b and 971c connecting to the sensors (FIG. 9).
Each circuit board has two adjustment screws 972a and 972b, for calibration of the infra-red and green or ultra-violet sensors within the head.
Each circuit board has two power sockets, an external socket 973 and an internal socket 974 (FIG. 105). The power supply PS1 connects to the first circuit board (the master), using a plug 973a (FIG. 9) fitted to the external socket. The slave units, if fitted, are daisy chained to each other, and to the master, using their internal sockets 974. The external sockets 973 on the slave units are not used.
Each circuit board has a pair of CAN bus connectors 975, so that one of them connects to the Service Display Module and the others are daisy-chained to it. The CAN bus address is set from the dipswitch 976a and the CAN bus termination is set from the dipswitch 976b. The termination should be:
   ON for the master, because it is at the end of the bus;
   OFF for the two slaves, if fitted.
      7.9 Storage Transport Controller

The Storage Transport Controller 977 (FIG. 106) is mounted on the back of the Storage Transport Module 500 and the connections are as follows:

| Number | Label | Abbreviation | Description |
|---|---|---|---|
| 978 | A | OSTRPU | Optical sensor, transport pulse, (rotating |
| | | | counter sensor) in the Storage Transport |
| | | | Module. |
| | B | DS1 | Reserved |
| 979 | C | OSSERE | Optical sensor, right |
| 980 | D | OSSELE | Optical sensor, left |
| 981 | E | MOTRDR | Motor (stepper), transport drive, for the |
| | | | Storage Transport Module, Note Transport |
| | | | Modules and storage gateway |
| 982 | F | | Power supply, 5 V/24 V, for the Storage |
| | | | Transport Module, from PS1. |
| 983 | G | | Power supply, 24 V, for the CAN bus, |
| | | | from PS1. |
| 984 | CAN | | Two CAN bus connections. One to the |
| | | | Main Control Unit, via the socket 902a |
| | | | (Figure) on the side of the storage cabinet, |
| | | | and the other to the first in the series of |
| | | | Roll Storage Controllers. |
| | Serial | | Not used |
| 985a | | | DIP switch to set CAN ID |
| 985b | | | DIP switch to set CAN termination: OFF |

7.10 Roll Storage Controllers

There is one Roll Storage Controller 986 (FIG. 106) for each Roll Storage Module 700, mounted in pairs up to a maximum of eight. A controller is mounted on the side of the module, and manages both the Roll Storage Module and the associated upper or lower half of the Note Transport Module.

The connections are as follows:

| Number | Label | Abbreviation | Description |
|---|---|---|---|
| 987 | A | MOOUDR | Motor (stepper), for notes to be |
| | | | rolled out from the Roll Storage |
| | | | Module. |
| 988 | B | MOINDR | Motor (stepper), for notes to be |
| | | | rolled in to the Roll Storage |
| | | | Module. |
| | Serial | | Not used |
| 989 | C | ISBAPO | Inductive sensor, to detect end of |
| | | | Mylar ™ tape. |
| | D | OS1 | Reserved |
| 990 | E | OSBAPU | Optical sensor, band pulse, |
| | | | (rotating counter sensor) to detect |
| | | | speed of Mylar tape in Roll |
| | | | Storage Module. |
| 991 | F | OSPSPO | Solenoid check sensor (optical), to |
| | | | ensure that the feedgate has |
| | | | moved fully to the active position, |
| | | | sending notes to the Roll Storage |
| | | | Module. |
| 992 | G | OSTRPA | Optical sensor, transport path, |
| | | | mounted on Note Transport |
| | | | Module. Reflex sensor for |
| | | | incoming notes arriving at |
| | | | feedgate. |
| 993 | H | OSSTPA | Optical sensor, storage path, |
| | | | mounted in Roll Storage Module. |
| | | | Reflex sensor for outgoing notes |
| | | | arriving at feedgate. |
| | I | AS1 | Reserved |
| 994 | Power 5 V/ | | Power supply from PS1. |
| | 24 V | | |
| 995 | | SOPS | Feedgate solenoid |
| 996 | CAN Bus | | Two CAN bus connections, so that |
| | | | the Roll Storage Controllers can |
| | | | be daisy-chained to each other. |
| | | | The first in the chain connects to |
| | | | The Storage Transport Controller. |
| | | | The last in the chain is left |
| | | | disconnected and the bus has to |
| | | | be terminated. |
| 997a | | | DIP switch to set CAN ID |
| 997b | | | DIP switch to set CAN |
| | | | termination: |
| | | | ON for last Roll Storage Controller |
| | | | on the bus. |
| | | | OFF for other controllers. |

Legend of Reference Numerals

| | Reference | Best viewed |
|---|---|---|
| Description | Number | in FIG: |
| Storage cabinet | 001 | 2 |
| Safe door cover | 002 | 2 |
| Safe door | 003 | 2 |
| Locking system | 004 | 2 |
| Top cover | 005 | 2, 15 |
| Input tray, aperture in top cover | 006 | 2 |
| Output tray, drawers for operator access | 007 | 2 |
| Output tray, LED for note withdrawal, left or right | 008 | 2 |
| Top cover section, removable, to slide safe under | 009 | 2 |
| desk. | | |
| Button, to open top cover for NHM access. | 010 | 2 |
| Storage trolley | 011 | 2 |
| Lever to lift feedgate assembly at end of input path | 012 | 6, 24 |
| Spring dampers to support top cover | 013 | 12, 13, 14 |
| Catch and safety hook for opening NHM | 014 | 10, 11, 15 |
| Pin, to engage with safety catch and hook | 015 | 11, 12 |
| Hand symbol on note reader, for opening NHM | 016 | 10 |
| Spring damper to support NHM | 017 | 12, 13, 14 |
| Slot for left-hand spring damper, for NHM support | 018 | 13 |
| Slot, front, for right-hand spring damper, NHM | 019a | 12 |
| support | | |
| Slot, rear, for right-hand spring damper, NHM | 019b | 14 |
| support | | |
| LED to indicate NHM closure | 020 | 15 |
| Ramp for removing trolley | 021 | 16 |
| Catch for releasing trolley | 022 | 16 |
| Handle, for pulling out trolley | 023 | 16 |
| Points where note jams might occur | 024a-024f | 20 |
| Safemaster storage unit | 025 | 27, 28 |
| Host computer, EDP of bank | 026 | 28, 29 |
| Journal printer | 027 | 28 |
| Alarm, in cabinet | 028 | 30 |
| Alarm, in safe door | 029 | 30 |
| Shielded cable for safe door components | 030 | 30 |
| Input module | 100 | 3, 5 |
| System of toothed wheels on Input Module | 117 | 22 |
| Front plate on Input Module | 122 | 21 |
| Transport base unit for NHM | 202 | 3, 5 |
| Input path | 203 | 4 |
| Output path | 204 | 4 |
| Storage gateway | 205 | 4 |
| Transport belt, upper | 209 | 5 |
| Transport belt, lower | 210 | 5 |
| Feedgate | 234 | 5, 6 |
| Feedgate solenoid | 237 | 6 |
| Feedgate solenoid operating lever | 238 | 6 |
| Sensor, optical check, feedgate solenoid | 239 | 6 |
| Toothed wheel on Note Reader Module | 266 | 23 |
| Drive belt for mechanical drive to Input Module | 271 | 5 |
| Toothed wheel on Output Module | 276 | 25 |
| Note reader module | 300 | 3, 5 |
| Optical sensor, master, note reader module | 301a | 9 |
| Optical sensor, slave 1, note reader module | 301b | 9 |
| Optical sensor, slave 2, note reader module | 301c | 9 |
| Output module | 400 | 3, 5 |
| Storage transport module | 500 | 3 |
| Storage transport path | 502 | 4 |
| Handwheel, note removal, Storage Transport Module | 539 | 19 |
| Note transport module | 600 | 3 |
| Note transport module, upper | 601 | 18 |
| Note transport module, lower | 602 | 18 |
| Note transport path | 603 | 4 |
| Clip, for releasing upper storage unit | 604 | 18, 19 |
| Roll storage module | 700 | 3, 18 |
| Handwheel for note removal, Roll Storage Module | 706 | 19 |
| Handle, for raising upper storage unit | 738 | 19 |
| Terminal block | 905c | 30 |
| Main control box | 908 | 3 |
| Note handling controller | 939 | 3 |
| Service display module | 963 | 3 |
| Storage transport controller | 977 | 3 |
| Input Module | 100 | [All of FIG. |
| | | 31] |
| Input compartment | 101 | 31 |
| Sensor, optical direct beam, on input compartment to | 102 | [See other |
| detect the presence of note(s) | | modules - |
| | | shown as |
| | | single unit] |
| Optical heads for sensor 102 | 102a | 31, 32, 33 |
| | 102b | 31, 35 |
| Input clutch | 103 | 31, 32, 33 |
| Micro-switch (detects pusher plate parked) | 104 | 31, 35 |
| Micro-switch (detects pusher plate deployed) | 105 | 31, 35 |
| Motor, DC, (deploys/parks the pusher plate) | 106 | 35 |
| Twin over-run clutches (provide drive to the contra- | 107 | 32, 34, 36, |
| rotating shaft) | | 37 |
| Input Module transport system | 108 | 32, 37 |
| Pusher plate | 109 | 34, 35 |
| Outer plate | 110 | 34, 36 |
| Feeder wheel | 111 | 32, 33, 37, |
| | | 38 |
| Feeder wheel shaft | 112 | 37 |
| Contra shaft | 113 | 37 |
| Slave shaft | 114 | 37 |
| Control shaft | 115 | 37 |
| Feeder slot | 116 | 33 |
| Toothed wheels | 117 | 32, 36 |
| Black rollers on contra shaft | 118 | 37 |
| Black rollers on contra shaft (component 118), left | 118a and | 38 |
| and right. | 118b | |
| Red rollers on contra shaft | 119 | [See 119a-119d] |
| Red rollers on contra shaft (component 119), left to | 119a, 119b, | 37, 38 |
| right. | 119c, and | |
| | 119d | |
| Input tray. The container for banknotes within the | 120 | 32 |
| input compartment. | | |
| Input tray base plate | 121 | 32, 34 |
| Input tray front plate | 122 | 32 |
| Note guides | 123a and | 32 |
| | 123b | |
| Note guide slots | 124a and | 33, 34 |
| | 124b | |
| Over centre cam | 125 | 35 |
| Springs | 126a and | 35 |
| | 126b | |
| Pusher plate assembly | 127 | [All of FIG. |
| | | 35] |
| Cam adjusters | 128 | 31, 36 |
| Cam adjusters (component 128), left and right. | 128a and | 37 |
| | 128b | |
| Transport system pulleys | 129 | 37 |
| Inner rollers - slave shaft | 130 | 37, 38 |
| Outer rollers - slave shaft | 131 | 37, 38 |
| Transport system shafts | 132 | 37 |
| Cam adjuster slot | 133 | 31, 36 |
| Thumb roller on short arm | 134 | 35 |
| Guide bars | 135 | 35 |
| NHM Transport System Base Unit | 202 | 5 |
| Transport system upper belts | 207 | 33, 37 |
| Transport system lower belts | 208 | 5 |
| Note Reader Module | 300 | 39, 40 |
| Input Module | 100 | 37, 40 |
| Input tray | 101 | 51 |
| Sensor, optical direct beam, on input tray | 102 | 57 |
| NHM Transport System | 200 | [All transport |
| | | components |
| | | of NHM] |
| Note Handling Module | 201 | [All of FIG. |
| | | 39] |
| NHM transport base unit | 202 | 39, 40 |
| Input path | 203 | 41, 52 |
| Output path | 204 | 41 |
| Storage gateway | 205 | 41 |
| Storage gateway front belt | 205a | 55, 56 |
| Storage gateway rear belt | 205b | 55, 56 |
| Toothed wheel at bottom of storage gateway | 206 | 41, 56, 62 |
| Transport belt, upper front | 207 | 5 |
| Transport belt, lower front | 208 | 5, 47 |
| Transport belt, upper rear | 209 | 5 |
| Transport belt, lower rear | 210 | 5, 47 |
| Transport belt, Note Reader Module | 211 | 5, 9, 43, 47 |
| Guide plate for transport belt facing note reader input | 212 | 44, 47, 48 |
| head | | |
| Guide plate for transport belt facing note reader | 213 | 43, 47 |
| central head | | |
| Guide plate for transport belt facing note reader | 214 | 44, 47 |
| output head | | |
| Guide plate on note reader head, leading edge | 215 | 46 |
| Guide plate on note reader head, trailing edge | 216 | 46 |
| Idler shaft on lower front transport belt | 217 | 48 |
| Guide plate, metal, for lower front transport belt | 218 | 48 |
| Pivot shaft for idler shaft and guide plate | 219 | 63 |
| Guide rails for lower rear transport belt | 220 | 44 |
| Guide rails for upper rear transport belt | 221 | 45 |
| Inner transport belt, Output Module | 222 | 50 |
| Outer transport belt, Output Module | 223 | 50 |
| Idler shaft on vertical section of output path | 224 | 50 |
| Idler shafts, to turn output path from vertical to | 225a, 225b, | 50 |
| horizontal | 225c | |
| Guide rails, Output Module | 226 | 50 |
| Inner roller, Output Module | 227 | 50 |
| Outer roller, Output Module | 228 | 50 |
| Stacking wheel, Output Module | 229 | 50 |
| Output tray | 230 | 49, 50 |
| Output drawers, left and right | 231 | 51 |
| Driveshaft, inner transport belt | 232 | 50, 59 |
| Driveshaft, outer transport belt | 233 | 50, 59 |
| Feedgate, at storage gateway | 234 | 41, 5, 50, |
| | | 52, 53, 57 |
| Guide plate, upper, at feedgate | 235 | 45 |
| Guide plate, lower, at feedgate | 236 | 52, 53 |
| Solenoid, feedgate | 237 | 53, 54 |
| Lever, for solenoid check sensor | 238 | 54 |
| Sensor, optical check, feedgate solenoid | 239 | 54 |
| Feedgate assembly | 240 | [All of |
| | | FIG. 54] |
| Pivot shaft, feedgate assembly | 241 | 54 |
| Spring, to hold down feedgate assembly | 242 | 55 |
| Lever, for raising feedgate assembly | 243 | 54, 55 |
| Sensor, optical, rotating counter | 244 | 50, 57 |
| Timing wheel for sensor 244 | 244a | 60 |
| Optical head for sensor 244 | 244b | 60 |
| Sensor, optical reflective, on input path | 245 | 48, 57, 62 |
| Sensor, note thickness | 246 | 57 |
| Note thickness sensor roller on floating shaft | 246a | 45 |
| Note thickness sensor roller on fixed driveshaft | 246b | 44, 62 |
| Sensors, optical, transverse pair | 247 | 45, 57 |
| Sensor, optical reflective, on output path | 248 | 50, 57 |
| Sensor, optical direct beam, on output tray | 249 | 49, 50, 57 |
| Micro-switch to indicate cover closure | 250 | 49, 60 |
| Stepper motor | 251 | 59 |
| Clutch for input path | 252 | 59, 61 |
| Drive belt from motor to clutch | 253 | 59 |
| Toothed wheel on clutch central shaft | 254 | 60, 61 |
| Idler, clutch to input path upper rear transport belt | 255 | 60, 61 |
| Toothed wheel on driveshaft for upper rear belt. | 256 | 60, 61 |
| Driveshaft for upper rear belt | 257 | 49, 61 |
| Clutch central shaft | 258 | 59, 61 |
| Toothed drivewheel on left side of transport base unit | 259 | 62 |
| Toothed wheel on transfer shaft to right of base unit | 260 | 62 |
| Shaft, transfers drive to right of base unit | 261a | 63 |
| Pulley, main drive on right side of transport base unit | 262 | 62, 63 |
| Driveshaft for lower rear transport belt | 263 | 62, 63 |
| Drive belt for lower rear driveshaft | 264 | 63 |
| Toothed wheel on base unit that connects with Note | 265 | 62, 63 |
| Reader Module transport belt wheel. | | |
| Toothed wheel on Note Reader Module belt | 266 | 9 |
| driveshaft | | |
| Driveshaft for lower front transport belt | 267 | 62, 63 |
| Drive belt for lower front driveshaft | 268 | 63 |
| Adjuster, drive belt tension | 269 | 63 |
| Pulley to transfer drive to left of transport base unit. | 270 | 63 |
| Shaft, transfers drive to left of base unit | 270a | 63 |
| Drive belt for drive to Input Module | 271 | 63 |
| Adjuster, drive belt tension | 272 | 63 |
| Toothed wheel at left end of transfer shaft 270a | 273 | 62 |
| Idler, connects 273 to 275 | 274 | 62 |
| Toothed wheel to engage with Input Module | 275 | 62, 63 |
| Drivewheel for output path | 276 | 59 |
| Drivewheel for inner belt driveshaft | 277 | 59 |
| Toothed wheel on inner belt driveshaft, right side | 278 | 59 |
| Idler, inner belt driveshaft to inner roller | 279 | 59 |
| Drivewheel for inner roller | 280 | 59 |
| Toothed wheel on inner belt driveshaft, left side | 281 | 60 |
| Drivewheel for outer belt driveshaft | 282 | 60 |
| Toothed wheel on inner roller, left side | 283 | 60 |
| Drivewheel for outer roller | 284 | 60 |
| Idler pulley, for drive to stacking wheel | 285 | 59 |
| Drivebelt, for stacking wheel | 286 | 59 |
| Idler, toothed wheel, for drive to stacking wheel | 287 | 59 |
| Drivewheel for stacking wheel | 288 | 59 |
| Note Reader Module | 300 | 39, 40 |
| Note reader input head (master) | 301a | 9, 47, 57 |
| Note reader central head (slave 1) | 301b | 5, 9, 47, 57 |
| Note reader output head (slave 2) | 301c | 9, 47, 57 |
| Output Module | 400 | 39, 40, 49 |
| Toothed wheel at top of Storage Transport Module | 535 | 42 |
| Note Handling Controller | 939 | 49, 58, 60 |
| LED, note thickness sensor | 947 | 58 |
| Service Display Module | 963 | 49 |
| Input Module | 100 | 39, 5 |
| NHM transport base unit | 202 | 39, 5 |
| Input path | 203 | 9, 41 |
| Output path | 204 | 41 |
| Storage gateway | 205 | 41 |
| Note reader transport belt | 211 | 9, 41, 43 |
| Note reader transport belt drivewheel | 266 | 9 |
| Note Reader Module | 300 | [All of |
| | | FIG. 9], 39, 5 |
| Note reader head (master) | 301a | 9, 41, 43 |
| Note reader head (slave 1) | 301b | 9, 39, 41 |
| Note reader head (slave 2) | 301c | 9, 41 |
| Blanking plate, in place of note reader head | 302 | 43 |
| Sensor, infra-red | 303a | 46 |
| Sensor, green or ultra-violet | 303b | 46 |
| Calibration papers | 304 | [All of |
| | | FIG. 64] |
| Output Module | 400 | 39, 5 |
| Note reader control box | 967 | 9, 41, 65 |
| Plug, note reader controller, cable to master | 970a | 9 |
| Plug, note reader controller, cable to slave 1 | 970b | 9 |
| Plug, note reader controller, cable to slave 2 | 970c | 9 |
| Plug, note reader master head, cable to controller | 971a | 9 |
| Plug, note reader slave 1, cable to controller | 971b | 9 |
| Plug, note reader slave 2, cable to controller | 971c | 9 |
| Sensor adjustment screw, infra-red | 972a | 65 |
| Sensor adjustment screw, green or ultra-violet | 972b | 65 |
| Plug, 5 V/24 V power to note reader controller | 973a | 9 |
| (master) | | |
| Plugs, CAN-bus connectors (master, slave 1, slave | 975a, b, c | 9 |
| 2) | | |
| Note Handling Module | 201 | 4 |
| Input path | 203 | 4 |
| Output path | 204 | 4 |
| Storage gateway | 205 | 4 |
| Toothed wheel on storage gateway | 206 | 56 |
| Storage Transport Module | 500 | [All of |
| | | FIG. 66], 67, |
| | | [All of |
| | | FIG. 69] |
| Storage system | 501 | 4 |
| Storage transport path | 502 | 4 |
| Stepper motor | 503 | 66, 68, 69 |
| Transport belt, front | 504 | 68 |
| Transport belt, rear | 505 | 68 |
| Note guide, upper | 506 | 68 |
| Note guide, lower | 507 | 68 |
| Guide rails | 508 | 66, 69 |
| Driveshaft, front belt | 509 | 68, 70 |
| Idler shaft, front and rear belt | 510 | 68 |
| Idler shaft, front and rear belt | 511 | 68 |
| Idler shaft, front and rear belt | 512 | 68 |
| Idler shaft, front belt | 513 | 68 |
| Idler shaft, front belt | 514 | 68 |
| Driveshaft, rear belt | 515 | 68, 69, 70 |
| Idler shaft, rear belt | 516 | 68 |
| Idler shaft, rear belt | 517 | 68 |
| Idler shaft, rear belt | 518 | 68 |
| Idler shaft, rear belt | 519 | 68 |
| Sensors, optical, transverse pair. | 520 | 66, 68 |
| Sensor, optical pulse (rotating counter) | 521 | 68 |
| Pulley on stepper motor | 522 | 69 |
| Pulley on rear belt driveshaft | 523 | 69 |
| Drive belt from stepper motor pulley | 524 | 66, 69 |
| Toothed wheel on rear belt driveshaft | 525 | 70 |
| Idler | 526 | 70 |
| Idler, connects to drive wheels for upper belt | 527 | 66, 70, 71 |
| driveshaft and Note Transport Module. | | |
| Drive wheel for the front transport belt driveshaft | 528 | 66, 70 |
| Drive belt from driveshaft pulley to floating arm | 529 | 66, 69 |
| Adjuster, drive belt tension | 530 | 69 |
| Pulley at pivot point on floating arm | 531 | 69, 56 |
| Pulley at pivot point on floating arm | 532 | 69, 56 |
| Floating arm, to connect to storage gateway on NHM | 533 | 69, 56 |
| Pulley at end of floating arm | 534 | 56 |
| Drive belt on floating arm | 535 | 56 |
| Toothed wheel on floating arm. | 536 | 66, 69, 56 |
| Spring on floating arm | 537 | 69, 56 |
| Smooth plastic wheel on floating arm | 538 | 56 |
| Hand wheel on driveshaft for front belt | 539 | 66, 69 |
| Mounting shaft, upper | 540 | 66 |
| Slot in trolley for upper mounting shaft | 540a | 67 |
| Mounting shaft, lower | 541 | 66 |
| Adjustment screw on lower mounting shaft | 541a | 71 |
| Note Transport Module, upper | 601 | 67 |
| Note Transport Module, lower | 602 | 67 |
| Note transport path | 603 | 4 |
| Drive wheel on Note Transport Module | 628 | 71 |
| Roll Storage Module | 700 | 67 |
| Controller, storage transport | 977 | 66 |
| Storage gateway | 205 | 4 |
| Storage transport path | 502 | 4 |
| Drivewheel on Storage Transport Module | 527 | 71 |
| Adjustment screw on Storage Transport Module | 541a | 71 |
| Note Transport Module | 600 | 72, 73 |
| Note Transport Module, upper | 601 | 72, 73 |
| Note Transport Module, lower | 602 | 72, 73 |
| Note transport path | 603 | 73, 4, 74, |
| | | 75, 76 |
| Clip, green | 604 | 73, 74 |
| Guide plate assembly, metal | 605 | 74 |
| Guide plate assembly, plastic | 606 | 74 |
| Hinge component, upper | 607 | 75, 76 |
| Inner pegs on upper hinge | 607a | 77 |
| Outer peg on upper hinge | 607b | 77 |
| Hinge component, lower | 608 | 76 |
| Inner slot in lower hinge | 608a | 77 |
| Outer tongue on lower hinge | 608b | 77 |
| Stop point on lower hinge | 608c | 77 |
| Lower slot in lower hinge | 608d | 77 |
| Clip, white, upper | 609 | 73, 74, 75 |
| Clip, white, lower | 610 | 73 |
| Screw hole in Roll Storage Module for upper hinge | 611 | 78 |
| Sensor, optical, at entry to lower feedgate | 612 | 74, 76 |
| Hole to prevent reflection from sensor 612 | 612a | 74 |
| Feedgate, lower | 613 | 74, 76 |
| Sensor, optical, at entry to upper feedgate | 614 | 74, 75 |
| Hole to prevent reflection from sensor 614 | 614a | 74 |
| Feedgate, upper | 615 | 74, 75, 76 |
| Roller, lower | 616 | 74, 76 |
| Transport Belt, upper | 617 | 74, 75, 76 |
| Transport Belt, lower | 618 | 74, 76 |
| Roller, upper | 619 | 74, 75 |
| Roller, support for upper belt | 620 | 74 |
| Roller, support for lower belt | 621 | 74 |
| Solenoid, lower feedgate | 622 | 76 |
| Pushrod, lower feedgate solenoid | 623 | 76 |
| Solenoid, upper feedgate | 624 | 75, 76 |
| Pushrod, upper feedgate solenoid | 625 | 75 |
| Sensor, optical check, lower feedgate solenoid | 626 | 76 |
| Sensor, optical check, upper feedgate solenoid | 627 | 75 |
| Toothed wheel, driven from previous module | 628 | 76, 71 |
| Toothed wheel on lower module | 629 | 76 |
| Pulley on lower module | 630 | 76 |
| Drive belt | 631 | 74, 76 |
| Drive pulley for lower belt | 632 | 74, 76 |
| Toothed wheel, to drive next module in path | 633 | 74, 76 |
| Drivewheel for upper belt | 634 | 74, 75, 76 |
| Cable clip on upper hinge, for CAN bus | 635 | 77 |
| Roll Storage Module | 700 | 72, 73 |
| Handle, for raising upper storage unit | 738 | 72 |
| Roll Storage Controller | 986 | 78 |
| Power socket for Roll Storage Controller | 994 | 78 |
| CAN bus, twin socket for Roll Storage Controller | 996 | 78 |
| Note Transport Module, upper | 601 | 72 |
| Note Transport Module, lower | 602 | 72 |
| Feedgate tongue, lower | 613 | See Section 5 |
| Feedgate tongue, upper | 615 | 84 |
| Roll storage module | 700 | [All of FIG. |
| | | 79], 72 |
| Side plate | 701 | 81 |
| Side plate | 702 | 82 |
| Mylar ™ tapes | 704 | 81, 84, 86, |
| | | 87 |
| Note storage drum | 705 | 81, 84, 86 |
| Wind-out hand wheel | 706 | 81 |
| Wind-in hand wheel | 707 | 81 |
| Shaft for Mylar tape storage reels (716) and | 708 | 79, 82, 87 |
| differential gear set (719) | | |
| Shaft for note storage drum (705) | 709 | 81 |
| Motor, stepper, roll-in | 710a | 81, 82 |
| Motor, stepper, roll-out | 710b | 81, 82 |
| Drive belt, roll-in | 711a | 81 |
| Drive belt, roll-out | 711b | 82 |
| Timing wheel | 712a | 82, 86 |
| Timing wheel optical sensor | 712b | 82, 86 |
| Inductive sensor | 713 | 79, 84 |
| Reflex sensor | 714 | 84, 86 |
| Guide rollers A | 715 | 79, 83 |
| Mylar tape storage reel | 716 | 79, 84 |
| Note guide | 717 | 84, 86 |
| Guide plate | 718 | 82, 84 |
| Differential gear set (comprising 720, 721) | 719 | 84, 87 |
| Bevel gears | 720 | 87 |
| Small bevel gear | 721 | 87 |
| Pinch rollers | 722 | 83 |
| Coil springs | 723 | 83 |
| Swivel arm (comprising 717, 725, 729, 730, 731) | 724 | [All of |
| | | FIG. 86] |
| Swivel-arm drum roller | 725 | 84, 86 |
| Guide plate spring clip | 726 | 79 |
| Shaft for guide rollers A (715) and timing wheel | 727 | 79, 83, 84 |
| (712a) | | |
| Shaft for swivel-arms (724) and pinch rollers (722) | 728 | 79, 83, 84, |
| | | 86 |
| Leaf spring | 729 | 86 |
| Peg | 730 | 86 |
| Swivel-arm tape roller | 731 | 86 |
| Sensor shield | 732 | 79 |
| Plastic cover for tape reel | 733 | 79, 84 |
| Protection plate | 734 | 80 |
| Shaft for guide plate (718 + 726) | 735 | 79 |
| Shaft for guide rollers B (737) | 736 | 79 |
| Guide rollers B | 737 | 79 |
| Handle, for raising upper storage unit | 738 | 80 |
| Main Control Unit | 909 | See Section 7 |
| Roll Storage controller | 986 | 82, 87 |
| Alarm, internal, on side of cabinet. | 028 | 90 |
| Note Reader Module sensor heads, master, slave 1, | 301a, 301b, | 9 |
| slave 2. | 301c | |
| Storage Transport Module | 500 | 106 |
| Roll Storage Module | 700 | 106 |
| Socket, male, on cabinet, power from PS1 to NHC | 901a | 90, 91 |
| and NRC | | |
| Socket, female, on trolley, power from PS1 to NHC | 901b | 92 |
| and NRC | | |
| Socket, male, on cabinet, CAN bus from MCU to | 902a | 90, 91 |
| STC, control from MCU to PS1 | | |
| Socket, female, on trolley, CAN bus from MCU to | 902b | 92 |
| STC, control from MCU to PS1 | | |
| Socket, female, on cabinet, mains power from | 903a | 90, 93 |
| service switch to PS1 | | |
| Socket, male, on trolley, mains power from service | 903b | 94 |
| switch to PS1 | | |
| Plug, on trolley, mains power to PS1 | 903c | 94 |
| Sockets, at left of trolley, for alignment pins | 904a | 91 |
| Alignment pins on trolley | 904b | 92 |
| Cables, connecting Twin Safe to environment | 905a | 95 |
| Aperture, for cable access to environment | 905b | 95 |
| Terminal block for cable connections | 905c | 95 |
| Mains filter | 906 | 90 |
| Service switch | 907 | 90, 93 |
| Main control box | 908 | 90 |
| Main Control Unit PCB | 909 | 96 |
| Network Interface Unit PCB | 910 | 96 |
| Power supply PS2 for MCU and optional NIU | 911 | 96 |
| Hard disk for NIU | 912 | 96 |
| Socket, internal, RS232, on MCU, connects to NIU | 913 | 99 |
| LEDs, indicate MCU power-on, 5 V/−12 V/+12 V | 914 | 97 |
| Floppy disk drive on MCU, for preparation only | 915 | 97 |
| PCMCIA slot on MCU, for import and export of data | 916 | 97 |
| Boot switch | 917 | 97 |
| Download switch | 918 | 97 |
| Reset button for MCU | 919 | 97 |
| LEDs, status and communication | 920 | 97 |
| Label, for MCU and PCMCIA components | 921 | 97 |
| Socket, 9-pin RS232, on MCU for service PC | 922 | 97 |
| Plug, 9-pin on RS232 cable, connects to socket 922 | 922a | 96 |
| Socket, DIN, on NIU for keyboard and mouse | 923 | 97 |
| Socket, Ethernet, on NIU for external network | 924 | 97 |
| Socket, 15-pin VGA, on NIU for monitor | 925 | 97 |
| Socket, 9-pin RS232, on NIU, connects to MCU | 926 | 97 |
| Plug, 9-pin on RS232 cable, connects to socket 926 | 926a | 96 |
| Cable, RS232, connecting NIU and MCU externally | 927 | 96, 97 |
| Socket, 9-pin RS232, on NIU, for remote access | 928 | 97 |
| Socket, mains power, on main control box | 929 | 98 |
| Sockets, CAN bus, on MCU | 930 | 98, 99 |
| Socket, 37-pin, on MCU, for terminals and modem | 931 | 98 |
| Socket, 12-pin RJ, on MCU, control to PS1 | 932 | 98 |
| Socket, 15-pin, on MCU, for alarms and Safemasters | 933 | 98 |
| Socket, 25-pin Centronics, on MCU, for journal | 934 | 98 |
| printer | | |
| Socket, 9-pin RS232, on MCU, for safe door solenoid | 935 | 98 |
| Sockets, USB, on MCU, for future use | 936 | 98 |
| Shield or ducting for safe door cables. | 937 | 90 |
| DIP switch, MCU, CAN-ID | 938a | 99 |
| DIP switch, MCU, CAN termination | 938b | 99 |
| Note Handling Controller | 939 | 100 |
| Socket, NHC, micro-switch on Input Module | 940 | 101 |
| Socket, NHC, optical sensor on input tray | 941 | 101 |
| Socket, NHC, optical sensor on output tray | 942 | 101 |
| Socket, NHC, micro-switch to detect cover closure | 943 | 101 |
| Socket, NHC, optical sensor, rotating counter | 944 | 101 |
| Socket, NHC, optical sensor, solenoid check | 945 | 101 |
| LED, NHC, status and communications | 946 | 101 |
| LED, NHC, note thickness sensor | 947 | 101 |
| Socket, NHC, optical sensor, right, before feedgate | 948 | 101 |
| Socket, NHC, optical sensor, output, after feedgate | 949 | 101 |
| Socket, NHC, optical sensor, left, before feedgate | 950 | 101 |
| Socket, NHC, optical sensor at entry to input path | 951 | 101 |
| Socket, NHC, inductive sensor, note thickness | 952 | 101 |
| Socket, NHC, input path clutch | 953 | 101 |
| Socket, NHC, separator clutch on Input Module | 954 | 101 |
| Socket, NHC, feedgate solenoid | 955 | 101 |
| Socket, NHC, pressure plate motor on Input Module | 956 | 101 |
| Socket, NHC, sliding doors on input tray | 957 | 101 |
| Socket, NHC, 5 V/24 V power | 958 | 101 |
| Socket, NHC, 5 V power output to SDM | 959 | 101 |
| Socket, NHC, transport motor drive | 960 | 101 |
| Sockets, NHC, CAN bus | 961 | 101 |
| DIP switch, NHC, CAN-ID | 962a | 101 |
| DIP switch, NHC, CAN termination | 962b | 101 |
| Service Display Module | 963 | 103, 104 |
| Power input to Service Display Module | 964 | 103, 104 |
| CAN bus connectors on Service Display Module | 965 | 103, 104 |
| DIP switch, SDM, CAN-ID | 966a | 104 |
| DIP switch, SDM, CAN termination | 966b | 104 |
| Note Reader Module control box | 967 | 9 |
| Note Reader Controller PCB | 968 | [All of FIG. |
| | | 105] |
| Socket, NRC to sensor head | 969 | 105 |
| Plug, NRC, cable to master | 970a | 9 |
| Plug, NRC, cable to slave 1 | 970b | 9 |
| Plug, NRC, cable to slave 2 | 970c | 9 |
| Plug, note reader master head, cable to NRC | 971a | 9 |
| Plug, note reader slave 1, cable to NRC | 971b | 9 |
| Plug, note reader slave 2, cable to NRC | 971c | 9 |
| Adjustment screw, infra-red sensor | 972a | 105 |
| Adjustment screw, green or ultra-violet sensor | 972b | 105 |
| Socket, power to NRC from PS1 | 973 | 105 |
| Plug, power to NRC (master) from PS1 | 973a | 9 |
| Socket, NRC, power distribution to slave units | 974 | 105 |
| Socket, NRC, CAN bus | 975 | 105 |
| Plugs, NRC, CAN bus (master, slave1, slave2) | 975a, b, c | 9 |
| DIP switch, NRC, CAN-ID | 976a | 105 |
| DIP switch, NRC, CAN termination | 976b | 105 |
| Storage Transport Controller | 977 | 106 |
| Socket, STC, optical sensor, rotating counter | 978 | 107 |
| Socket, STC, optical sensor, right | 979 | 107 |
| Socket, STC, optical sensor, left | 980 | 107 |
| Socket, STC, transport motor drive | 981 | 107 |
| Socket, STC, 5 V/24 V power | 982 | 107 |
| Socket, STC, 24 V power for CAN bus | 983 | 107 |
| Sockets, STC, CAN bus | 984 | 107 |
| DIP switch, STC, CAN-ID | 985a | 107 |
| DIP switch, STC, CAN termination | 985b | 107 |
| Roll Storage Controller | 986 | 106 |
| Socket, RSC, roll-out motor | 987 | 108 |
| Socket, RSC, roll-in motor | 988 | 108 |
| Socket, RSC, inductive sensor, end of tape | 989 | 108 |
| Socket, RSC, optical sensor, rotating counter | 990 | 108 |
| Socket, RSC, optical sensor, solenoid check | 991 | 108 |
| Socket, RSC, optical sensor, note input to feedgate | 992 | 108 |
| Socket, RSC, optical sensor, note output to feedgate | 993 | 108 |
| Socket, RSC, 5 V/24 V power | 994 | 108 |
| Socket, RSC, feedgate solenoid | 995 | 108 |
| Sockets, RSC, CAN bus | 996 | 108 |
| DIP switch, RSC, CAN-ID | 997a | 108 |
| DIP switch, RSC, CAN termination | 997b | 108 |

We claim:

1. A document handling apparatus substantially as hereinbefore described with reference to the accompanying drawings.
